(19) United States
(12) Patent Application Publication
(10) Pub. No.: US 2024/0334926 A1
(43) Pub. Date: Oct. 10, 2024

(54) AGROCHEMICAL COMPOSITION

(71) Applicant: BASF SE, Ludwigshafen (DE)

(72) Inventors: Jan Ole Mueller, Ludwigshafen (DE); Doris Kremzow-Graw, Ludwigshafen (DE); Janine Rude, Ludwigshafen (DE); Joachim Bentele, Ludwigshafen (DE); Stephan Jan Bachmann, Ludwigshafen (DE); Christian Schade, Ludwigshafen (DE); Adam Blanazs, Ludwigshafen (DE); Christian Sowa, Limburgerhof (DE); Marcus Annawald, Limburgerhof (DE)

(21) Appl. No.: 18/681,909

(22) PCT Filed: Aug. 10, 2022
(86) PCT No.: PCT/EP2022/072416

§ 371 Date: Feb. 7, 2024

(30) Foreign Application Priority Data
Aug. 12, 2021 (EP) 21190962.7

(51) Int. Cl. A01N 25/10; A01N 43/40; A01N 43/54; A01N 43/56; A01N 43/653; A01N 43/70; A01N 43/713; A01P 3/00; A01P 13/02; C08F 283/06

(52) U.S. Cl. CPC A01N 25/10; A01N 43/40; A01N 43/54; A01N 43/56; A01N 43/653; A01N 43/70; A01N 43/713; A01P 3/00; A01P 13/02; C08F 283/06

(57) ABSTRACT

An agrochemical composition comprising (i) an agrochemical active ingredient; and (ii) a graft polymer comprising (A) a polymer backbone as a graft base, wherein said polymer backbone is obtainable by polymerization of at least one alkylene oxide selected from the group of C₂- to C₁₀-alkylene oxides, preferably C₂- to C₅-alkylene oxides, such as ethylene oxide, 1,2-propylene oxide, 1,2-butylene oxide, 2,3-butylene oxide, 1,2-pentene oxide or 2,3-pentene oxide; and optionally at least one polyol selected from the group of C₂- to C₁₄-polyols or at least one polyamine selected from the group of C₂- to C₁₄-polyamines; and (B) polymeric sidechains grafted onto the polymer backbone (A), wherein said polymeric sidechains (B) are obtainable by polymerization of monomers comprising at least one vinyl ester monomer (B1) in the presence of the polymer backbone (A). It was found that the graft polymer of the inventive composition is suitable as a dispersant for pesticides in agrochemical compositions. Moreover, the graft polymer typically exhibits a suitably high degree of biodegradability.

The present invention relates to an agrochemical composition.

Agrochemicals (agriculture chemicals) such as pesticides (pesticidal active ingredients) are materials that provide control of agricultural pests including insects, pathogens, rodents, and weeds. Pesticidal active ingredients are typically applied to a plant or its seeds by spraying with a liquid composition comprising the active ingredient.

Pesticides are often solid particles, crystal-like particles or oily liquids, which must be dispersed in the liquid composition to allow for homogeneous application. Compositions comprising finely dispersed pesticidal active ingredients are typically obtained by the inclusion of dispersants. Examples of conventional dispersants include salts of naphthalene sulfonate formaldehyde condensates, salts of lignosulfonates, salts of maleic anhydride copolymers and salts of condensed phenol sulfonic acid.

Unfortunately, many dispersants used in agrochemical compositions do not significantly decompose and remain present on both the plant or seed and the surrounding area, causing an undesired accumulation on the plant or seed, as well as in the soil in which the plant or seed is planted. This problem is predominant for dispersants produced by radical polymerization based on carbon-only backbones (a backbone not containing heteroatoms such as oxygen), since a carbon-only backbone is particularly difficult to degrade for microorganisms. Even radically produced graft polymers of industrial importance with a polyethylene glycol backbone show only limited biodegradation in waste water.

It is desirable to provide dispersants useful for agrochemical compositions, in particular biodegradable dispersants.

U.S. Pat. No. 5,318,719 A relates to biodegradable water-soluble graft copolymers having building, anti-filming, dispersing and threshold crystal inhibiting properties comprising an acid functional monomer and optionally other water-soluble, monoethylenically unsaturated monomers copolymerizable with the acid functional monomer, grafted to a biodegradable substrate comprising polyalkylene oxides and/or polyalkoxylated materials. The graft polymers are considered suitable as detergent additives.

CN 102 030 871 A relates to relates to a polyethylene glycol block biodegradable polyester comb-type graft copolymer. The comb-type graft copolymer is a homo- or copolymer, wherein degradable polyester of the polyethylene glycol block is utilized as the hydrophobic main chain. It is described that the polymer self-assembles in water to form nanoparticles useful for preparing hydrophobic drug nanoparticles.

The present invention provides an agrochemical composition comprising
(i) an agrochemical active ingredient; and
(ii) a graft polymer comprising
   (A) a polymer backbone as a graft base, wherein said polymer backbone is obtainable by polymerization of at least one alkylene oxide selected from the group of C₂- to C₁₀-alkylene oxides, preferably C₂- to C₅-alkylene oxides, such as ethylene oxide, 1,2-propylene oxide, 1,2-butylene oxide, 2,3-butylene oxide, 1,2-pentene oxide or 2,3-pentene oxide;
   and optionally at least one polyol selected from the group of C₂- to C₁₄-polyols or at least one polyamine selected from the group of C₂ to C₁₄-polyamines; and
   (B) polymeric sidechains grafted onto the polymer backbone (A), wherein said polymeric sidechains (B) are obtainable by polymerization of monomers comprising at least one vinyl ester monomer (B1) in the presence of the polymer backbone (A).

It was found that the graft polymer of the inventive composition is suitable as a dispersant for pesticides in agrochemical compositions. Moreover, the graft polymer typically exhibits a suitably high degree of biodegradability.

The graft polymer comprises a polymer backbone (A) as a graft base, and polymeric sidechains (B) grafted onto the polymer backbone (A).

The polymer backbone (A) of the graft polymer is obtainable by polymerization of at least one alkylene oxide selected from the group of C₂- to C₁₀-alkylene oxides, preferably C₂ to C₅-alkylene oxides, such as ethylene oxide, 1,2-propylene oxide, 1,2-butylene oxide, 2,3-butylene oxide, 1,2-pentene oxide or 2,3-pentene oxide; and optionally at least one polyol selected from the group of C₂- to C₁₄-polyols or at least one polyamine selected from the group of C₂ to C₁₄-polyamines.

When the polymer backbone (A) is obtained by polymerization of only one alkylene oxide, the polymer backbone (A) is a homopolymer. In this case, it is preferable that the alkylene oxide is selected from ethylene oxide, 1,2-propylene oxide and 1,2-butylene. A copolymer backbone obtained by polymerization of ethylene oxide, i.e., a polyethylene glycol backbone, is particularly preferred as the polymer backbone (A).

When the polymer backbone (A) is obtained by polymerization of more than one alkylene oxide and optionally at least one polyol or at least one polyamine, the polymer backbone (A) is a copolymer. In this case, the polymer backbone may be any type of known copolymer, such as a block copolymer, an alternating copolymer or a statistical copolymer. Statistical copolymers are also known as random copolymers.

The term “block copolymer (backbone)” as used herein means that the respective polymer comprises at least two, i.e., two or more, homopolymer subunits (blocks) linked by covalent bonds. Two block copolymers have two distinct blocks (homopolymer subunits), whereas triblock copolymers have, by consequence, three distinct blocks (homopolymer subunits), and so on. The number of individual blocks within such block copolymers is not limited, by consequence, an “n-block copolymer” comprises n distinct blocks (homopolymer subunits). Within the individual blocks (homopolymer subunits), the size/length of such a block may vary. The smallest length/size of a block is based on a minimum of two individual monomers. Various types of block copolymer backbones are commercially available, for example under the trademark series “Pluronic” (BASF SE, Ludwigshafen, Germany). Specific examples are Pluronic PE 6100, Pluronic PE 6800 or Pluronic PE 3100.

When more than one alkylene oxide is polymerized to obtain the polymer backbone (A), the alkylene oxides are preferably selected from ethylene oxide, 1,2-propylene oxide and/or 1,2-butylene oxide. In a preferred embodiment, ethylene oxide is polymerized with at least one alkylene oxide selected from 1,2-propylene oxide and/or 1,2-butylene oxide, preferably only 1,2-propylene oxide.

In order to obtain the polymer backbone, at least one polyol or at least one polyamine may optionally be polymerized with the at least one alkylene oxide.

When at least one polyol is polymerized to obtain the polymer backbone (A), the polyol is a C₂- to C₁₄-polyol, preferably a C₂- to C₁₂-polyol, more preferably a preferably C₂- to C₈-polyol. The polyol may serve as a “core” molecule from which polymer chains extend. This means that the polyol is preferably present at the start of the polymerization reaction for obtaining the polymer backbone.

A polyol is an organic compound comprising multiple hydroxyl groups. The polyol is preferably an aliphatic or cycloaliphatic polyol, in particular an aliphatic polyol. The polyol is preferably selected from diols, which comprise two hydroxyl groups, and polyols comprising three to ten hydroxyl groups.

Suitable aliphatic diols include aliphatic diols, i.e., glycols, such as ethylene glycol, propylene glycol, diethylene glycol, dipropylene glycol, 1,3-propanediol, 1,3-butanediol, 2-methyl-1,3-propanediol, triethylene glycol, and neopentyl glycol. A suitable cycloaliphatic diol is cyclohexanedimethanol.

Suitable polyols comprising three to ten hydroxyl groups include aliphatic polyols and cycloaliphatic polyols such as glycerin, trimethylolpropane, pentaerythritol, sorbitol, glucose, fructose, sucrose and lactose, in particular glycerin.

In one embodiment, the polymer backbone is obtained by polymerization of ethylene oxide and at least one alkylene oxide selected from 1,2-propylene oxide and/or 1,2-butylene oxide, preferably only 1,2-propylene oxide, and at least one polyol, in particular diethylene glycol and/or glycerin.

When at least one polyamine is polymerized to obtain the polymer backbone (A), the polyamine is a C₂- to C₁₄-polyamine, preferably a C₂- to C₁₂-polyamine, more preferably a preferably C₂- to C₈-polyamine. The polyamine may serve as a “core” molecule from which polymer chains extend. This means that the polyamine is preferably present at the start of the polymerization reaction for obtaining the polymer backbone.

A polyamine is an organic compound comprising multiple amino groups. The polyamine is preferably an aliphatic or cycloaliphatic polyamine, in particular an aliphatic polyamine. The polyamine is preferably selected from alkylene polyamines, such as ethylene diamine, propylene diamine, diethylene triamine and dipropylene triamine.

In a preferred embodiment, the polymer backbone is obtained by polymerization of at least one alkylene oxide selected from the group of C₂- to C₁₀-alkylene oxides in the absence of a polyamine. In a more preferred embodiment, the polymer backbone is obtained by polymerization of at least one alkylene oxide selected from the group of C₂ to C₁₀-alkylene oxides in the absence of a polyol and in the absence of a polyamine.

The skilled person is well-aware of how to obtain different types of copolymers. A suitable discussion may be found, e.g., in EP 0 362 688 A2.

The polymer backbone (A) preferably has a number average molecular weight Mₙ of 500 to 12,000 g/mol, preferably at most 9,000 g/mol, more preferably at most 6,000 g/mol, even more preferably at most 3,800 g/mol or at most 3,500 g/mol, in particular at most 3,000 g/mol, such as at most 2,750 g/mol, at most 2,700 g/mol or at most 2,650 g/mol, and at least 1,000 g/mol, more preferably at least 1,500 g/mol. A low number average molecular weight Mₙ of the polymer backbone (A) increases the degree of biodegradability. The molecular weight may be determined as described below in the experimental part.

Polymer backbones (A) may be based on different amounts of hydrophilic ethylene glycol units (—C₂H₄—O) derived from ethylene oxide, which influences the overall properties of the graft polymer. The total EO content (% EO) describing the total amount of ethylene glycol units in the polymer backbone (A) is defined as:

$$\% EO = m ( EO ) / ( m ( total backbone ) )$$

wherein m(EO) is the total mass of the ethylene glycol units and m(total backbone) is the total mass of the polymer backbone (A). The polymer backbone can have low, medium or high total EO contents % EO, which has effects on the biodegradability as well as the performance in agrochemical compositions. The ranges are defined as follows:
Low: 5 to 20% EO
Medium: 21 to 50% EO
High: 51 to 90% EO

In a preferred embodiment, the total EO content (% EO) is in the range of 10 to 80%, preferably at least 20%, and preferably at most 70%.

It was found that graft polymers comprising copolymer backbones (A) having a medium total EO content, i.e., 21 to 50% EO, exhibit particularly high biodegradability. Likewise, graft polymers comprising polymer backbones (A) obtained by polymerization of ethylene oxide exhibit particularly high biodegradability.

The graft polymer comprises polymeric sidechains (B) grafted onto the polymer backbone (A), wherein said polymeric sidechains (B) are obtainable by polymerization of monomers comprising at least one vinyl ester monomer (B1), and optionally at least one secondary monomer (B2), in the presence of the polymer backbone (A).

Preferably, the polymeric sidechains (B) are obtained by radical polymerization of monomers comprising at least one vinyl ester monomer (B1), and optionally at least one secondary monomer (B2), in the presence of the polymer backbone (A).

As vinyl ester monomer (B1), any vinyl ester as known to the skilled person may be employed, such as vinyl acetate, vinyl propionate, vinyl laurate, vinyl valerate, vinyl pivalate, vinyl neodecanoate, vinyl decanoate or vinyl benzoate. Preferably, the vinyl ester monomer (B1) is selected from vinyl acetate, vinyl propionate and vinyl laurate, in particular vinyl acetate and vinyl laurate. In an especially preferred embodiment, the polymeric sidechains (B) are obtained by radical polymerization of vinyl acetate.

The secondary monomer (B2) is preferably selected from olefinically unsaturated nitrogen-containing monomers such as vinyl lactams and vinylimidazoles, in particular vinyl lactams; and vinyl ethers.

Suitable vinyl lactams include N-vinyl lactams, such as N-vinylpyrrolidone, N-vinylpiperidone and N-vinylcaprolactam, preferably N-vinylpyrrolidone and N-vinylcaprolactam, in particular preferably N-vinylpyrrolidone (NVP).

Suitable vinylimidazoles include 1-vinylimidazole and C₁-C₈-alkyl-substituted derivatives of 1-vinylimidazole including 2-methyl-1-vinylimidazole, preferably 1-vinylimidazole.

Suitable vinyl ethers include ethyl vinyl ether, n-butyl vinyl ether, isobutyl vinyl ether, 4-hydroxybutyl vinyl ether, cyclohexyl vinyl ether, 2-ethyl-hexyl vinyl ether, dodecyl vinyl ether, and octadecyl vinyl ether, in particular n-butyl vinyl ether, isobutyl vinyl ether, 4-hydroxybutyl vinyl ether, cyclohexyl vinyl ether and 2-ethyl hexyl vinyl ether.

In case secondary monomer (B2) is used for obtaining the polymeric sidechains (B), the weight ratio of vinyl ester monomer (B1) to said secondary monomer (B2) is not especially limited. However, the amount of vinyl ester monomer (B1) is usually not smaller than 1 wt.-%, relative to the total amount of monomers constituting the polymeric sidechains (B). In this case, the polymeric sidechains (B) are obtainable by polymerization, in particular radical polymerization, of 1 to 100 wt.-% of monomer (B1), which is most preferably vinyl acetate, and 0 to 99 wt.-% of at least one secondary monomer (B2).

In one embodiment, the polymeric sidechains (B) are obtained by polymerization, in particular by (free) radical polymerization of
10 to 100 wt.-%, preferably 25 to 100 wt.-%, more preferably 50 to 100 wt.-%, most preferably 75 to 100 wt.-%, relative to the total amount of monomers constituting the polymeric sidechains (B), of at least one vinyl ester monomer (B1), and optionally
0 to 90 wt.-%, preferably 0 to 75 wt.-%, more preferably 0 to 50 wt.-%, most preferably 0 to 25 wt.-%, relative to the total amount of monomers constituting the polymeric sidechains (B), of at least one secondary monomer (B2),
   in the presence of polymer backbone (A).

In a preferred embodiment, the polymeric sidechains (B) are obtained by polymerization, in particular by (free) radical polymerization of
65 to 100 wt.-%, preferably 70 to 100 wt.-%, more preferably 75 to 100 wt.-%, most preferably 80 to 100 wt.-%, relative to the total amount of monomers constituting the polymeric sidechains (B), of at least one vinyl ester monomer (B1), and optionally
0 to 35 wt.-%, preferably 0 to 30 wt.-%, more preferably 0 to 25 wt.-%, most preferably 0 to 20 wt.-%, relative to the total amount of monomers constituting the polymeric sidechains (B), of at least one secondary monomer (B2), in the presence of polymer backbone (A).

In a preferred embodiment, the polymeric sidechains (B) are obtained by polymerization of at least one vinyl ester monomer (B1), in particular vinyl acetate, in the presence of polymer backbone (A), in the absence of further monomers.

The graft polymers of the invention may contain a certain amount of ungrafted polymers (“ungrafted side chains”) made of vinyl ester(s), e.g., polyvinylacetate in case only vinyl acetate is employed, and/or, when one or more secondary monomers (B2) are employed, homo- and copolymers of vinyl ester(s) with the secondary monomers. The amount of such ungrafted vinyl ester homo- and copolymers may be high or low, depending on the reaction conditions, but is preferably low. Thus, the amount of grafted side chains is preferably increased. Low amounts of ungrafted vinyl ester homo- and copolymers may be achieved by suitable reaction conditions, such as dosing of vinyl ester and radical initiator and their relative amounts, and also in relation to the amount of backbone being present. This is generally known to the skilled person in the present field.

The inventive graft polymers may be characterized by their degree of grafting (number of graft sites of the polymeric sidechains (B) on the polymer backbone (A)). Preferably, the degree of grafting is low.

This adjustment of the degree of grafting and the amounts of ungrafted polymers can be used to optimize the performance in areas of specific interest, e.g., certain agrochemical compositions, application areas or desired agrochemical performance.

In one embodiment of the present invention, the polymeric sidechains (B) of the graft polymer according to the present invention are fully or at least partially hydrolyzed after the graft polymer as such is obtained. This means that the full or at least partial hydrolyzation of the polymeric sidechains (B) of the graft polymer is carried out after the polymerization process of the polymeric sidechains (B) is finished.

Due to this full or at least partial hydrolyzation of the polymeric sidechains (B) of the graft polymers according to the present invention, the respective sidechain units originating from the at least one vinyl ester monomer (B1) are changed from the respective ester function into the alcohol function within the polymeric sidechain (B). Notably, the corresponding vinyl alcohol is not suitable to be employed as monomer within the polymerization process of the polymeric sidechains (B) due to stability aspects. In order to obtain an alcohol function (hydroxy substituent) within the polymeric sidechains (B) of the graft polymers according to the present invention, the alcohol function is thus typically introduced by hydrolyzing the ester function of the sidechains.

From a theoretical point of view, each ester function of the polymeric sidechain (B) may be replaced by an alcohol function (hydroxy group). In such a case, the polymeric sidechain is fully hydrolyzed (saponified). It is to be noted that in case a secondary monomer (B2) such as N-vinylpyrrolidone is employed, typically no hydrolyzation takes place at those units of the polymeric sidechain (B) which originates from N-vinylpyrrolidone employed as secondary monomer (B2).

The hydrolysis can be carried out by any method known to a person skilled in the art. For example, the hydrolysis can be induced by addition of a suitable base, such as sodium hydroxide or potassium hydroxide.

Within this embodiment, it is preferred that the hydrolyzation of the polymeric sidechains (B) is only carried out partially, for example, to an extent that up to 20 wt.-%, 40 wt.-% or 60 wt.-% of the units derived from vinyl ester monomer (B1) are hydrolyzed, relative to the total weight of vinyl ester monomer (B1).

In one embodiment,
the polymeric sidechains (B) are obtained by radical polymerization of monomers comprising at least one vinyl ester monomer (B1) and at least one secondary monomer (B2), and
the polymeric sidechains (B) are fully or partially hydrolyzed after polymerization, preferably to an extent of up to 50%, relative to the amount of the at least one vinyl ester monomer (B1) employed within the polymerization.

In a preferred embodiment, the polymeric sidechains (B) are not hydrolyzed after polymerization.

It is preferred that no other monomers besides those as defined above in connection with the at least one vinyl ester monomer (B1) and the optional secondary monomer (B2) are employed within the respective polymerization process for obtaining the polymeric sidechains (B). However, if any further monomers besides the monomers according to (B1) and (B2) are present during polymerization, such further monomers (other than B1 and B2) are preferably present in an amount of less than 1 wt.-%, relative the total amount of monomers employed for obtaining the polymeric sidechains (B). Preferably, the amount of said additional monomers is less than 0.5 wt.-%, even more preferably less than 0.01 wt.-%, relative to the total amount of monomers employed for obtaining the polymeric sidechains (B).

In a preferred embodiment, no monomers are employed comprising an acid function. In particular, the monomers employed for obtaining the polymeric sidechains (B) of the graft polymers according to the present invention preferably do not comprise any acid-functional monomers, such as acrylic acid, methacrylic acid, maleic acid, itaconic acid, crotonic acid, vinyl-acetic acid and/or acryloxy-propionic acid.

The weight ratio of the polymer backbone (A) to the polymeric side chains (B) within the graft polymer according to the present invention is not particularly limited. However, the graft polymer typically comprises at least 0.2 wt.-% of the polymeric sidechains (B), relative to the total weight of the graft polymer. Preferably, the graft polymer comprises at least 1 wt.-% of the polymeric sidechains (B), relative to the total weight of the graft polymer.

In a preferred embodiment, the graft polymer comprises 25 to 90 wt.-%, preferably 30 to 85 wt.-%, more preferably 35 to 80 wt.-%, such as 40 to 75 wt.-%, in particular 45 to 70 wt.-%, of the polymer backbone (A), relative to the total weight of the graft polymer.

In a preferred embodiment, the graft polymer comprises 10 to 75 wt.-%, preferably 15 to 70 wt.-%, more preferably 20 to 65 wt.-%, even more preferably 25 to 60 wt.-%, most preferably 30 to 55 wt.-%, of the polymeric sidechains (B), relative to the total weight of the graft polymer. A proportion of polymeric sidechains (B) in this range allows for an increased degree of biodegradability.

It is thus preferred that the graft polymer comprises 25 to 90 wt.-% of the polymer backbone (A) and 10 to 75 wt.-% of the polymeric sidechains (B); preferably 30 to 85 wt.-% of the polymer backbone (A) and 15 to 70 wt.-% of the polymeric sidechains (B); more preferably 35 to 80 wt.-% of the polymer backbone (A) and 20 to 65 wt.-% of the polymeric sidechains (B); such as 40 to 75 wt.-% of the polymer backbone (A) and 25 to 60 wt.-% of the polymeric sidechains (B); in particular 45 to 70 wt.-% of the polymer backbone (A) and 30 to 55 wt.-% of the polymeric sidechains (B); relative to the total weight of the graft polymer.

In a preferred embodiment, the present invention provides an agrochemical composition comprising
(i) an agrochemical active ingredient; and
(ii) a graft polymer comprising
   (A) a polymer backbone as a graft base, having a number average molecular weight Mₙ of 500 to 3,800 g/mol, wherein said polymer backbone is obtainable by polymerization of at least one alkylene oxide selected from the group of C₂- to C₁₀-alkylene oxides, preferably C₂- to C₅-alkylene oxides, such as ethylene oxide, 1,2-propylene oxide, 1,2-butylene oxide, 2,3-butylene oxide, 1,2-pentene oxide or 2,3-pentene oxide; and optionally at least one polyol selected from the group of C₂- to C₁₄-polyols or at least one polyamine selected from the group of C₂- to C₁₄-polyamines; and
   (B) polymeric sidechains grafted onto the polymer backbone (A), wherein said polymeric sidechains (B) are obtainable by polymerization of monomers comprising
      65 to 100 wt.-%, relative to the total amount of monomers constituting the polymeric sidechains (B), of at least one vinyl ester monomer (B1); and optionally
      0 to 35 wt.-%, relative to the total amount of monomers constituting the polymeric sidechains (B), of at least one secondary monomer (B2), preferably 0 to 30 wt.-%;
   in the presence of the polymer backbone (A).

In a further preferred embodiment, the present invention provides an agrochemical composition comprising
(i) an agrochemical active ingredient; and
(ii) a graft polymer comprising
   (A) a polymer backbone as a graft base, having a number average molecular weight Mₙ of 500 to 3,800 g/mol, wherein said polymer backbone is obtainable by polymerization of at least one alkylene oxide selected from the group of C₂- to C₁₀-alkylene oxides, preferably C₂- to C₅-alkylene oxides, such as ethylene oxide, 1,2-propylene oxide, 1,2-butylene oxide, 2,3-butylene oxide, 1,2-pentene oxide or 2,3-pentene oxide; and optionally at least one polyol selected from the group of C₂- to C₁₄-polyols or at least one polyamine selected from the group of C₂- to C₁₄-polyamines; and
   (B) polymeric sidechains grafted onto the polymer backbone (A), wherein said polymeric sidechains (B) are obtainable by polymerization of monomers comprising
      65 to 100 wt.-%, relative to the total amount of monomers constituting the polymeric sidechains (B), of at least one vinyl ester monomer (B1); and optionally
      0 to 35 wt.-%, relative to the total amount of monomers constituting the polymeric sidechains (B), of at least one secondary monomer (B2), preferably 0 to 30 wt.-%;
   in the presence of the polymer backbone (A)
      wherein the graft polymer comprises 25 to 90 wt.-%, in particular 45 to 70 wt.-%, of the polymer backbone (A) and 10 to 75 wt.-%, in particular 30 to 55 wt.-%, of the polymeric sidechains (B), relative to the total weight of the graft polymer.

The following specific embodiments highlight certain aspects of the graft polymer. It is understood that the above discussion and embodiments also apply to the following specific embodiments, where applicable.

In a first specific embodiment, the graft polymer comprises:
(A) a polymer backbone as a graft base, wherein said polymer backbone is obtainable by polymerization of at least one alkylene oxide selected from the group of C₂- to C₁₀-alkylene oxides, preferably C₂- to C₅-alkylene oxides, such as ethylene oxide, 1,2-propylene oxide, 1,2-butylene oxide, 2,3-butylene oxide, 1,2-pentene oxide or 2,3-pentene oxide; and
(B) polymeric sidechains grafted onto the polymer backbone (A), wherein said polymeric sidechains (B) are obtainable by copolymerization of monomers comprising at least one vinyl ester monomer (B1) and at least one secondary monomer (B2) in the presence of the polymer backbone (A), wherein the secondary monomer (B2) comprises
   (B2a) at least one olefinically unsaturated nitrogen-containing monomer, selected from 1-vinylimidazole or C₁-C₈-alkyl-substituted derivatives of 1-vinylimidazole including 2-methyl-1-vinylimidazole, preferably 1-vinylimidazole; and, optionally
   (B2b) at least one further olefinically unsaturated nitrogen-containing monomer, selected from vinyl lactams, being preferably selected from N-vinyl lactams, such as N-vinylpyrrolidone, N-vinylpiperidone and N-vinylcaprolactam, more preferably N-vinylpyrrolidone and N-vinylcaprolactam, and most preferably N-vinylpyrrolidone.

In this embodiment, the graft polymer preferably comprises:
1 to 30 wt.-%, preferably 3 to 25 wt.-%, more preferably 5 to 20 wt.-%, most preferably 10 to 20 wt.-% of the vinyl ester monomer (B1), and
10 to 60 wt.-%, preferably of 20 to 50 wt.-%, more preferably 20 to 40 wt.-%, most preferably 25 to 35 wt.-% of the secondary monomer (B2),
   relative to the total weight of the graft polymer.

Further in this embodiment, the secondary monomer (B2) preferably comprises 10 to 100 wt.-%, preferably of 20 to 90 wt.-%, more preferably 30 to 80 wt.-%, most preferably 40 to 70 wt.-% of olefinically unsaturated nitrogen-containing monomer (B2a) relative to the total amount of secondary monomer (B2).

Further in this embodiment, it is particularly preferred that vinyl ester monomer (B1) is vinyl acetate, olefinically unsaturated nitrogen-containing monomer (B2a) is 1-vinylimidazole, and olefinically unsaturated nitrogen-containing monomer (B2b) is N-vinylpyrrolidone.

In a second specific embodiment, the graft polymer comprises:
(A) a statistical copolymer backbone as a graft base, wherein said statistical copolymer backbone is obtainable by polymerization of at least two alkylene oxides selected from the group of C₂- to C₁₀-alkylene oxides, preferably C₂- to C₅-alkylene oxides, such as ethylene oxide, 1,2-propylene oxide, 1,2-butylene oxide, 2,3-butylene oxide, 1,2-pentene oxide or 2,3-pentene oxide; and
(B) polymeric sidechains grafted onto the statistical copolymer backbone (A), wherein said polymeric sidechains (B) are obtainable by polymerization of monomers comprising at least one vinyl ester monomer (B1) in the presence of the statistical copolymer backbone (A).

In this embodiment, the number average molecular weight Mₙ of the statistical copolymer backbone (A) is preferably 500 to 6,000 g/mol, preferably at most 5,500 g/mol, more preferably at most 5,000 g/mol, even more preferably at most 4,500 g/mol, in particular at most 4,000 g/mol, such as at most 3,800 g/mol or at most 3,500 g/mol, especially at most 3,000 g/mol, even more preferably at most 2,750 g/mol and most preferably at most 2,700 g/mol or at most 2,650 g/mol, and preferably at least 800 g/mol or at least 1,000 g/mol, more preferably at least 1,200 g/mol.

In a third specific embodiment, the graft polymer comprises:
(A) a polymer backbone as a graft base, wherein said polymer backbone is obtainable by polymerization of ethylene oxide; and
(B) polymeric sidechains grafted onto the statistical copolymer backbone (A), wherein said polymeric sidechains (B) are obtainable by polymerization of monomers comprising at least one vinyl ester monomer (B1) in the presence of the polymer backbone (A).

In this embodiment, the number average molecular weight Mₙ of the polymer backbone (A) is preferably 500 to 5,000 g/mol, preferably at most 4,000 g/mol, more preferably at most 3,800 g/mol or at most 3,500 g/mol, even more preferably at most 3,000 g/mol, such as at most 2,750 g/mol, and most preferably at most 2,700 g/mol or at most 2,650 g/mol.

Further in this embodiment, it is preferable that the product of formula P

$$P = [ \text{} molecular weight of the polymer backbone {M}_{n} in g / mol ] \times [ \text{} percentage of grafting of vinyl acetate based on total polymer weight , with polymer weight being set to “ 1 ” and the percentage of grafting as fractions thereof ]$$

is at most 1500, preferably at most 1200, more preferably at most 1000, even more preferably at most 800, and most preferably at most 600 such as at most 400, or even at most 300, and is at least 100, preferably at least 150, and more preferably at least 200.

In a fourth specific embodiment, the graft polymer comprises:
(A) a block copolymer backbone as a graft base, wherein said block copolymer backbone (A) is obtainable by block copolymerization of at least two alkylene oxides selected from ethylene oxide, 1,2-propylene oxide, 1,2-butylene oxide, 2,3-butylene oxide, 1,2-pentene oxide or 2,3-pentene oxide, and
(B) polymeric sidechains grafted onto the block copolymer backbone, wherein said polymeric sidechains (B) are obtainable by polymerization of monomers comprising at least one vinyl ester monomer (B1), and optionally N-vinylpyrrolidone (B2).

In this embodiment, the alkylene oxides are preferably selected from ethylene oxide, 1,2-propylene oxide and 1,2-butylene oxide. Preferably, one of the at least two alkylene oxides employed is ethylene oxide, and preferably the second alkylene oxide employed is 1,2-propylene oxide. Most preferably, the block copolymer backbone (A) is obtainable by block copolymerization of ethylene oxide and 1,2-propylene oxide. Preferably, the number (x) of individual blocks within the block copolymer backbone (A) is an integer, wherein x is from 3 to 10, preferably from 3 to 5, more preferably x is 3.

Suitable block copolymer backbones (A) are described, for example, in EP 0 362 688 A2. It is preferred that the respective alkylene oxides to be employed for preparing the individual blocks of the block copolymer backbone (A) are added in sequence. However, it is possible at the transition of the feed from one alkylene oxide to the other to produce so called “dirty structures” wherein at the edge/border of the respective block a small number of alkylene oxides of the respective neighboring block may be contained within the individual block to be considered. However, it is preferred that the block copolymer backbones (A) according to the present invention do not contain any so called “dirty structures” or “dirty passages” at the respective border of the blocks.

Further in this embodiment, it is preferred that the block copolymer backbone (A) is a triblock copolymer of polyethylene oxide (PEG) and polypropylene oxide (PPG), preferably having the structure according to formula (A1) or formula (A2), wherein formula (A1) is defined as follows:

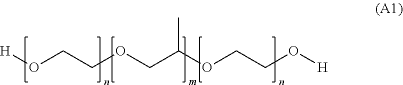

wherein
n is an integer in the range of 2 to 100, preferably of 3 to 80, and
m is an integer in the range of 2 to 100, preferably of 10 to 70, more preferably of 14 to 54, and
formula (A2) is defined as follows:

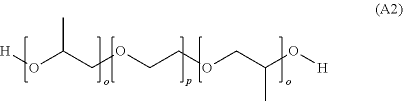

wherein
o is an integer in the range of 2 to 100, preferably of 5 to 50, more preferably of 8 to 27, and
p is an integer in the range of 2 to 100, preferably of 5 to 50, more preferably of 7 to 24,
with structure (A2) being particularly preferred. A block copolymer backbone (A) having structure (A2) allows for a particularly high degree of biodegradability.

Further in this embodiment, it is preferred that the graft polymer is a polymer wherein the copolymer (A) is a triblock copolymer of polyethylene oxide and polypropylene oxide, and wherein the number average molecular weight Mₙ of the triblock copolymer backbone (A) is lower than 6,000 g/mol, preferably lower than 5,000 g/mol, more preferably lower than 3,800 g/mol or lower than 3,650 g/mol and even more preferably lower than 3,000 g/mol, such as lower than 2,750 g/mol or lower than 2,700 g/mol.

Of the four specific embodiments provided above, the third and fourth embodiment are especially preferred.

The graft polymer of the inventive composition preferably has a weight average molecular weight M_{w} of 1,000 to 100,000 g/mol, preferably 2,000 to 45,000 g/mol and more preferably 3,000 to 30,000 g/mol. It was found that the biodegradability of the graft polymers increases with decreasing weight average molecular weight of the graft polymer.

The graft polymers of the inventive composition preferably have a low polydispersity. It is preferred that the graft polymer has a polydispersity M_{w}/Mₙ of less than 7, preferably less than 5, more preferably less than 3, in particular less than 2.5, such as less than 2.3, and most preferably in the range from 1.0 to 2.2, with M_{w} being the weight average molecular weight and Mₙ being the number average molecular weight, and polydispersity being without unit [g/mol/g/mol]). The respective values of M_{w} and/or Mₙ can be determined as described in the experimental part below.

The graft polymers of the inventive composition preferably have at least one of the following properties, in particular two or more, to be successfully employed as agrochemical compositions:
Biodegradability of a certain level. Biodegradation is preferably at least 30%, more preferably at least 40%, and most preferably at least 50%, such as 35, 45, 55, 60, 65, 75, 80, 85 or more up to 100% (all percentages in weight-% based on the total solid content) within 28 days according to OECD 301 F.
The polymers should be water-soluble to a certain extent, so as to be able to employ the polymers within the aqueous environment typically present in agrochemical applications. Preferably, inventive polymers should exhibit a medium to good, more preferably a very good solubility in water.
Viscosities of the polymer solutions should be such that at reasonably high solid concentrations of the polymer as to be handled in and after production and to be provided to the user, which could be e.g., as a “pure” (then typically liquid) product, dissolved in a solvent, typically an aqueous solution containing water and organic solvents, only water or only organic solvents, the viscosity of such polymer or polymer solution being in a range that allows typical technical process steps such as pouring, pumping, dosing etc.

Hence, the viscosities are be preferably in the range of about up to less than 4000 mPa·s, more preferably up to 3500 mPa·s, even more preferably up to 3000 mPa·s, such as up to 4500, 3750, 3250, 2750 or even 2600 or below such as 2500, 2000, 1750, 1500, 1250, 1000, 750, 500, 250, 200, 150, or 100 mPa·s, at concentrations of the polymer (based on the total solid content of the polymer in solution, as defined by weight percent of the dry polymer within the total weight of the polymer solution) of preferably at least 10 wt.-%, more preferably at least 20 wt.-%, and even more preferably at least 40 wt.-%, and most preferably at least 50 wt.-%, such as at least 60, 70, 80 or even 90 wt.-%. The viscosity may be determined as described below in the experimental part.

The viscosity may be measured at either 25° C. or at elevated temperature, e.g., temperatures of 50 or even 60° C. By this a suitable handling of the polymer solutions in commercial scales is possible. It is of course evident that depending on the amount of solvent being added the viscosity is lower when the amount of solvent increases and vice versa, thus allowing for adjustment in case desired. It is also evident that the viscosity being measured depends on the temperature at which it is being measured, e.g., the viscosity of a given polymer with a given solid content of e.g., 80 wt.-% will be higher when measured at lower temperature and lower when measured at a higher temperature. In a preferred embodiment the solid content is in between 70 and 99 wt.-%, more preferably in between 75 and 85 wt.-%, with no additional solvent being added but the polymer as prepared. In a more preferred embodiment, the solid content is in between 70 and 99 wt.-%, more preferably in between 75 and 95 wt.-%, with no additional solvent being added but the polymer as prepared, and the viscosity is lower than 3000 mPa·s, more preferably 3250, or even below 2750, 2600, 2500, 2000, 1750, 1500, 1250, 1000, 750, 500 or even 250 mPa·s, when measured at 60° C.

Biodegradability increases with each of the following conditions:
lower molecular weight of the polymer backbone (A) compared to higher molecular weight; and/or
lower weight percentage of polymeric side chains (B) being grafted onto the backbone compared to higher weight percentages.

Preferable graft polymers are obtained using at least one of the following conditions:
I) a polymer backbone (A) with a number average molecular weight Mₙ of at most 3,800 g/mol, preferably at most 3,500 g/mol, more preferably at most 3,000 g/mol, more preferably at most 2,750 g/mol, most preferably at most 2,700 g/mol or at most 2,650 g/mol;
II) weight percentage of polymeric side chains of the graft polymers, relative to the total weight of the graft polymer, of more than 10 wt.-%, preferably at least 15 wt.-%, more preferably at least 20 wt.-%, and even more preferably at least 30 wt.-%, to at most 75 wt.-%, more preferably at most 70 wt.-%, even more preferably at most 65 wt.-%, most preferably at most 60 wt.-% or at most 55%;
III) graft polymers have a backbone having a weight percentage of ethylene oxide (EO)-moiety to total alkylene oxide moiety present in the backbone (A) of at least 10%.

The graft polymer of the inventive composition may be prepared by polymerizing at least one monomer (B1) and optionally at least one secondary monomer (B2) in the presence of the polymer backbone (A). The grafting process as such, wherein a polymeric backbone is grafted with polymeric sidechains, is well-known. Any grafting process known to the skilled person can be employed within the present invention.

Preferably, the polymeric sidechains (B) are obtained by radical polymerization. Radical polymerization as such is known to the skilled person. The grafting process can be carried out in the presence of a radical-forming initiator (C) and/or at least one solvent (D), suitable representatives of which are well-known.

The term “radical polymerization” as used herein comprises besides the free radical polymerization also variants thereof, such as controlled radical polymerization. Suitable control mechanisms are RAFT, NMP or ATRP, which are each known to the skilled person, including suitable control agents.

It is even more preferred that the process for obtaining the graft polymer is carried out by a method comprising the polymerization of at least one monomer (B1) selected from vinyl acetate or vinyl propionate and optionally N-vinylpyrrolidone as secondary monomer (B2) in order to obtain the polymer sidechains (B) in the presence of a polymer backbone (A), a free radical-forming initiator (C) and, if desired, up to 50 wt.-%, based on the sum of components (A), (B1), optionally (B2), and (C) of at least one organic solvent (D), at a mean polymerization temperature at which the initiator (C) has a decomposition half-life of 40 to 500 min, in such a way that the fraction of unconverted monomers (B1) and optionally (B2) and initiator (C) in the reaction mixture is constantly kept in a quantitative deficiency relative to the polymer backbone (A).

The amount of initiator (C) is preferably from 0.1 to 5 wt.-%, in particular from 0.3 to 3.5 wt.-%, based in each case on the polymeric sidechains (B).

Preferably, the steady-state concentration of radicals present at the mean polymerization temperature is substantially constant and the monomers (B1) and optionally (B2) are present in the reaction mixture constantly only in low concentration (for example of at most 5 wt.-% in total). This allows the reaction to be controlled, and graft polymers can be prepared in a controlled manner with the desired low polydispersity.

The term “mean polymerization temperature” is understood to mean that, although the process is substantially isothermal, there may, owing to the exothermicity of the reaction, be temperature variations which are preferably kept within the range of +/−10° C., more preferably in the range of +/−5° C.

At the mean polymerization temperature, the initiator (C) should have a decomposition half-life of 40 to 500 min, preferably from 50 to 400 min and more preferably from 60 to 300 min.

The initiator (C) and the monomers (B1) and optionally (B2) are advantageously added in such a way that a low and substantially constant concentration of undecomposed initiator and monomers (B1) and optionally (B2) is present in the reaction mixture. The proportion of undecomposed initiator in the overall reaction mixture is preferably less than 15 wt.-%, in particular less than 10 wt.-%, based on the total amount of initiator added during the monomer addition.

The mean polymerization temperature is appropriately in the range of 50 to 140° C., preferably of 60 to 120° C. and more preferably of 65 to 110° C.

Examples of suitable initiators (C) whose decomposition half-life in the temperature range from 50 to 140° C. is from 20 to 500 min are:
O—C₂-C₁₂-acylated derivatives of tert-C₄-C₁₂-alkyl hydroperoxides and tert-(C₉-C₁₂-aralkyl) hydroperoxides, such as tert-butyl peroxyacetate, tert-butyl monoperoxymaleate, tert-butyl peroxyisobutyrate, tert-butyl peroxypivalate, tert-butyl peroxyneoheptanoate, tert-butyl peroxy-2-ethylhexanoate, tert-butyl peroxy-3,5,5-trimethylhexanoate, tert-butyl peroxyneodecanoate, tert-amyl peroxypivalate, tert-amyl peroxy-2-ethylhexanoate, tert-amyl peroxyneo-decanoate, 1,1,3,3-tetramethylbutyl peroxyneodecanoate, cumyl peroxyneo-decanoate, tert-butyl peroxybenzoate, tert-amyl peroxybenzoate and di-tert-butyl diperoxyphthalate;
di-O—C₄-C₁₂-acylated derivatives of tert-C₈-C₁₄-alkylene bisperoxides, such as 2,5-dimethyl-2,5-di(2-ethylhexanoylperoxy)hexane, 2,5-dimethyl-2,5-di(benzoyl-peroxy)hexane and 1,3-di(2-neodecanoylperoxyisopropyl)benzene;
di(C₂-C₁₂-alkanoyl) and dibenzoyl peroxides, such as diacetyl peroxide, dipropionyl peroxide, disuccinyl peroxide, dicapryloyl peroxide, di(3,5,5-trimethylhexanoyl) peroxide, didecanoyl peroxide, dilauroyl peroxide, dibenzoyl peroxide, di(4-methylbenzoyl) peroxide, di(4-chlorobenzoyl) peroxide and di(2,4-dichlorobenzoyl) peroxide;
tert-C₄-C₅-alkyl peroxy(C₄-C₁₂-alkyl)carbonates, such as tert-amyl peroxy(2-ethyl-hexyl)carbonate;
di(C₂-C₁₂-alkyl) peroxydicarbonates, such as di(n-butyl) peroxydicarbonate and di(2-ethylhexyl) peroxydicarbonate.

Depending on the mean polymerization temperature, examples of particularly suitable initiators (C) are:
at a mean polymerization temperature of 50 to 60° C.: tert-butyl peroxyneoheptanoate, tert-butyl peroxyneodecanoate, tert-amyl peroxypivalate, tert-amyl peroxyneodecanoate, 1,1,3,3-tetramethylbutyl peroxyneodecanoate, cumyl peroxyneodecanoate, 1,3-di(2-neodecanoyl peroxyisopropyl)benzene, di(n-butyl) peroxydicarbonate and di(2-ethylhexyl) peroxydicarbonate;
at a mean polymerization temperature of 60 to 70° C.: tert-butyl peroxypivalate, tert-butyl peroxyneoheptanoate, tert-butyl peroxyneodecanoate, tert-amyl peroxypivalate and di(2,4-dichlorobenzoyl) peroxide;
at a mean polymerization temperature of 70 to 80° C.: tert-butyl peroxypivalate, tert-butyl peroxyneoheptanoate, tert-amyl peroxypivalate, dipropionyl peroxide, dicapryloyl peroxide, didecanoyl peroxide, dilauroyl peroxide, di(2,4-dichlorobenzoyl) peroxide and 2,5-dimethyl-2,5-di(2-ethylhexanoylperoxy)hexane;
at a mean polymerization temperature of 80 to 90° C.: tert-butyl peroxyisobutyrate, tert-butyl peroxy-2-ethylhexanoate, tert-amyl peroxy-2-ethylhexanoate, dipropionyl peroxide, dicapryloyl peroxide, didecanoyl peroxide, dilauroyl peroxide, di(3,5,5-trimethylhexanoyl) peroxide, dibenzoyl peroxide and di(4-methylbenzoyl) peroxide;
at a mean polymerization temperature of 90 to 100° C.: tert-butyl peroxyisobutyrate, tert-butyl peroxy-2-ethylhexanoate, tert-butyl monoperoxymaleate, tert-amyl peroxy-2-ethylhexanoate, dibenzoyl peroxide and di(4-methylbenzoyl) peroxide;
at a mean polymerization temperature of 100 to 110° C.: tert-butyl monoperoxymaleate, tert-butyl peroxyisobutyrate and tert-amyl peroxy(2-ethylhexyl)carbonate;
at a mean polymerization temperature of 110 to 120° C.: tert-butyl monoperoxymaleate, tert-butyl peroxy-3,5,5-trimethylhexanoate and tert-amyl peroxy(2-ethylhexyl)carbonate.

Preferred initiators (C) are O—C₄-C₁₂-acylated derivatives of tert-C₄-C₅-alkyl hydroperoxides, particular preference being given to tert-butyl peroxypivalate and tert-butyl peroxy-2-ethylhexanoate.

Particularly advantageous polymerization conditions can be established by precise adjustment of initiator (C) and polymerization temperature. For instance, the preferred mean polymerization temperature in the case of use of tert-butyl peroxypivalate is from 60 to 80° C., and, in the case of tert-butyl peroxy-2-ethylhexanoate, from 80 to 100° C.

The polymerization reaction can be carried out in the presence of, preferably small amounts of, an organic solvent (D). It is of course also possible to use mixtures of different solvents (D). Preference is given to using water-soluble or water-miscible solvents.

When a solvent (D) is used as a diluent, generally from 1 to 40 wt.-%, preferably from 1 to 35 wt.-%, more preferably from 1.5 to 30 wt.-%, most preferably from 2 to 25 wt.-%, based in each case on the sum of the components (A), (B1), optionally (B2), and (C), are used.

Examples of suitable solvents (D) include:
monohydric alcohols, preferably aliphatic C₁-C₁₆-alcohols, more preferably aliphatic C₂-C₁₂-alcohols, most preferably C₂-C₄-alcohols, such as ethanol, propanol, isopropanol, butanol, sec-butanol and tert-butanol;
polyhydric alcohols, preferably C₂-C₁₀-diols, more preferably C₂-C₆-diols, most preferably C₂-C₄-alkylene glycols, such as ethylene glycol, 1,2-propylene glycol and 1,3-propylene glycol;
alkylene glycol ethers, preferably alkylene glycol mono(C₁-C₁₂-alkyl) ethers and alkylene glycol di(C₁-C₆-alkyl) ethers, more preferably alkylene glycol mono- and di(C₁-C₂-alkyl) ethers, most preferably alkylene glycol mono(C₁-C₂-alkyl) ethers, such as ethylene glycol monomethyl and -ethyl ether and propylene glycol monomethyl and -ethyl ether;
polyalkylene glycols, preferably poly(C₂-C₄-alkylene) glycols having 2-20 C₂-C₄-alkylene glycol units, more preferably polyethylene glycols having 2-20 ethylene glycol units and polypropylene glycols having 2-10 propylene glycol units, most preferably polyethylene glycols having 2-15 ethylene glycol units and polypropylene glycols having 2-4 propylene glycol units, such as diethylene glycol, triethylene glycol, dipropylene glycol and tripropylene glycol;
polyalkylene glycol monoethers, preferably poly(C₂-C₄-alkylene) glycol mono(C₁-C₂₅-alkyl) ethers having 2-20 alkylene glycol units, more preferably poly(C₂-C₄-alkylene) glycol mono(C₁-C₂₀-alkyl) ethers having 2-20 alkylene glycol units, most preferably poly(C₂-C₃-alkylene) glycol mono(C₁-C₁₆-alkyl) ethers having 3-20 alkylene glycol units;
carboxylic esters, preferably C₁-C₈-alkyl esters of C₁-C₆-carboxylic acids, more preferably C₁-C₄-alkyl esters of C₁-C₃-carboxylic acids, most preferably C₂-C₄-alkyl esters of C₂-C₃-carboxylic acids, such as ethyl acetate and ethyl propionate;
aliphatic ketones which preferably have from 3 to 10 carbon atoms, such as acetone, methyl ethyl ketone, diethyl ketone and cyclohexanone;
cyclic ethers, in particular tetrahydrofuran and dioxane.

The solvents (D) are advantageously those solvents which may also used to formulate the agrochemical composition and can therefore remain in the polymerization product, including solvents selected from polyethylene glycols having 2-15 ethylene glycol units, polypropylene glycols having 2-6 propylene glycol units and in particular alkoxylation products of C₆-C₈-alcohols (alkylene glycol monoalkyl ethers and polyalkylene glycol monoalkyl ethers).

Particular preference is given to alkoxylation products of C₈-C₁₆-alcohols with a high degree of branching, which allow the composition of polymer mixtures which are free-flowing at 40 to 70° C. and have a very low polymer content at comparatively low viscosity. The branching may be present in the alkyl chain of the alcohol and/or in the polyalkoxylate moiety (copolymerization of at least one propylene oxide, butylene oxide or isobutylene oxide unit). Particularly suitable examples of these alkoxylation products are 2-ethylhexanol or 2-propylheptanol alkoxylated with 1 to 15 mol of ethylene oxide, C₁₃/C₁₅ oxo alcohol or C₁₂/C₁₄ or C₁₆/C₁₈ fatty alcohol alkoxylated with 1 to 15 mol of ethylene oxide and 1 to 3 mol of propylene oxide, preference being given to 2-propyl-heptanol alkoxylated with 1 to 15 mol of ethylene oxide and 1 to 3 mol of propylene oxide.

Polymer backbone (A), monomer (B1) and optionally (B2), initiator (C) and, if appropriate, solvent (D) are usually heated to the selected mean polymerization temperature in a reactor.

The polymerization is preferably carried out in such a way that an excess of polymer (polymer backbone (A) and formed graft polymer (B)) is constantly present in the reactor. The quantitative ratio of polymer to ungrafted monomer and initiator is generally at least 10:1, preferably at least 15:1 and more preferably at least 20:1.

The polymerization process can be carried out in various reactor types.

The reactor used is preferably a stirred tank in which the polymer backbone (A), if appropriate together with portions, of generally up to 15 wt.-% of the particular total amount, of monomers (B1) and optionally (B2), initiator (C) and solvent (D), are initially charged fully or partly and heated to the polymerization temperature, and the remaining amounts of (B1), (B2), (C) and, if appropriate, (D) are metered in, preferably separately. The remaining amounts of (B1), (B2), (C) and, if appropriate, (D) are metered in preferably over a period of at least 2 h, more preferably of at least 4 h and most preferably of at least 5 h.

In the case of the particularly preferred, substantially solvent-free process variant, the entire amount of polymer backbone (A) is initially charged as a melt and the monomers (B1) and optionally (B2), and also the initiator (C) present preferably in the form of a from 10 to 50 wt.-% solution in one of the solvents (D), are metered in, the temperature being controlled such that the selected polymerization temperature, on average during the polymerization, is maintained with a range of especially +/−10° C., in particular +/−5° C.

In a further particularly preferred, low-solvent process variant, the procedure is as described above, except that solvent (D) is metered in during the polymerization in order to limit the viscosity of the reaction mixture. It is also possible to commence with the metered addition of the solvent only at a later time with advanced polymerization, or to add it in portions.

The polymerization can be affected under standard pressure or at reduced or elevated pressure. When the boiling point of the monomers (B1) or (B2) or of any diluent (D) used is exceeded at the selected pressure, the polymerization is carried out with reflux cooling.

After completion of the polymerization, volatiles may be removed under vacuum.

The agrochemical composition of the invention comprises, besides the graft polymer, an agrochemical active ingredient. It was found that the graft polymer of the inventive composition is suitable as a dispersant for a broad range of agrochemical active ingredients. The term “agrochemical active ingredient” refers to a substance that confers a desirable biological activity to the agrochemical composition.

Agrochemical active ingredients include pesticides, safeners, nitrification inhibitors, urease inhibitors, micronutrients, and/or plant growth regulators. Typically, the agrochemical active ingredient is a pesticide. Pesticides include insecticides, herbicides, fungicides, algaecides, rodenticides, molluscicides and nematicides. The skilled person is familiar with pesticides, which can be found, for example, in the Pesticide Manual, 16th Ed. (2013), The British Crop Protection Council, London.

Preferably, the agrochemical active ingredient is selected from insecticides, fungicides, and herbicides.

Suitable insecticides are insecticides from the classes of carbamates, organophosphates, organochlorine insecticides, phenylpyrazoles, pyrethroids, neonicotinoids, spinosins, avermectins, milbemycins, juvenile hormone analogs, alkyl halides, organotin compounds nereistoxin analogs, benzoylureas, diacylhydrazines, METI acarizides, and insecticides such as chloropicrin, pymetrozin, flonicamid, clofentezin, hexythiazox, etoxazole, diafenthiuron, propargite, tetradifon, chlorofenapyr, DNOC, buprofezine, cyromazine, amitraz, hydramethylnon, acequinocyl, fluacrypyrim, rotenone, afidopyropene, amidrazones, dimpropyridaz, fipronil or their derivatives.

Suitable fungicides are fungicides from the classes of dinitroanilines, allylamines, anilinopyrimidines, antibiotics, aromatic hydrocarbons, benzenesulfonamides, benzimidazoles, benzisothiazoles, benzophenones, benzothiadiazoles, benzotriazines, benzyl carbamates, carbamates, carboxamides such as fluxapyroxad and diflufenican, carboxylic acid diamides, chloronitriles such as chlorothalonil, cyanoacetamide oximes, cyanoimidazoles, cyclopropanecarboxamides, dicarboximides, dihydrodioxazines, dinitrophenyl crotonates, dithiocarbamates, dithiolanes, ethylphosphonates, ethylaminothiazolecarboxamides, guanidines, hydroxy-(2-amino)pyrimidines, hydroxyanilides, imidazoles, imidazolinones, inorganic substances, isobenzofuranones, methoxyacrylates such as azoxystrobin, methoxycarbamates, morpholines, N-phenylcarbamates, oxazolidinediones, oximinoacetates, oximinoacetamides, peptidylpyrimidine nucleosides, phenylacetamides, phenylamides, phenylpyrroles such as fludioxonil, phenylureas, phosphonates, phosphorothiolates, phthalamic acids, phthalimides, piperazines, piperidines, propionamides, pyridazinones, pyridines, pyridinylmethylbenzamides, pyrimidinamines, pyrimidines, pyrimidinonehydrazones, pyrroloquinolinones, quinazolinones, quinolines, quinones, sulfamides, sulfamoyltriazoles, tetrazolinones such as metyltetraprole, thiazolecarboxamides, thiocarbamates, thiophanates, thiophenecarboxamides, toluamides, triphenyltin compounds, triazines, and conazole fungicides, in particular triazoles such as mefentrifluconazole, triticonazole, prothioconazole and tebuconazol. Azoxystrobin, fluxapyroxad, fludioxonil, prothioconazole, chlorothalonil, diflufenican, metyltetraprole, mefentrifluconazole and tebuconazol, in particular azoxystrobin, fluxapyroxad and chlorothalonil and diflufenican, especially azoxystrobin, are especially preferred fungicides.

Suitable herbicides are herbicides from the classes of the acetamides, amides, aryloxyphenoxypropionates, benzamides, benzofuran, benzoic acids, benzothiadiazinones, bipyridylium, carbamates, cinmethylin, chloroacetamides, chlorocarboxylic acids, cyclohexanediones, dinitroanilines, dinitrophenol, diphenyl ether, glycines, imidazolinones, isoxazoles, isoxazolidinones, nitriles, N-phenylphthalimides, oxadiazoles, oxazolidinediones, oxyacetamides, phenoxycarboxylic acids, phenylcarbamates, phenylpyrazoles, phenylpyrazolines, phenylpyridazines, phosphinic acids such as glufosinate, phosphoroamidates, phosphorodithioates, phthalamates, pyrazoles such as pyroxasulfone, pyridazinones, pyridines, pyridinecarboxylic acids, pyridinecarboxamides, pyrimidinediones, pyrimidinyl(thio)benzoates, quinolinecarboxylic acids, semicarbazones, sulfonylaminocarbonyltriazolinones, sulfonylureas, tetrazolinones, thiadiazoles, thiocarbamates, triazines such as atrazine, indaziflam and terbuthylazine, triazinones such as metribuzin, triazoles, triazolinones, triazolocarboxamides, triazolopyrimidines, triketones, uracils including aryl uracils such as saflufenacil, and ureas. Atrazine, indaziflam, saflufenacil, pyroxasulfone, glufosinate, cinmethylin, terbuthylazine and metribuzine, in particular atrazine, are especially preferred herbicides.

In a particularly preferred embodiment, the agrochemical active ingredient is selected from azoxystrobin, fluxapyroxad, fludioxonil, chlorothalonil, atrazine, metyltetraprole, mefentrifluconazole, prothioconazole, tebuconazole, terbuthylazine, diflufenican, and metribuzin, preferably from azoxystrobin, fluxapyroxad, fludioxonil, prothioconazole, chlorothalonil, diflufenican, terbuthylazine and atrazine, and is most preferably azoxystrobin.

Suitable safeners include (quinolin-8-oxy)acetic acids, 1-phenyl-5-haloalkyl-1H-1,2,4-triazol-3-carboxylic acids, 1-phenyl-4,5-dihydro-5-alkyl-1 H-pyrazol-3,5-dicarboxylic acids, 4,5-dihydro-5,5-diaryl-3-isoxazol carboxylic acids, dichloroacetamides, alpha-oximinophenylacetonitriles, acetophenonoximes, 4,6-dihalo-2-phenylpyrimidines, N-[[4-(aminocarbonyl)phenyl]sulfonyl]-2-benzoic amides, 1,8-naphthalic anhydride, 2-halo-4-(haloalkyl)-5-thiazol carboxylic acids, phosphorthiolates and N-alkyl-O-phenyl-carbamates and their agriculturally acceptable salts and their agriculturally acceptable derivatives such amides, esters, and thioesters, provided they have an acid group.

Suitable nitrification inhibitors are linoleic acid, alpha-linolenic acid, methyl p-coumarate, methyl ferulate, methyl 3-(4-hydroxyphenyl) propionate (MHPP), Karanjin, brachialacton, p-benzoquinone sorgoleone, 2-chloro-6-(trichloromethyl)-pyridine (nitrapyrin or N-serve), dicyandiamide (DCD, DIDIN), 3,4-dimethyl pyrazole phosphate (DMPP, ENTEC), 4-amino-1,2,4-triazole hydrochloride (ATC), 1-amido-2-thiourea (ASU), 2-amino-4-chloro-6-methylpyrimidine (AM), 2-mercapto-benzothiazole (MBT), 5-ethoxy-3-trichloromethyl-1,2,4-thiodiazole (terrazole, etridiazole), 2-sulfanilamidothiazole (ST), ammoniumthiosulfate (ATU), 3-methylpyrazol (3-MP), 3,5-dimethylpyrazole (DMP), 1,2,4-triazol thiourea (TU), N-(1 H-pyrazolyl-methyl)acetamides such as N-((3(5)-methyl-1 H-pyrazole-1-yl)methyl)acetamide, and N-(1 H-pyrazolyl-methyl)formamides such as N-((3(5)-methyl-1 H-pyrazole-1-yl)methyl formamide, N-(4-chloro-3(5)-methyl-pyrazole-1-ylmethyl)-formamide, N-(3(5),4-dimethyl-pyrazole-1-ylmethyl)-formamide, neem, products based on ingredients of neem, cyan amide, melamine, zeolite powder, catechol, benzoquinone, sodium terta board, zinc sulfate, 2-(3,4-dimethyl-1 H-pyrazol-1-yl)succinic acid (referred to as “DMPSA1” in the following) and/or 2-(4,5-dimethyl-1H-pyrazol-1-yl)succinic acid (referred to as “DMPSA2” in the following), and/or a derivative thereof, and/or a salt thereof; glycolic acid addition salt of 3,4-dimethyl pyrazole (3,4-dimethyl pyrazolium glycolate, referred to as “DMPG” in the following), and/or an isomer thereof, and/or a derivative thereof; citric acid addition salt of 3,4-dimethyl pyrazole (3,4-dimethyl pyrazolium citrate, referred to as “DMPC” in the following), and/or an isomer thereof, and/or a derivative thereof; lactic acid addition salt of 3,4-dimethyl pyrazole (3,4-dimethyl pyrazolium lactate, referred to as “DMPL” in the following), and/or an isomer thereof, and/or a derivative thereof; mandelic acid addition salt of 3,4-dimethyl pyrazole (3,4-dimethyl pyrazolium mandelate, referred to as “DMPM” in the following), and/or an isomer thereof, and/or a derivative thereof; 1,2,4-triazole (referred to as “TZ” in the following), and/or a derivative thereof, and/or a salt thereof; 4-Chloro-3-methylpyrazole (referred to as “CIMP” in the following), and/or an isomer thereof, and/or a derivative thereof, and/or a salt thereof; a reaction adduct of dicyandiamide, urea and formaldehyde, or a triazonyl-formaldehyde-dicyandiamide adduct; 2-cyano-1-((4-oxo-1,3,5-triazinan-1-yl)methyl)guanidine, 1-((2-cyanoguanidino)methyl)urea; 2-cyano-1-((2-cyanoguanidino)methyl)guanidine; 3,4-dimethyl pyrazole phosphate; allylthiourea, and chlorate salts.

Examples of urease inhibitors include N-(n-butyl) thiophosphoric acid triamide (NBPT, Agrotain), N-(n-propyl) thiophosphoric acid triamide (NPPT), 2-nitrophenyl phosphoric triamide (2-NPT), further NXPTs known to the skilled person, phenylphosphorodiamidate (PPD/PPDA), hydroquinone, ammonium thiosulfate, and mixtures of NBPT and NPPT (see e.g., U.S. Pat. No. 8,075,659). Such mixtures of NBPT and NPPT may comprise NBPT in amounts of 40 to 95% wt.-% and preferably of 60 to 80% wt.-% based on the total amount of active substances. Such mixtures are marketed as LIMUS, which is a composition comprising about 16.9 wt.-% NBPT and about 5.6 wt.-% NPPT and about 77.5 wt.-% of other ingredients including solvents and adjuvants.

Suitable plant growth regulators are antiauxins, auxins, cytokinins, defoliants, ethylene modulators, ethylene releasers, gibberellins, growth inhibitors, morphactins, growth retardants, growth stimulators, and further unclassified plant growth regulators.

Suitable micronutrients are compounds comprising boron, zinc, iron, copper, manganese, chlorine, and molybdenum.

The agrochemical composition typically comprises a biologically effective amount, e.g., a pesticidally effective amount of the agrochemical active ingredient. The term “effective amount” denotes an amount of the composition or of the agrochemical active ingredient, which is sufficient for, e.g., controlling harmful fungi on cultivated plants or in the protection of materials and which does not result in a substantial damage to the treated plants. Such an amount can vary in a broad range and is dependent on various factors, such as, e.g., the fungal species to be controlled, the treated cultivated plant or material, the climatic conditions and the specific agrochemical active ingredient used.

The agrochemical composition typically comprises the agrochemical active ingredient in a concentration of 1 to 70% by weight of solids (% w.s.), preferably 1 to 60% w.s., more preferably 10 to 50% w.s., most preferably 20 to 45% w.s., based on the total weight of the agrochemical composition. The agrochemical composition typically contains at least 5% w.s. of the agrochemical active ingredient, preferably at least 15% w.s., more preferably at least 25% w.s., most preferably at least 35% w.s. of the agrochemical active ingredient based on the total weight of the agrochemical composition. The agrochemical composition typically contains up to 95% w.s. of the agrochemical active ingredient, preferably up to 65% w.s., more preferably up to least 45% w.s. of the agrochemical active ingredient based on the total weight of the agrochemical composition. The active substances are employed in a purity of 90% to 100%, preferably 95% to 100%, as determined by nuclear magnetic resonance (NMR) spectroscopy.

The agrochemical composition typically comprises the graft polymer in a concentration of 0.5 to 20% w.s., preferably 0.5 to 10% w.s., more preferably 1 to 8% w.s. based on the total weight of the agrochemical composition. The concentration of the graft polymer is typically up to 15% w.s., more preferably up to 9% w.s., most preferably up to 7% w.s. based on the total weight of the agrochemical composition. The concentration of the graft polymer is usually at least 2% w.s., preferably at least 2.5% w.s. based on the total weight of the agrochemical composition.

The graft polymer according to the invention is typically present in the agrochemical composition in dissolved form, in particular if the agrochemical composition is an aqueous agrochemical composition. Typical solvents include those discussed as auxiliaries below.

The graft polymer may be present as solid particles, such as dispersed particles, especially if the agrochemical composition is a non-aqueous composition, such as a solid composition or an agrochemical composition with a continuous organic phase.

The weight ratio of the active agrochemical ingredient to the graft polymer in the agrochemical composition is typically in the range of 1:1 to 30:1, preferably 5:1 to 30:1, more preferably 7:1 to 20:1.

The agrochemical composition can be any customary type of agrochemical compositions, including solutions, emulsions, suspensions, dusts, powders, pastes, granules, pressings, capsules, and mixtures thereof. Examples for composition types are suspensions (e.g., SC, OD, FS, SE, DC), emulsifiable concentrates (e.g., EC), emulsions (e.g., EW, EO, ES, ME), capsules (e.g., CS, ZC), pastes, pastilles, wettable powders or dusts (e.g., WP, SP, WS, DP, DS), pressings (e.g., BR, TB, DT), granules (e.g., WG, SG, GR, FG, GG, MG), insecticidal articles (e.g., LN), as well as gel compositions for the treatment of plant propagation materials such as seeds (e.g., GF). These and further compositions types are defined in the “Catalogue of pesticide formulation types and international coding system”, Technical Monograph No. 2, 6th Ed. May 2008, CropLife International.

Preferred composition types are suspensions, emulsifiable concentrates (EC), wettable powders or wettable dusts, and granules, in particular suspensions. Preferred suspensions include suspension concentrates (SC), suspo-emulsions (SE) and dispersible concentrates (DC). Most preferred are suspension concentrates (SC).

The compositions are prepared in a known manner, such as described by Mollet and Grubemann, Formulation technology, Wiley VCH, Weinheim, 2001; or Knowles, New developments in crop protection product formulation, Agrow Reports DS243, T&F Informa, London, 2005. The agrochemical composition is typically prepared by contacting the graft polymer and the active agrochemical ingredient. If the agrochemical composition is a suspension, the method typically comprises contacting the active agrochemical ingredient with water to form a mill-base. The premix is then typically submitted to grinding or milling to form the final suspension. The graft polymer may either be added to the mill-base or to the final suspension, in particular to the mill-base.

In case the agrochemical composition is a granule, it is typically obtained by preparing a premix containing the agrochemical active ingredient, the graft polymer, a filler, and typically up to 5 wt.-% of water, and the premix is then extruded. The extrudate is then dried and converted to granules.

Suitable auxiliaries that may be added to the agrochemical composition are solvents, liquid carriers, solid carriers or fillers, surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, crystal growth inhibitors, tackifiers and binders.

Suitable solvents and liquid carriers are water and organic solvents, such as mineral oil fractions of medium to high boiling point, e.g., kerosene, diesel oil; oils of vegetable or animal origin; aliphatic, cyclic and aromatic hydrocarbons, e.g. toluene, paraffin, tetrahydronaphthalene, alkylated naphthalenes; alcohols, e.g., ethanol, propanol, butanol, benzylalcohol, cyclohexanol; glycols; DMSO; ketones, e.g., cyclohexanone; esters, e.g., lactates, carbonates, fatty acid esters, gamma-butyrolactone; fatty acids; phosphonates; amines; amides, e.g., N-methylpyrrolidone, fatty acid dimethylamides; and mixtures thereof.

Suitable solid carriers or fillers are mineral earths, e.g., silicates, silica gels, talc, kaolins, limestone, lime, chalk, clays, dolomite, diatomaceous earth, bentonite, calcium sulfate, magnesium sulfate, magnesium oxide; polysaccharides, e.g., cellulose, starch; fertilizers, e.g., ammonium sulfate, ammonium phosphate, ammonium nitrate, ureas; products of vegetable origin, e.g., cereal meal, tree bark meal, wood meal, nutshell meal, and mixtures thereof.

Suitable surfactants are surface-active compounds, such as anionic, cationic, nonionic and amphoteric surfactants, block polymers, polyelectrolytes, and mixtures thereof. Such surfactants can be used as emusifier, dispersant, solubilizer, wetter, penetration enhancer, protective colloid, or adjuvant. Examples of surfactants are listed in McCutcheon's, Vol. 1: Emulsifiers & Detergents, McCutcheon's Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Suitable nonionic surfactants are alkoxylates, N-subsituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-subsititued fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of vinylpyrrolidone, vinylalcohols, or vinylacetate.

Suitable cationic surfactants are quaternary surfactants, for example quaternary ammonium compounds with one or two hydrophobic groups, or salts of long-chain primary amines. Suitable amphoteric surfactants are alkylbetaines and imidazolines. Suitable block polymers are block polymers of the A-B or A-B-A type comprising blocks of polyethylene oxide and polypropylene oxide, or of the A-B—C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinylamines or polyethyleneamines.

Suitable adjuvants are compounds which have a neglectable or even no pesticidal activity themselves, and which improve the biological performance of the compound I on the target. Examples are surfactants, mineral or vegetable oils, and other auxiliaries. Further examples are listed by Knowles, Adjuvants and additives, Agrow Reports DS256, T&F Informa UK, 2006, chapter 5.

Suitable thickeners are polysaccharides (e.g., xanthan gum, carboxymethylcellulose), anorganic clays (organically modified or unmodified), polycarboxylates, and silicates. Suitable bactericides are bronopol and isothiazolinone derivatives such as alkylisothiazolinones and benzisothiazolinones. Suitable anti-freezing agents are ethylene glycol, propylene glycol, urea and glycerin. Suitable anti-foaming agents are silicones, long chain alcohols, and salts of fatty acids. Suitable colorants (e.g., in red, blue, or green) are pigments of low water solubility and water-soluble dyes. Examples are inorganic colorants (e.g., iron oxide, titan oxide, iron hexacyanoferrate) and organic colorants (e.g., alizarin-, azo- and phthalocyanine colorants). Suitable tackifiers or binders are polyvinylpyrrolidons, polyvinylacetates, polyvinyl alcohols, polyacrylates, biological or synthetic waxes, and cellulose ethers.

Examples for composition types and their preparation include:
i) Water-soluble concentrates (SL, LS)

10 to 60 wt.-% of an agrochemical active, 5 to 15 wt.-% wetting agent (e.g., alcohol alkoxylates), and 1 to 15 wt.-% of the graft polymer are dissolved in water and/or in a water-soluble solvent (e.g., alcohols) ad 100 wt.-%. The active substance dissolves upon dilution with water.
ii) Dispersible concentrates (DC)

5 to 25 wt.-% of the agrochemical active ingredient, 1 to 10 wt.-% of the graft polymer and optionally further dispersants (e.g. polyvinylpyrrolidone) are dissolved in organic solvent (e.g., cyclohexanone) ad 100 wt.-%. Dilution with water gives a dispersion.
iii) Emulsifiable concentrates (EC)

15 to 70 wt.-% of an agrochemical active ingredient, 1 to 15 wt.-% of the graft polymer, 5 to 10 wt.-% emulsifiers (e.g., calcium dodecylbenzenesulfonate and castor oil ethoxylate) are dissolved in water-insoluble organic solvent (e.g., aromatic hydrocarbon) ad 100 wt.-%. Dilution with water gives an emulsion.
iv) Emulsions (EW, EO, ES)

5 to 40 wt.-% of the agrochemical active ingredient, the 1 to 15 wt.-% of the graft polymer and 1 to 10 wt.-% emulsifiers (e.g., calcium dodecylbenzenesulfonate and castor oil ethoxylate) are dissolved in 20 to 40 wt.-% water-insoluble organic solvent (e.g., aromatic hydrocarbon). This mixture may be introduced into water ad 100 wt.-% by means of an emulsifying machine and made into a homogeneous emulsion.
v) Suspensions (SC, OD, FS)

In an agitated ball mill, 20 to 60 wt.-% of an agrochemical active ingredient are comminuted with addition of 1 to 10 wt.-% the graft polymer and optionally further dispersants, and wetting agents (e.g., sodium lignosulfonate and alcohol ethoxylate), 0,1 to 2 wt.-% thickener (e.g., xanthan gum) and water ad 100 wt.-% to give a fine active substance suspension. Dilution with water gives a stable suspension of the active substance. For FS type composition up to 40 wt.-% binder (e.g., polyvinylalcohol) is added. A suspension emulsion (SE) may be obtained by mixing a suspension with an emulsifiable concentrate or with an emulsion, such as an oil-in-water emulsion (EW).
vi) Water-dispersible granules and water-soluble granules (WG, SG)

50 to 80 wt.-% of the agrochemical active ingredient are ground finely with addition of the graft polymer, optionally further dispersants, and wetting agents (e.g., sodium lignosulfonate and alcohol ethoxylate) ad 100 wt.-% and prepared as water-dispersible or water-soluble granules by means of technical appliances (e.g. extrusion, spray tower, fluidized bed). Dilution with water gives a stable dispersion or solution of the active substance.
vii) Water-dispersible powders and water-soluble powders (WP, SP, WS)

50 to 80 wt.-% of an agrochemical active ingredient are ground in a rotor-stator mill with addition of 1 to 5 wt.-% of the graft polymer and optionally further dispersants (e.g., sodium lignosulfonate), 1 to 3 wt.-% wetting agents (e.g., alcohol ethoxylate) and solid carrier (e.g., silica gel) ad 100 wt.-%. Dilution with water gives a stable dispersion or solution of the active substance.
viii) Gel (GW, GF)

In an agitated ball mill, 5 to 25 wt.-% of an agrochemical active ingredient are comminuted with addition of 3 to 10 wt.-% of graft polymer and optionally further dispersants (e.g., sodium lignosulfonate), 1 to 5 wt.-% thickener (e.g., carboxymethylcellulose) and water ad 100 wt.-% to give a fine suspension of the active substance. Dilution with water gives a stable gel of the active substance.
iv) Microemulsion (ME)

5 to 20 wt.-% of an agrochemical active ingredient are added to 5 to 30 wt.-% organic solvent blend (e.g., fatty acid dimethylamide and cyclohexanone), 10 to 25 wt.-% surfactant blend (e.g., alkohol ethoxylate and arylphenol ethoxylate), 1 to 25 wt.-% of the graft polymer, and water ad 100%. This mixture is stirred for 1 h to produce spontaneously a thermodynamically stable microemulsion.
iv) Microcapsules (CS)

An oil phase comprising 5 to 50 wt.-% of an agrochemical active ingredient, 0 to 40 wt.-% water insoluble organic solvent (e.g., aromatic hydrocarbon), 2 to 15 wt.-% acrylic monomers (e.g., methylmethacrylate, methacrylic acid and a di- or triacrylate) are dispersed into an aqueous solution of a protective colloid (e.g., polyvinyl alcohol). Radical polymerization initiated by a radical initiator results in the formation of poly(meth)acrylate microcapsules. Alternatively, an oil phase comprising 5 to 50 wt.-% of an agrochemical active ingredient, 0 to 40 wt.-% water insoluble organic solvent (e.g., aromatic hydrocarbon), and an isocyanate monomer (e.g., diphenylmethene-4,4′-diisocyanatae) are dispersed into an aqueous solution of a protective colloid (e.g., polyvinyl alcohol).

The addition of a polyamine (e.g., hexamethylenediamine) results in the formation of a polyurea microcapsules. The monomers amount to 1 to 10 wt.-%. The wt.-% relate to the total CS composition. The microcapsules may then be dispersed in an aqueous composition. To this end, 1 to 40 wt.-% of the microcapsules are mixed with 2 to 10 wt.-% the graft polymer and optionally further dispersants, and wetting agents (e.g., sodium lignosulfonate and alcohol ethoxylate), 0,1 to 2 wt.-% thickener (e.g., xanthan gum) and water ad 100 wt.-% to yield a CS composition.
ix) Dustable powders (DP, DS)

1 to 10 wt.-% of an agrochemical active ingredient are ground finely and mixed intimately with the 1 to 20 wt.-% of the graft polymer, and solid carrier (e.g., finely divided kaolin) ad 100 wt.-%.
x) Granules (GR, FG)

0.5 to 30 wt.-% of an agrochemical active ingredient is ground finely and associated with 1 to 20 wt.-% of the graft polymer and with solid carrier (e.g., silicate) ad 100 wt.-%. Granulation is achieved by extrusion, spray-drying or the fluidized bed.
xi) Ultra-low volume liquids (UL)

1 to 50 wt.-% of an agrochemical active ingredient and 1 to 30 wt.-% of the graft polymer are dissolved in organic solvent (e.g., aromatic hydrocarbon) ad 100 wt.-%.

The compositions types i) to xi) may optionally comprise further auxiliaries such as those discussed above, e.g., 0,1 to 1 wt.-% bactericides, 5 to 15 wt.-% anti-freezing agents, 0,1 to 1 wt.-% anti-foaming agents, and 0,1 to 1 wt.-% colorants.

In one embodiment, the agrochemical composition is a suspension, preferably a suspension concentrate. The agrochemical suspension typically contains the agrochemical active ingredient in a concentration of 1 to 65 wt.-%, preferably 10 to 60 wt.-%, more preferably 20 to 50 wt.-%, most preferably 30 to 50 wt.-% based on the total weight of the agrochemical suspension.

The agrochemical suspension contains at least a portion of the agrochemical active as solid particles suspended in a continuous phase, which is preferably an aqueous continuous phase. Accordingly, the agrochemical suspension is preferably an aqueous agrochemical suspension containing at least 5 wt.-% of water, preferably at least 10 wt.-%, more preferably at least 15 wt.-%, most preferably at least 20 wt.-%, especially preferably at least 25 wt.-%, such as at least 30 wt.-%, in particular at least 40 wt.-%, each time based on the total weight of the suspension. The agrochemical composition may contain up to 95 wt.-% of water, preferably up to 80 wt.-%, more preferably up to 70 wt.-%, most preferably up to 60 wt.-% of water, such as up to 50 wt.-% of water, each time based on the total weight of the suspension.

The agrochemical active ingredient typically exhibits low water-solubility. The agrochemical active may have a water-solubility at 20° C. and pH of 7 of up to 10 g/L, preferably up to 5 g/L, more preferably up to 1 g/L, most preferably up to 0.5 g/L, in particular up to 0.1 g/L.

The agrochemical active ingredient is present in the form of suspended particles in the agrochemical suspension. The particles may be characterized by their size distribution, which can be determined by dynamic light scattering techniques. Suitable dynamic light scattering measurement units are inter alia produced under the trade name Malvern Mastersizer 3000.

The particles of the agrochemical active ingredient may be characterized by their median diameter, which is usually abbreviated as D50 value. The D50 value refers to a particular particle diameter, wherein half of the particle population by volume is smaller than this diameter. The D50 value is typically determined according to ISO 13320:2009. The particles may have an D50 value in the range of 0.05 μm to 25 μm, preferably in the range of 0.1 μm to 20 μm, more preferably in the range of 0.5 to less than 20 μm, most preferably in the range of 0.5 μm to 15 μm, especially preferably in the range of 0.5 μm to 10 μm. The particles typically have a D50 value of at least 0.75 μm, preferably at least 1 μm, and as upper limit preferably at most 3 μm or at most 2 μm.

The particles of the agrochemical active ingredient may further be characterized by their D90 value. The D90 value refers to a particular particle diameter, wherein 90% of the particle population by volume is smaller than this diameter. The D90 value is typically determined according to ISO 13320:2009. The particles may have a D90 value of less than 30 to 3 μm, in particular less than 20 μm or less than 15 μm, especially less than 10 μm or less than 8 μm or less than 6 μm or less than 5 μm.

The particles of the agrochemical active ingredient may also be characterized by their D10 value. The D10 value refers to a particular particle diameter, wherein 10% of the particle population by volume is smaller than this diameter. The D10 value is typically determined according to ISO 13320:2009. The particles may generally have a D10 value of less than 2 μm, e.g. in the range of 0.05 to <2 μm, in particular in the range of 0.1 to 1.5 μm or in the range of 0.1 to 1 μm.

Preferably, the particles have D50 value in the range of 0.5 to 10 μm, especially in the range of 0.5 to 3 μm or in the range of 0.75 to 2 μm and a D90 value in the range of 3 to less than 10 μm.

The suspended particles may be present in the form of crystalline or amorphous particles which are solid at 20° C.

Typically, at least 50 wt.-% of the agrochemical active ingredient may be present as solid particles based on the total weight of the agrochemical active ingredient in the agrochemical suspension, preferably at least 70 wt.-%, more preferably at least 90 wt.-%.

The agrochemical suspension may contain a further active ingredient, which may be selected from fungicides, insecticides, nematicides, herbicides, safeners, micronutrients, biopesticides, nitrification inhibitors, urease inhibitors, and/or growth regulators. The further active ingredient may be present in dissolved form or as suspended particles in the agrochemical suspension. The concentration of the further active ingredient is typically from 1 to 50 wt.-%, preferably from 10 to 25 wt.-% based on the total weight of the agrochemical suspension.

The agrochemical suspension may be prepared at any pH value. Preferably, agrochemical suspensions according to the invention have a pH below 9, more preferably from 4 to 8.

The agrochemical suspension typically contains a thickener. The term “thickener(s)” usually refers to inorganic clays (organically modified or unmodified), such as bentonites, attapulgite, hectorite and smectite clays, and silicates (e.g., colloidal hydrous magnesium silicate, colloidal hydrous aluminium silicate, colloidal hydrous aluminium magnesium silicate, hydrous amorphous silicon dioxide); and organic clays, such as polycarboxylates (e.g., poly(meth)acrylates and modified poly(meth)acrylates), polysaccharides (e.g., xanthan gum, agarose, rhamsan gum, pullulan, tragacanth gum, locust bean gum, guar gum, tara gum, Whelan cum, casein, dextrin, diutan gum, cellulose, ethylcellulose, hydroxyethylcellulose, methylhydroxypropylcellulose), polyvinyl ethers, polyvinyl pyrrolidone, polypropylene oxide-polyethylene ocide condensates, polyvinyl acetates, maleic anhydrides, polypropylene glycols, polyacrylonitrile block copolymers, proteins, and carbohydrates.

The invention also relates to the use of the graft polymer according to the present invention as a dispersant for agrochemical active ingredients in agrochemical compositions, such as in suspensions. It is understood that all embodiments regarding the agrochemical composition herein relate to both the inventive agrochemical composition and the inventive use of the graft polymer as a dispersant for agrochemical active ingredients in agrochemical compositions.

Solutions for seed treatment (LS), Suspoemulsions (SE), flowable concentrates (FS), powders for dry treatment (DS), water-dispersible powders for slurry treatment (WS), water-soluble powders (SS), emulsions (ES), emulsifiable concentrates (EC) and gels (GF) are usually employed for the purposes of treatment of plant propagation materials, particularly seeds. These compositions give, after two-to-tenfold dilution, active substance concentrations of 0.01 to 60 wt.-%, preferably 0.1 to 40 wt.-%, in the ready-to-use preparations. Application can be carried out before or during sowing. Methods for applying the agrochemical composition on to plant propagation material, especially seeds include dressing, coating, pelleting, dusting, soaking and in-furrow application methods of the propagation material. Preferably, the agrochemical composition applied on to the plant propagation material by a method such that germination is not induced, e.g. by seed dressing, pelleting, coating and dusting.

The invention also relates to a method for controlling phytopathogenic fungi and/or undesired plant growth and/or undesired attack by insects or mites and/or for regulating the growth of plants, where the agrochemical composition is allowed to act on the phytopathogenic fungi, undesired plant growth or undesired insects or mites; and/or on the habitat of the phytopathogenic fungi, undesired plant growth or undesired insects or mites; and/or on the plants to be protected, and/or on the soil of the plants to be protected; and/or on the useful plants and/or their habitat.

In one embodiment, the method is for controlling phytopathogenic fungi. In another embodiment, the method is for controlling undesired plant growth. In another embodiment, the method is for controlling undesired attach by insects or mites. These methods typically comprise the treatment of the plant to be protected, its locus of growth, the phytopathogenic fungi and/or undesired plant growth and/or undesired attack by insects or mites with the agrochemical composition.

Suitable methods of treatment include inter alia soil treatment, seed treatment, in furrow application, and foliar application. Soil treatment methods include drenching the soil, drip irrigation (drip application onto the soil), dipping roots, tubers or bulbs, or soil injection. Seed treatment techniques include seed dressing, seed coating, seed dusting, seed soaking, and seed pelleting. In furrow applications typically include the steps of making a furrow in cultivated land, seeding the furrow with seeds, applying the pesticidally active compound to the furrow, and closing the furrow.

When employed in plant protection, the amounts of agrochemical active applied are, depending on the kind of effect desired, from 0.001 to 2 kg per ha, preferably from 0.005 to 2 kg per ha, more preferably from 0.05 to 0.9 kg per ha, and in particular from 0.1 to 0.75 kg per ha.

When used in the protection of materials or stored products, the amount of active substance applied depends on the kind of application area and on the desired effect. Amounts customarily applied in the protection of materials are 0.001 g to 2 kg, preferably 0.005 g to 1 kg, of active substance per cubic meter of treated material.

In treatment of plant propagation materials such as seeds, e.g., by dusting, coating or drenching seed, amounts of active substance of 0.1 to 1000 g, preferably 1 to 1000 g, more preferably from 1 to 100 g and most preferably from 5 to 100 g, per 100 kilogram of plant propagation material (preferably seeds) are generally required.

The invention also relates to a seed comprising the agrochemical composition of the invention in an amount of 0.1 g to 10 kg per 100 kg of seed.

Various types of oils, wetters, adjuvants, fertilizer, or micronutrients, and further pesticides (e.g., herbicides, insecticides, fungicides, growth regulators, safeners) may be added to the agrochemical composition as premix or, if appropriate not until immediately prior to use (tank mix). These agents can be admixed with the compositions according to the invention in a weight ratio of 1:100 to 100:1, preferably 1:10 to 10:1.

The user applies the agrochemical composition according to the invention usually from a predosage device, a knapsack sprayer, a spray tank, a spray plane or a spray drone, or an irrigation system. Usually, the agrochemical composition is made up with water, buffer, and/or further auxiliaries to the desired application concentration and the ready-to-use spray liquor or the agrochemical composition according to the invention is thus obtained. Usually, 20 to 2,000 liters, preferably 50 to 400 liters, of the ready-to-use spray liquor are applied per hectare of agricultural useful area.

The invention also relates to a method for combating or controlling invertebrate pests, which method comprises contacting the invertebrate pest or its food supply, habitat or breeding grounds with a pesticidally effective amount of the agrochemical composition. Moreover, the invention relates to a method for protecting growing plants from attack or infestation by invertebrate pests, which method comprises contacting a plant, or soil or water in which the plant is growing, with a pesticidally effective amount of the agrochemical composition. Furthermore, the invention relates to a method for treating or protecting an animal from infestation or infection by invertebrate pests, which method comprises bringing the animal in contact with a pesticidally effective amount of the agrochemical composition.

Invertebrate pests according to the present invention are typically arachnids, mollusca, or insects, in particular insects.

According to one embodiment, individual components of the composition according to the invention such as parts of a kit or parts of a binary or ternary mixture may be mixed by the user itself in a spray tank and further auxiliaries may be added, if appropriate.

In a further embodiment, either individual components of the composition according to the invention or partially premixed components may be mixed by the user in a spray tank and further auxiliaries and additives may be added, if appropriate.

In a further embodiment, either individual components of the composition according to the invention or partially premixed components can be applied jointly (e.g., after tank mix) or consecutively.

The invention is further illustrated by the following examples.

### EXAMPLES

### Polymer Measurements

The K-value measures the relative viscosity of dilute polymer solutions and is a relative measure of the average molecular weight. As the average molecular weight of the polymer increases for a particular polymer, the K-value tends to also increase. The K-value is determined in a 3 wt.-% NaCl solution at 23° C. and a polymer concentration of 1 wt.-% polymer according to the method of H. Fikentscher in “Cellulosechemie”, 1932, 13, 58.

The number average molecular weight (Mₙ), the weight average molecular weight (M_{w}) and the polydispersity M_{w}/Mₙ of the inventive graft polymers were determined by gel permeation chromatography in tetrahydrofuran. The mobile phase (eluent) used was tetrahydrofuran comprising 0.035 mol/L diethanolamine. The concentration of graft polymer in tetrahydrofuran was 2.0 mg per mL. After filtration, (pore size 0.2 μm), 100 μL of this solution were injected into the GPC system. Four different columns (heated to 60° C.) were used for separation (SDV precolumn, SDV 1000A, SDV 100000A, SDV 1000000A). The GPC system was operated at a flow rate of 1 mL per min. A DRI Agilent 1100 was used as the detection system. Poly(ethylene glycol) (PEG) standards (PL) having a molecular weight Mₙ from 106 to 1 378 000 g/mol were used for the calibration.

### Polymer Backbones

For examples 13, 14 and 39, commercially available statistical EO/PO polyether products were used as backbone materials. These products are available for example from BASF under the tradename Breox®.

### Polymer Backbone for Example 26

For example 26, an EO/PO block copolymer backbone was synthesized as follows:

Propylene Glycol+2.6 moles of PO Step 26a

In a 2 L autoclave, 228.3 g propylene glycol and 1.36 g potassium tert-butylate were mixed. The autoclave was purged 3 times with nitrogen and heated to 140° C. 453.0 g propylene oxide were added within 8 hours. The mixture was stirred for additional 5 h at 140° C. to complete the reaction. The reaction mixture was stripped with nitrogen and volatile compounds were removed in vacuo at 80° C. After filtration, 680.0 g of a light brown oil was obtained. ¹H-NMR in CDCl₃ confirmed the expected structure.

EO/PO block copolymer(propylene glycol+2.6 mol PO+17.7 mol EO, 80 wt.-% EO, molecular weight 1000 g/mol) Step 26b

In a 2 L autoclave, 209.6 g of the product of step 26a and 1.39 g potassium tert-butylate were mixed. The autoclave was purged 3 times with nitrogen and heated to 140° C. A mixture of 693.8 g ethylene oxide was added within 12 hours. The mixture was stirred for additional 5 h at 140° C. to complete the reaction. After cooling to 80° C., the reaction mixture was neutralized with 0.96 g acetic acid. The reaction mixture was stripped with nitrogen and volatile compounds were removed in vacuo at 80° C. After filtration, 901.0 g of a light brown oil were obtained. ¹H-NMR in CDCl₃ confirmed the expected structure.

### Polymer Backbone for Example 27

For example 27, an EO/PO block copolymer backbone (polyethylene glycol+4.2 mol EO+7.2 mol PO, 80 wt.-% EO, Mₙ 2100 g/mol) was synthesized as follows:

In a 2 L autoclave, 499.9 g polyethylene glycol (Mₙ 1500 g/mol, Pluriol E1500) and 1.42 g potassium tert-butylate were mixed. The autoclave was purged 3 times with nitrogen and heated to 140° C. 61.7 g ethylene oxide was added within 1 hour, and was stirred for additional 2 hours. 139.4 g propylene oxide was added within 3 hours. The mixture was stirred for additional 6 h at 140° C. to complete the reaction. After cooling to 80° C., the reaction mixture was neutralized with 0.75 g acetic acid. The reaction mixture was stripped with nitrogen and volatile compounds were removed in vacuo at 80° C. After filtration, 700.0 g of a light brown solid were obtained. ¹H-NMR in CDCl₃ confirmed the expected structure.

### Polymer Backbone for Example 32

For example 32, a statistical EO/PO polyether backbone was synthesized as follows:

Diethylene Glycol+5.3 mol EO+8.3 mol PO Step 32a

In a 2 L autoclave, 106.1 g diethylene glycol and 1.65 g potassium tert-butylate were mixed. The autoclave was purged 3 times with nitrogen and heated to 140° C. A mixture of 233.9 g ethylene oxide and 482.6 g propylene oxide was added within 13 hours. The mixture was stirred for additional 5 h at 140° C. to complete the reaction. The reaction mixture was stripped with nitrogen and volatile compounds were removed in vacuo at 80° C. After filtration, 820.0 g of a light brown oil was obtained. ¹H-NMR in CDCl₃ confirmed the expected structure.

Statistical EO/PO copolymer(diethylene glycol+17.7 mol EO+27.7 mol PO, 35 wt.-% EO, molecular weight 2500 g/mol) Step 32b

In a 2 L autoclave, 370.2 g of the product of step 32a and 1.51 g potassium tert-butylate were mixed. The autoclave was purged 3 times with nitrogen and heated to 140° C. A mixture of 245.6 g ethylene oxide and 506.7 g propylene oxide was added within 15 hours. The mixture was stirred for additional 5 h at 140° C. to complete the reaction. The reaction mixture was stripped with nitrogen and volatile compounds were removed in vacuo at 80° C. After filtration, 1119.0 g of a light brown oil was obtained. ¹H-NMR in CDCl₃ confirmed the expected structure.

### Polymer Backbone for Example 33

For example 33, a statistical EO/PO polyether backbone was synthesized as follows:

Diethylene Glycol+12.1 mol EO+3.2 mol PO Step 33a

In a 2 L autoclave, 106.1 g diethylene glycol and 1.65 g potassium tert-butylate were mixed. The autoclave was purged 3 times with nitrogen and heated to 140° C. A mixture of 532.6 g ethylene oxide and 186.4 g propylene oxide was added within 13 hours. The mixture was stirred for additional 5 h at 140° C. to complete the reaction. The reaction mixture was stripped with nitrogen and volatile compounds were removed in vacuo at 80° C. After filtration, 825.0 g of a light brown oil was obtained. ¹H-NMR in CDCl₃ confirmed the expected structure.

Statistical EO/PO copolymer(diethylene glycol+40.3 mol EO+10.7 mol PO, 75 wt.-% EO, molecular weight 2500 g/mol) Step 33b

In a 2 L autoclave, 370.1 g of the product of step 33a and 1.50 g potassium tert-butylate were mixed. The autoclave was purged 3 times with nitrogen and heated to 140° C. A mixture of 559.2 g ethylene oxide and 195.8 g propylene oxide was added within 15 hours. The mixture was stirred for additional 5 h at 140° C. to complete the reaction. The reaction mixture was stripped with nitrogen and volatile compounds were removed in vacuo at 80° C. After filtration, 1130.0 g of a light brown oil was obtained. ¹H-NMR in CDCl₃ confirmed the expected structure.

### Polymer Backbone for Example 34

For example 34, a statistical EO/PO polyether backbone was synthesized as follows:

Diethylene Glycol+8.7 mol EO+5.8 mol PO Step 34a

In a 2 L autoclave, 106.1 g diethylene glycol and 1.65 g potassium tert-butylate were mixed. The autoclave was purged 3 times with nitrogen and heated to 140° C. A mixture of 381.9 g ethylene oxide and 334.5 g propylene oxide was added within 13 hours. The mixture was stirred for additional 5 h at 140° C. to complete the reaction. The reaction mixture was stripped with nitrogen and volatile compounds were removed in vacuo at 80° C. After filtration, 822.0 g of a light brown oil was obtained. ¹H-NMR in CDCl₃ confirmed the expected structure.

Statistical EO/PO copolymer(diethylene glycol+28.9 mol EO+19.2 mol PO, 55 wt.-% EO, molecular weight 2500 g/mol) Step 34b

In a 2 L autoclave, 370.1 g of the product of step 34a and 1.50 g potassium tert-butylate were mixed. The autoclave was purged 3 times with nitrogen and heated to 140° C. A mixture of 370.2 g ethylene oxide and 351.6 g propylene oxide was added within 15 hours. The mixture was stirred for additional 5 h at 140° C. to complete the reaction. The reaction mixture was stripped with nitrogen and volatile compounds were removed in vacuo at 80° C. After filtration, 1128.0 g of a light brown oil was obtained. ¹H-NMR in CDCl₃ confirmed the expected structure.

### Polymer Backbone for Example 35

For example 35, a statistical EO/PO polyether backbone was synthesized as follows:

Diethylene Glycol+14.4 mol EO+1.26 mol PO Step 35a

In a 2 L autoclave, 106.1 g diethylene glycol and 1.63 g potassium tert-butylate were mixed. The autoclave was purged 3 times with nitrogen and heated to 140° C. A mixture of 634.4 g ethylene oxide and 73.2 g propylene oxide was added within 13 hours. The mixture was stirred for additional 5 h at 140° C. to complete the reaction. The reaction mixture was stripped with nitrogen and volatile compounds were removed in vacuo at 80° C. After filtration, 815.0 g of a light brown wax was obtained. ¹H-NMR in CDCl₃ confirmed the expected structure.

Statistical EO/PO copolymer(diethylene glycol+48.0 mol EO+4.2 mol PO, 90 wt.-% EO, molecular weight 2500 g/mol) Step 35b

In a 2 L autoclave, 366.1 g of the product of step 35a and 1.49 g potassium tert-butylate were mixed. The autoclave was purged 3 times with nitrogen and heated to 140° C. A mixture of 661.1 g ethylene oxide and 76.8 g propylene oxide was added within 15 hours. The mixture was stirred for additional 5 h at 140° C. to complete the reaction. The reaction mixture was stripped with nitrogen and volatile compounds were removed in vacuo at 80° C. After filtration, 1105.0 g of a light brown wax was obtained. ¹H-NMR in CDCl₃ confirmed the expected structure.

For examples 51 and 52, commercially available EO/PO polyether products under the BASF tradename Lupranol® were used. Specifically, Lupranol® 2048 was used for example 51 and Lupranol©6000/1 was used for example 52. Lupranol® 2048 is obtained from glycerine, PO and EO and is a polymer of the structure Glycerin[2,25]-PO[5,54]-PO[19,72]/EO[67,49]-EO[5,0] (Mₙ 3550 g/mol). Lupranol©6000/1 is derived from diethylene glycol, PO and EO and is a polymer of the structure DEG[4,9]-EO[12,4]-PO[20,9]/EO[47,5]-EO[14,3] (Mₙ 2220 g/mol).

For all other examples, commercially available polyether products were used as backbone materials. These products are available for example from BASF under the tradename Pluriol® and Pluronic®.

### Graft Polymers

The following graft polymerizations were performed using the material and ratios and amounts as indicated below and in Table 1.

### Example 1: Graft Polymerization of Vinyl Acetate (40 wt.-%) on PO-EO-PO Block Copolymer (60 wt.-%)

A polymerization vessel equipped with stirrer and reflux condenser was initially charged with 600 g of PO-EO-PO block copolymer (Mₙ 2650 g/mol) under nitrogen atmosphere and melted at 90° C. Feed 1 containing 4.8 g of tert-butyl peroxy-2-ethylhexanoate, dissolved in 23.6 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (400 g of vinyl acetate) was started and dosed within 6:00 h at constant feed rate and 90° C. Upon completion of the Feeds 1 and 2, the temperature was increased to 95° C. and Feed 3 consisting of 3.16 g of tert-butyl peroxy-2-ethylhexanoate, dissolved in 15.70 g of tripropylene glycol, were dosed within 56 min with constant flow rate at 95° C. The mixture was stirred for one hour at 95° C. upon complete addition of the feed. Residual amounts of monomer were removed by vacuum distillation for 1 h at 95° C. and 500 mbar.

### Example 2: Graft Polymerization of Vinyl Acetate (30 wt.-%) on PO-EO-PO Block Copolymer (70 wt.-%)

A polymerization vessel equipped with stirrer and reflux condenser was initially charged with 770 g of PO-EO-PO block copolymer (Mₙ 6500 g/mol) under nitrogen atmosphere and melted at 90° C. Feed 1 containing 7.97 g of tert-butyl peroxy-2-ethylhexanoate, dissolved in 35.09 g of 1,2-propanediol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (330 g of vinyl acetate) was started and dosed to the reaction vessel within 6:00 h at constant feed rate and 90° C. Upon completion of the feeds, Feed 3 consisting of 5.28 g of tert-butyl peroxy-2-ethylhexanoate, dissolved in 23.21 g of 1,2-propanediol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 3: Graft Polymerization of Vinyl Acetate (20 wt.-%) on PEG (80 wt.-%)

A polymerization vessel equipped with stirrer and reflux condenser was initially charged with 800 g of PEG (Mₙ 1500 g/mol) under nitrogen atmosphere and melted at 90° C. Feed 1 containing 3.57 g of tert-butyl peroxy-2-ethylhexanoate, dissolved in 29.86 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (200 g of vinyl acetate) was started and dosed to the reaction vessel within 6:00 h at constant feed rate and 90° C. Upon completion of the feeds, Feed 3 consisting of 4.90 g of tert-butyl peroxy-2-ethylhexanoate, dissolved in 40.12 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 4: Graft Polymerization of Vinyl Acetate (30 wt.-%) on PO-EO-PO Block Copolymer (70 wt.-%)

A polymerization vessel equipped with stirrer and reflux condenser was initially charged with 700 g of PO-EO-PO block copolymer (Mₙ 1950 g/mol) under nitrogen atmosphere and melted at 90° C. Feed 1 containing 3.57 g of tert-butyl peroxy-2-ethylhexanoate, dissolved in 29.86 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (300 g of vinyl acetate) was started and dosed to the reaction vessel within 6:00 h at constant feed rate and 90° C. Upon completion of the feeds, Feed 3 consisting of 4.90 g of tert-butyl peroxy-2-ethylhexanoate, dissolved in 40.12 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 5: Graft Polymerization of Vinyl Acetate (50 wt.-%) on PO-EO-PO Block Copolymer (50 wt.-%)

A polymerization vessel equipped with stirrer and reflux condenser was initially charged with 500 g of PO-EO-PO block copolymer (Mₙ 2650 g/mol) under nitrogen atmosphere and melted at 90° C. Feed 1 containing 12.24 g of tert-butyl peroxy-2-ethylhexanoate, dissolved in 50.30 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (500 g of vinyl acetate) was started and dosed to the reaction vessel within 6:00 h at constant feed rate and 90° C. Upon completion of the feeds, Feed 3 consisting of 4.90 g of tert-butyl peroxy-2-ethylhexanoate, dissolved in 19.70 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 6: Graft Polymerization of Vinyl Acetate (20 wt.-%) and Vinyl Laurate (20 wt.-%) on PEG (60 wt.-%)

A polymerization vessel equipped with stirrer and reflux condenser was initially charged with 640 g of PEG (Mₙ 4000 g/mol) under nitrogen atmosphere and melted at 90° C. Feed 1 containing 4.11 g of tert-butyl peroxy-2-ethylhexanoate, dissolved in 36.16 g of 1,2-propanediol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (213.33 g of vinyl acetate) and Feed 3 (213.33 g of vinyl laurate) were started and dosed to the reaction vessel within 6:00 h at constant feed rate and 90° C. Upon completion of the feeds, Feed 4 consisting of 2.72 g of tert-butyl peroxy-2-ethylhexanoate, dissolved in 23.89 g of 1,2-propanediol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 7: Graft Polymerization of Vinyl Acetate (40 wt.-%) on PO-EO-PO Block Copolymer (60 wt.-%)

A polymerization vessel equipped with stirrer and reflux condenser was initially charged with 600 g of PO-EO-PO block copolymer (Mₙ 1950 g/mol) under nitrogen atmosphere and melted at 90° C. Feed 1 containing 12.24 g of tert-butyl peroxy-2-ethylhexanoate, dissolved in 50.30 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (400 g of vinyl acetate) was started and dosed to the reaction vessel within 6:00 h at constant feed rate and 90° C. Upon completion of the feeds, Feed 3 consisting of 4.90 g of tert-butyl peroxy-2-ethylhexanoate, dissolved in 19.70 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 8: Graft Polymerization of Vinyl Acetate (40 wt.-%) on PEG (60 wt.-%)

A polymerization vessel equipped with stirrer and reflux condenser was initially charged with 600 g of PEG (Mₙ 4000 g/mol) under nitrogen atmosphere and melted at 90° C. Feed 1 containing 3.57 g of tert-butyl peroxy-2-ethylhexanoate, dissolved in 29.90 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (400 g of vinyl acetate) was started and dosed to the reaction vessel within 6:00 h at constant feed rate and 90° C. Upon completion of the feeds, Feed 3 consisting of 4.90 g of tert-butyl peroxy-2-ethylhexanoate, dissolved in 41.00 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 9: Graft Polymerization of Vinyl Acetate (40 wt.-%) on PO-EO-PO Block Copolymer (60 wt.-%)

A polymerization vessel equipped with stirrer and reflux condenser was initially charged with 600 g of PO-EO-PO block copolymer (Mₙ 5900 g/mol) under nitrogen atmosphere and melted at 90° C. Feed 1 containing 4.8 g of tert-butyl peroxy-2-ethylhexanoate, dissolved in 23.6 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (400 g of vinyl acetate) was started and dosed within 6:00 h at constant feed rate and 90° C. Upon completion of the Feeds 1 and 2, the temperature was increased to 95° C. and Feed 3 consisting of 3.16 g of tert-butyl peroxy-2-ethylhexanoate, dissolved in 15.70 g of tripropylene glycol, were dosed within 56 min with constant flow rate at 95° C. The mixture was stirred for one hour at 95° C. upon complete addition of the feed. Residual amounts of monomer were removed by vacuum distillation for 1 h at 95° C. and 500 mbar. The resulting graft polymer (Example 9) had a mean molecular weight M_{w} of 5190 g/mol and a polydispersity of 1.5.

### Example 10: Graft Polymerization of Vinyl Acetate (30 wt.-%) on PEG (70 wt.-%)

A polymerization vessel equipped with stirrer and reflux condenser was initially charged with 595 g of PEG (Mₙ 1500 g/mol) under nitrogen atmosphere and melted at 90° C. Feed 1 containing 10.41 g of tert-butyl peroxy-2-ethylhexanoate, dissolved in 42.76 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (255 g of vinyl acetate) was started and dosed to the reaction vessel within 6:00 h at constant feed rate and 90° C. Upon completion of the feeds, Feed 3 consisting of 4.16 g of tert-butyl peroxy-2-ethylhexanoate, dissolved in 16.75 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 11: Graft Polymerization of Vinyl Acetate (25 wt.-%) on PEG (75 wt.-%)

A polymerization vessel equipped with stirrer and reflux condenser was initially charged with 750 g of PEG (Mₙ 1500 g/mol) under nitrogen atmosphere and melted at 90° C. Feed 1 containing 3.57 g of tert-butyl peroxy-2-ethylhexanoate, dissolved in 29.86 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (250 g of vinyl acetate) was started and dosed to the reaction vessel within 6:00 h at constant feed rate and 90° C. Upon completion of the feeds, Feed 3 consisting of 4.90 g of tert-butyl peroxy-2-ethylhexanoate, dissolved in 40.12 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 12: Graft Polymerization of Vinyl Acetate (25 wt.-%) on PO-EO-PO Block Copolymer (75 wt.-%)

A polymerization vessel equipped with stirrer and reflux condenser was initially charged with 750 g of PO-EO-PO block copolymer (Mₙ 2650 g/mol) under nitrogen atmosphere and melted at 90° C. Feed 1 containing 3.57 g of tert-butyl peroxy-2-ethylhexanoate, dissolved in 29.90 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (250 g of vinyl acetate) was started and dosed to the reaction vessel within 6:00 h at constant feed rate and 90° C. Upon completion of the feeds, Feed 3 consisting of 4.90 g of tert-butyl peroxy-2-ethylhexanoate, dissolved in 41.00 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 13: Graft Polymerization of Vinyl Acetate (50 wt.-%) on EO/PO Backbone (50 wt.-%)

A polymerization vessel equipped with stirrer and reflux condenser was initially charged with 500 g of EO/PO statistical copolymer (Mₙ 2500 g/mol; 60% EO) under nitrogen atmosphere and melted at 90° C. Feed 1 containing 3.98 g of tert-butyl peroxy-2-ethylhexanoate, dissolved in 41.91 g of 1,2-propanediol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (500 g of vinyl acetate) was started and dosed to the reaction vessel within 6:00 h at constant feed rate and 90° C. Upon completion of the feeds, Feed 3 consisting of 2.55 g of tert-butyl peroxy-2-ethylhexanoate, dissolved in 26.85 g of 1,2-propanediol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 14: Graft Polymerization of Vinyl Acetate (70 wt.-%) on EO/PO Backbone (30 wt.-%)

A polymerization vessel equipped with stirrer and reflux condenser was initially charged with 300 g of EO/PO statistical copolymer (Mₙ 2500 g/mol; 60% EO) under nitrogen atmosphere and melted at 90° C. Feed 1 containing 3.98 g of tert-butyl peroxy-2-ethylhexanoate, dissolved in 41.91 g of 1,2-propanediol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (700 g of vinyl acetate) was started and dosed to the reaction vessel within 6:00 h at constant feed rate and 90° C. Upon completion of the feeds, Feed 3 consisting of 2.55 g of tert-butyl peroxy-2-ethylhexanoate, dissolved in 26.85 g of 1,2-propanediol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 15: Graft Polymerization of Vinyl Acetate (20 wt.-%) and Vinyl Laurate (5 wt.-%) on PEG (75 wt.-%)

A polymerization vessel equipped with stirrer and reflux condenser was initially charged with 750 g of PEG (Mₙ 1500 g/mol) under nitrogen atmosphere and melted at 90° C. Feed 1 containing 3.57 g of tert-butyl peroxy-2-ethylhexanoate, dissolved in 29.50 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (200 g of vinyl acetate) and Feed 3 (50 g of vinyl laurate) were started and dosed to the reaction vessel within 6:00 h at constant feed rate and 90° C. Upon completion of the feeds, Feed 4 consisting of 4.90 g of tert-butyl peroxy-2-ethylhexanoate, dissolved in 40.48 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 16: Graft Polymerization of Vinyl Acetate (30 wt.-%) on PEG (70 wt.-%)

A polymerization vessel equipped with stirrer and reflux condenser was initially charged with 700 g of PEG (Mₙ 600 g/mol) under nitrogen atmosphere and heated to 90° C. Feed 1 containing 10.20 g of tert-butyl peroxy-2-ethylhexanoate, dissolved in 47.61 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (300 g of vinyl acetate) was started and dosed to the reaction vessel within 6:00 h at constant feed rate and 90° C. Upon completion of the feeds, Feed 3 consisting of 4.90 g of tert-butyl peroxy-2-ethylhexanoate, dissolved in 22.39 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 17: Graft Polymerization of Vinyl Acetate (35 wt.-%) on PO-EO-PO Block Copolymer (Mₙ 2650 g/Mol; 65 wt.-%)

A polymerization vessel equipped with stirrer and reflux condenser was initially charged with 650 g of PO-EO-PO block copolymer (Mₙ 2650 g/mol) under nitrogen atmosphere and melted at 90° C. Feed 1 containing 3.98 g of tert-butyl peroxy-2-ethylhexanoate, dissolved in 41.91 g of 1,2-propanediol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (350 g of vinyl acetate) was started and dosed to the reaction vessel within 6:00 h at constant feed rate and 90° C. Upon completion of the feeds, Feed 3 consisting of 2.55 g of tert-butyl peroxy-2-ethylhexanoate, dissolved in 26.85 g of 1,2-propanediol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 18: Graft Polymerization of Vinyl Acetate (20 wt.-%) on EO-PO-EO Block Copolymer (80 wt.-%)

A polymerization vessel equipped with stirrer and reflux condenser was initially charged with 880 g of EO-PO-EO (Mₙ 2900 g/mol) under nitrogen atmosphere and melted at 90° C. Feed 1 containing 4.42 g of tert-butyl peroxy-2-ethylhexanoate, dissolved in 37.33 g of 1,2-propanediol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (220 g of vinyl acetate) was started and dosed to the reaction vessel within 6:00 h at constant feed rate and 90° C. Upon completion of the feeds, Feed 3 consisting of 2.81 g of tert-butyl peroxy-2-ethylhexanoate, dissolved in 24.70 g of 1,2-propanediol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 19: Graft Polymerization of Vinyl Acetate (60 wt.-%) on PEG (40 wt.-%)

A polymerization vessel equipped with stirrer and reflux condenser was initially charged with 400 g of PEG (Mₙ 6000 g/mol) under nitrogen atmosphere and melted at 90° C. Feed 1 containing 4.8 g of tert-butyl peroxy-2-ethylhexanoate, dissolved in 23.6 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (600 g of vinyl acetate) was started and dosed within 6:00 h at constant feed rate and 90° C. Upon completion of the Feeds 1 and 2, the temperature was increased to 95° C. and Feed 3 consisting of 3.16 g of tert-butyl peroxy-2-ethylhexanoate, dissolved in 15.70 g of tripropylene glycol, were dosed within 56 min with constant flow rate at 95° C. The mixture was stirred for one hour at 95° C. upon complete addition of the feed. Residual amounts of monomer were removed by vacuum distillation for 1 h at 95° C. and 500 mbar.

### Example 20: Graft Polymerization of Vinyl Acetate (30 wt.-%) and Vinyl Pyrrolidone (20 wt.-%) on PEG (Mₙ 6000 g/Mol; 50 wt.-%)

The experimental procedure was performed according to example 1 K of US 2019/0390142 A1.

### Example 21: Graft Polymerization of Vinyl Acetate (30 wt.-%) on PPG (70 wt.-%)

A polymerization vessel equipped with stirrer and reflux condenser was initially charged with 700 g of PPG (Mₙ 2000 g/mol) under nitrogen atmosphere and heated to 90° C. Feed 1 containing 10.20 g of tert-butyl peroxy-2-ethylhexanoate, dissolved in 47.61 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (300 g of vinyl acetate) was started and dosed to the reaction vessel within 6:00 h at constant feed rate and 90° C. Upon completion of the feeds, Feed 3 consisting of 4.90 g of tert-butyl peroxy-2-ethylhexanoate, dissolved in 22.39 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 22: Graft Polymerization of Vinyl Acetate (40 wt.-%) on PO-EO-PO Block Copolymer (60 wt.-%)

A polymerization vessel equipped with stirrer and reflux condenser was initially charged with 600 g of PO-EO-PO block copolymer (Mₙ 3100 g/mol) under nitrogen atmosphere and melted at 90° C. Feed 1 containing 4.8 g of tert-butyl peroxy-2-ethylhexanoate, dissolved in 23.6 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (400 g of vinyl acetate) was started and dosed within 6:00 h at constant feed rate and 90° C. Upon completion of the Feeds 1 and 2, the temperature was increased to 95° C. and Feed 3 consisting of 3.16 g of tert-butyl peroxy-2-ethylhexanoate, dissolved in 15.70 g of tripropylene glycol, were dosed within 56 min with constant flow rate at 95° C. The mixture was stirred for one hour at 95° C. upon complete addition of the feed. Residual amounts of monomer were removed by vacuum distillation for 1 h at 95° C. and 500 mbar. The resulting graft polymer (Example 7) had a mean molecular weight M_{w} of 5 190 g/mol and a polydispersity of 1.5.

### Example 23: Graft Polymerization of Vinyl Acetate (15 wt.-%) on PEG (85 wt.-%)

A polymerization vessel equipped with stirrer and reflux condenser was initially charged with 850 g of PEG (Mₙ 1500 g/mol) under nitrogen atmosphere and melted at 90° C. Feed 1 containing 3.57 g of tert-butyl peroxy-2-ethylhexanoate, dissolved in 29.86 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (150 g of vinyl acetate) was started and dosed to the reaction vessel within 6:00 h at constant feed rate and 90° C. Upon completion of the feeds, Feed 3 consisting of 4.90 g of tert-butyl peroxy-2-ethylhexanoate, dissolved in 41.00 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 24: Graft Polymerization of Vinyl Acetate (30 wt.-%) and Vinyl Laurate

(10 wt.-%) on PO-EO-PO block copolymer (Mₙ 2650 g/mol; 60 wt.-%) A polymerization vessel equipped with stirrer and reflux condenser was initially charged with 600 g of PO-EO-PO block copolymer (Mₙ 2650 g/mol) under nitrogen atmosphere and melted at 90° C. Feed 1 containing 3.98 g of tert-butyl peroxy-2-ethylhexanoate, dissolved in 35.03 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (300 g of vinyl acetate) and Feed 3 (100 g of vinyl laurate) were started and dosed to the reaction vessel within 6:00 h at constant feed rate and 90° C. Upon completion of the feeds, Feed 4 consisting of 2.55 g of tert-butyl peroxy-2-ethylhexanoate, dissolved in 22.46 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 25: Graft Polymerization of Vinyl Acetate (15 wt.-%) and Vinyl Laurate (15 wt.-%) on PO-EO-PO Block Copolymer (Mₙ 2650 g/Mol; 70 wt.-%)

A polymerization vessel equipped with stirrer and reflux condenser was initially charged with 700 g of PO-EO-PO block copolymer (Mₙ 2650 g/mol) under nitrogen atmosphere and melted at 90° C. Feed 1 containing 3.98 g of tert-butyl peroxy-2-ethylhexanoate, dissolved in 35.03 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (150 g of vinyl acetate) and Feed 3 (150 g of vinyl laurate) were started and dosed to the reaction vessel within 6:00 h at constant feed rate and 90° C. Upon completion of the feeds, Feed 4 consisting of 2.55 g of tert-butyl peroxy-2-ethylhexanoate, dissolved in 22.46 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 26: Graft Polymerization of Vinyl Acetate (45 wt.-%) on EO-PO-EO Block Copolymer (Mₙ 1043 g/Mol, 55 wt.-%)

A polymerization vessel equipped with stirrer and reflux condenser was initially charged with 350 g of EO/PO statistical copolymer (Mₙ 1043 g/mol; (80% EO) under nitrogen atmosphere and melted at 90° C. Feed 1 containing 2.56 g of tert-butyl peroxy-2-ethylhexanoate, dissolved in 21.00 g of 1,2-propanediol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (286.36 g of vinyl acetate) was started and dosed to the reaction vessel within 6:00 h at constant feed rate and 90° C. Upon completion of the feeds, Feed 3 consisting of 1.62 g of tert-butyl peroxy-2-ethylhexanoate, dissolved in 13.33 g of 1,2-propanediol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 27: Graft Polymerization of Vinyl Acetate (60 wt.-%) on PO-EO-PO Block Copolymer (Mₙ 2103 g/Mol, 40 wt.-%)

A polymerization vessel equipped with stirrer and reflux condenser was initially charged with 350 g of EO/PO statistical copolymer (Mₙ 2103 g/mol; 80% EO) under nitrogen atmosphere and melted at 90° C. Feed 1 containing 3.52 g of tert-butyl peroxy-2-ethylhexanoate, dissolved in 28.88 g of 1,2-propanediol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (525 g of vinyl acetate) was started and dosed to the reaction vessel within 6:00 h at constant feed rate and 90° C. Upon completion of the feeds, Feed 3 consisting of 2.23 g of tert-butyl peroxy-2-ethylhexanoate, dissolved in 18.33 g of 1,2-propanediol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 28: Graft Polymerization of Vinyl Acetate (5 wt.-%) and Vinyl Laurate (15 wt.-%) on PO-EO-PO Block Copolymer (Mₙ 2650 g/Mol; 80 wt.-%)

A polymerization vessel equipped with stirrer and reflux condenser was initially charged with 800 g of PO-EO-PO block copolymer (Mₙ 2650 g/mol) under nitrogen atmosphere and melted at 90° C. Feed 1 containing 3.98 g of tert-butyl peroxy-2-ethylhexanoate, dissolved in 35.01 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (50 g of vinyl acetate) and Feed 3 (150 g of vinyl laurate) were started and dosed to the reaction vessel within 6:00 h at constant feed rate and 90° C. Upon completion of the feeds, Feed 4 consisting of 2.55 g of tert-butyl peroxy-2-ethylhexanoate, dissolved in 22.46 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 29: Graft Polymerization of Vinyl Acetate (45 wt.-%) and Vinyl Propionate (5 wt.-%) on PO-EO-PO Block Copolymer (Mₙ 2650 g/Mol; 50 wt.-%)

A polymerization vessel equipped with stirrer and reflux condenser was initially charged with 500 g of PO-EO-PO block copolymer (Mₙ 2650 g/mol) under nitrogen atmosphere and melted at 90° C. Feed 1 containing 3.98 g of tert-butyl peroxy-2-ethylhexanoate, dissolved in 35.01 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (450 g of vinyl acetate) and Feed 3 (50 g of vinyl propionate) were started and dosed to the reaction vessel within 6:00 h at constant feed rate and 90° C. Upon completion of the feeds, Feed 4 consisting of 2.55 g of tert-butyl peroxy-2-ethylhexanoate, dissolved in 22.46 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 30: Graft Polymerization of Vinyl Acetate (15 wt.-%) and Vinyl Propionate (15 wt.-%) on PO-EO-PO Block Copolymer (Mₙ 2650 g/Mol; 70 wt.-%)

A polymerization vessel equipped with stirrer and reflux condenser was initially charged with 700 g of PO-EO-PO block copolymer (Mₙ 2650 g/mol) under nitrogen atmosphere and melted at 90° C. Feed 1 containing 3.98 g of tert-butyl peroxy-2-ethylhexanoate, dissolved in 35.01 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (150 g of vinyl acetate) and Feed 3 (150 g of vinyl propionate) were started and dosed to the reaction vessel within 6:00 h at constant feed rate and 90° C. Upon completion of the feeds, Feed 4 consisting of 2.55 g of tert-butyl peroxy-2-ethylhexanoate, dissolved in 22.46 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 31: Graft Polymerization of Vinyl Acetate (5 wt.-%) and Vinyl Propionate (15 wt.-%) on PO-EO-PO Block Copolymer (Mₙ 2650 g/Mol; 80 wt.-%)

A polymerization vessel equipped with stirrer and reflux condenser was initially charged with 800 g of PO-EO-PO block copolymer (Mₙ 2650 g/mol) under nitrogen atmosphere and melted at 90° C. Feed 1 containing 3.98 g of tert-butyl peroxy-2-ethylhexanoate, dissolved in 35.01 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (50 g of vinyl acetate) and Feed 3 (150 g of vinyl propionate) were started and dosed to the reaction vessel within 6:00 h at constant feed rate and 90° C. Upon completion of the feeds, Feed 4 consisting of 2.55 g of tert-butyl peroxy-2-ethylhexanoate, dissolved in 22.46 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 32: Graft Polymerization of Vinyl Acetate (40 wt.-%) on EO/PO Backbone (Mₙ 2500 g/mol, 60 wt.-%)

A polymerization vessel equipped with stirrer and reflux condenser was initially charged with 480 g of EO/PO statistical copolymer (Mₙ 2500 g/mol; 35% EO) under nitrogen atmosphere and melted at 90° C. Feed 1 containing 4.48 g of tert-butyl peroxy-2-ethylhexanoate, dissolved in 34.30 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (320 g of vinyl acetate) was started and dosed to the reaction vessel within 6:00 h at constant feed rate and 90° C. Upon completion of the feeds, Feed 3 consisting of 2.83 g of tert-butyl peroxy-2-ethylhexanoate, dissolved in 21.69 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 33: Graft Polymerization of Vinyl Acetate (40 wt.-%) on EO/PO Backbone (Mₙ 2500 g/Mol, 60 wt.-%)

A polymerization vessel equipped with stirrer and reflux condenser was initially charged with 420 g of EO/PO statistical copolymer (Mₙ 2500 g/mol, 75% EO) under nitrogen atmosphere and melted at 90° C. Feed 1 containing 3.49 g of tert-butyl peroxy-2-ethylhexanoate, dissolved in 30.02 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (280 g of vinyl acetate) was started and dosed to the reaction vessel within 6:00 h at constant feed rate and 90° C. Upon completion of the feeds, Feed 3 consisting of 2.20 g of tert-butyl peroxy-2-ethylhexanoate, dissolved in 18.98 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 34: Graft Polymerization of Vinyl Acetate (40 wt.-%) on EO/PO Backbone (Mₙ 2500 g/Mol, 60 wt.-%)

A polymerization vessel equipped with stirrer and reflux condenser was initially charged with 420 g of EO/PO statistical copolymer (Mₙ 2500 g/mol; 55% EO) under nitrogen atmosphere and melted at 90° C. Feed 1 containing 3.70 g of tert-butyl peroxy-2-ethylhexanoate, dissolved in 30.02 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (280 g of vinyl acetate) was started and dosed to the reaction vessel within 6:00 h at constant feed rate and 90° C. Upon completion of the feeds, Feed 3 consisting of 2.34 g of tert-butyl peroxy-2-ethylhexanoate, dissolved in 18.98 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 35: Graft Polymerization of Vinyl Acetate (40 wt.-%) on EO/PO Backbone (Mₙ 2500 g/Mol, 60 wt.-%)

A polymerization vessel equipped with stirrer and reflux condenser was initially charged with 420 g of EO/PO statistical copolymer (Mₙ 2500 g/mol; % 90 EO) under nitrogen atmosphere and melted at 90° C. Feed 1 containing 3.05 g of tert-butyl peroxy-2-ethylhexanoate, dissolved in 30.02 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (280 g of vinyl acetate) was started and dosed to the reaction vessel within 6:00 h at constant feed rate and 90° C. Upon completion of the feeds, Feed 3 consisting of 1.93 g of tert-butyl peroxy-2-ethylhexanoate, dissolved in 18.98 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 36: Graft Polymerization of Vinyl Acetate (40 wt.-%) on PO-EO-PO Block Copolymer (Mₙ 2650 g/Mol; 60 wt.-%)

A polymerization vessel equipped with stirrer and reflux condenser was initially charged with 600 g of PO-EO-PO block copolymer (Mₙ 2650 g/mol) under nitrogen atmosphere and melted at 90° C. Feed 1 containing 4.02 g of tert-butyl peroxy-2-ethylhexanoate, dissolved in 33.00 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (400 g of vinyl acetate) was started and dosed within 6:00 h at constant feed rate and 90° C. Upon completion of the feeds, Feed 3 consisting of 2.55 g of tert-butyl peroxy-2-ethylhexanoate, dissolved in 20.95 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 37: Graft Polymerization of Vinyl Acetate (40 wt.-%) on PO-EO-PO Block Copolymer (Mₙ 2650 g/Mol; 60 wt.-%)

A polymerization vessel equipped with stirrer and reflux condenser was initially charged with 600 g of PO-EO-PO block copolymer (Mₙ 2650 g/mol) under nitrogen atmosphere and melted at 90° C. Feed 1 containing 11.20 g of tert-butyl peroxy-2-ethylhexanoate, dissolved in 53.18 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (400 g of vinyl acetate) was started and dosed within 6:00 h at constant feed rate and 90° C. Upon completion of the feeds, Feed 3 consisting of 3.54 g of tert-butyl peroxy-2-ethylhexanoate, dissolved in 16.81 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 38: Graft Polymerization of Vinyl Acetate (40 wt.-%) on PO-EO-PO Block Copolymer (Mₙ 2650 g/Mol; 60 wt.-%)

A polymerization vessel equipped with stirrer and reflux condenser was initially charged with 600 g of PO-EO-PO block copolymer (Mₙ 2650 g/mol) under nitrogen atmosphere and melted at 100° C. Feed 1 containing 11.20 g of tert-butyl peroxy-2-ethylhexanoate, dissolved in 53.18 g of tripropylene glycol, was dosed to the stirred vessel in 6:10 h, at 100° C. 5.56 wt.-% of Feed 1 were dosed in the first 10 min and the rest was dosed with constant feed rate for 6:00 h. 10 minutes after the start of Feed 1, Feed 2 (400 g of vinyl acetate) was started and dosed within 6:00 h at constant feed rate and 100° C. Upon completion of the feeds, Feed 3 consisting of 3.54 g of tert-butyl peroxy-2-ethylhexanoate, dissolved in 16.81 g of tripropylene glycol, were dosed within 56 min with constant flow rate at 100° C. The mixture was stirred for one hour at 100° C. upon complete addition of the feed. Residual amounts of monomer were removed by vacuum distillation for 1 h at 95° C. and 500 mbar.

### Example 39: Graft Polymerization of Vinyl Acetate (30 wt.-%) on EO/PO Backbone (Mₙ 2500 g/Mol; 70 wt.-%)

A polymerization vessel equipped with stirrer and reflux condenser was initially charged with 420 g of EO/PO statistical copolymer (Mₙ 2500 g/mol; 40% EO) under nitrogen atmosphere and melted at 90° C. Feed 1 containing 2.99 g of tert-butyl peroxy-2-ethylhexanoate, dissolved in 25.73 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (180 g of vinyl acetate) was started and dosed to the reaction vessel within 6:00 h at constant feed rate and 90° C. Upon completion of the feeds, Feed 3 consisting of 1.89 g of tert-butyl peroxy-2-ethylhexanoate, dissolved in 16.27 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 40: Graft Polymerization of Vinyl Acetate (5 wt.-%) and Vinyl Laurate (25 wt.-%) on PO-EO-PO Block Copolymer (Mₙ 2650 g/Mol; 70 wt.-%)

A polymerization vessel equipped with stirrer and reflux condenser was initially charged with 700 g of PO-EO-PO block copolymer (Mₙ 2650 g/mol) under nitrogen atmosphere and melted at 90° C. Feed 1 containing 3.57 g of tert-butyl peroxy-2-ethylhexanoate, dissolved in 29.50 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (250 g of vinyl acetate+50 g of vinyl laurate) was started and dosed to the reaction vessel within 6:00 h at constant feed rate and 90° C. Upon completion of the feeds, Feed 3 consisting of 4.90 g of tert-butyl peroxy-2-ethylhexanoate, dissolved in 40.48 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 41: Graft Polymerization of Vinyl Acetate (25 wt.-%) on PO-EO-PO Block Copolymer (Mₙ 2900 g/Mol; 75 wt.-%)

A polymerization vessel equipped with stirrer and reflux condenser was initially charged with 750 g of EO-PO-EO (Mₙ 2900 g/mol) under nitrogen atmosphere and melted at 90° C. Feed 1 containing 3.57 g of tert-butyl peroxy-2-ethylhexanoate, dissolved in 29.90 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (250 g of vinyl acetate) was started and dosed to the reaction vessel within 6:00 h at constant feed rate and 90° C. Upon completion of the feeds, Feed 3 consisting of 4.90 g of tert-butyl peroxy-2-ethylhexanoate, dissolved in 41.00 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 42: Graft Polymerization of Vinyl Acetate (25 wt.-%) on PO-EO-PO Block Copolymer (Mₙ 1950 g/Mol; 75 wt.-%)

A polymerization vessel equipped with stirrer and reflux condenser was initially charged with 937.50 g of EO-PO-EO (Mₙ 1950 g/mol) under nitrogen atmosphere and melted at 90° C. Feed 1 containing 4.46 g of tert-butyl peroxy-2-ethylhexanoate, dissolved in 37.38 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (312.50 g of vinyl acetate) was started and dosed to the reaction vessel within 6:00 h at constant feed rate and 90° C. Upon completion of the feeds, Feed 3 consisting of 6.12 g of tert-butyl peroxy-2-ethylhexanoate, dissolved in 51.25 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 43: Graft Polymerization of Vinyl Acetate (20 wt.-%) and Vinyl Laurate (5 wt.-%) on PO-EO-PO Block Copolymer (Mₙ 1950 g/Mol; 75 wt.-%)

A polymerization vessel equipped with stirrer and reflux condenser was initially charged with 750 g of PO-EO-PO block copolymer (Mₙ 1950 g/mol) under nitrogen atmosphere and melted at 90° C. Feed 1 containing 3.57 g of tert-butyl peroxy-2-ethylhexanoate, dissolved in 29.50 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (200 g of vinyl acetate+50 g of vinyl laurate) was started and dosed to the reaction vessel within 6:00 h at constant feed rate and 90° C. Upon completion of the feeds, Feed 3 consisting of 4.90 g of tert-butyl peroxy-2-ethylhexanoate, dissolved in 40.48 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 44: Graft Polymerization of Vinyl Acetate (40 wt.-%) on PO-EO-PO Block Copolymer (Mₙ 2900 g/Mol; 60 wt.-%)

A polymerization vessel equipped with stirrer and reflux condenser was initially charged with 600.00 g of EO-PO-EO (Mₙ 2900 g/mol) under nitrogen atmosphere and melted at 90° C. Feed 1 containing 11.22 g of tert-butyl peroxy-2-ethylhexanoate, dissolved in 40.21 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (400.00 g of vinyl acetate) was started and dosed to the reaction vessel within 6:00 h at constant feed rate and 90° C. Upon completion of the feeds, Feed 3 consisting of 3.57 g of tert-butyl peroxy-2-ethylhexanoate, dissolved in 12.79 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 45: Graft Polymerization of Vinyl Acetate (15 wt.-%) and Vinyl Laurate (5 wt.-%) on PO-EO-PO Block Copolymer (Mₙ 2650 g/Mol; 80 wt.-%)

A polymerization vessel equipped with stirrer and reflux condenser was initially charged with 800 g of PO-EO-PO block copolymer (Mₙ 2650 g/mol) under nitrogen atmosphere and melted at 90° C. Feed 1 containing 11.20 g of tert-butyl peroxy-2-ethylhexanoate, dissolved in 53.18 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (150 g of vinyl acetate+50 g of vinyl laurate) was started and dosed to the reaction vessel within 6:00 h at constant feed rate and 90° C. Upon completion of the feeds, Feed 3 consisting of 3.54 g of tert-butyl peroxy-2-ethylhexanoate, dissolved in 16.81 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 46: Graft Polymerization of Vinyl Acetate (20 wt.-%) and Vinyl Laurate (5 wt.-%) on PO-EO-PO Block Copolymer (Mₙ 2650 g/Mol; 75 wt.-%)

A polymerization vessel equipped with stirrer and reflux condenser was initially charged with 750 g of PO-EO-PO block copolymer (Mₙ 2650 g/mol) under nitrogen atmosphere and melted at 90° C. Feed 1 containing 11.20 g of tert-butyl peroxy-2-ethylhexanoate, dissolved in 53.18 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (200 g of vinyl acetate+50 g of vinyl laurate) was started and dosed to the reaction vessel within 6:00 h at constant feed rate and 90° C. Upon completion of the feeds, Feed 3 consisting of 3.54 g of tert-butyl peroxy-2-ethylhexanoate, dissolved in 16.81 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 47: Graft Polymerization of Vinyl Laurate (10 wt.-%) on PO-EO-PO Block Copolymer (Mₙ 2650 g/Mol; 90 wt.-%)

A polymerization vessel equipped with stirrer and reflux condenser was initially charged with 900 g of PO-EO-PO block copolymer (Mₙ 2650 g/mol) under nitrogen atmosphere and melted at 90° C. Feed 1 containing 20.41 g of tert-butyl peroxy-2-ethylhexanoate, dissolved in 59.60 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (100 g of vinyl laurate) was started and dosed to the reaction vessel within 6:00 h at constant feed rate and 90° C. Upon completion of the feeds, Feed 3 consisting of 3.57 g of tert-butyl peroxy-2-ethylhexanoate, dissolved in 10.43 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 48: Graft Polymerization of Vinyl Acetate (20 wt.-%) on PEG (Mₙ 600 g/Mol; 80 wt.-%)

A polymerization vessel equipped with stirrer and reflux condenser was initially charged with 800 g of PEG (Mₙ 600 g/mol) under nitrogen atmosphere and melted at 90° C. Feed 1 containing 4.08 g of tert-butyl peroxy-2-ethylhexanoate, dissolved in 31.82 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (200 g of vinyl acetate) was started and dosed to the reaction vessel within 6:00 h at constant feed rate and 90° C. Upon completion of the feeds, Feed 3 consisting of 4.90 g of tert-butyl peroxy-2-ethylhexanoate, dissolved in 38.18 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 49: Graft Polymerization of Vinyl Acetate (20 wt.-%) and Vinyl Laurate (5 wt.-%) on PO-EO-PO Block Copolymer (Mₙ 2650 g/Mol; 75 wt.-%)

A polymerization vessel equipped with stirrer and reflux condenser was initially charged with 750 g of PO-EO-PO block copolymer (Mₙ 2650 g/mol) under nitrogen atmosphere and melted at 90° C. Feed 1 containing 4.08 g of tert-butyl peroxy-2-ethylhexanoate, dissolved in 37.33 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (200 g of vinyl acetate+50 g of vinyl laurate) was started and dosed to the reaction vessel within 6:00 h at constant feed rate and 90° C. Upon completion of the feeds, Feed 3 consisting of 3.57 g of tert-butyl peroxy-2-ethylhexanoate, dissolved in 32.67 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 50: Graft Polymerization of Vinyl Acetate (10 wt.-%) and Vinyl Pyrrolidone (30 wt.-%) on PEG (Mₙ 4000 g/Mol; 60 wt.-%)

A polymerization vessel equipped with stirrer and reflux condenser was initially charged with 420 g of PEG (Mₙ 4000 g/mol) under nitrogen atmosphere and melted at 90° C. Feed 1 containing 2.50 g of tert-butyl peroxy-2-ethylhexanoate, dissolved in 20.66 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (70.0 g of vinyl acetate and Feed 3 (210.0 g of vinyl pyrrolidone) was started and dosed to the reaction vessel within 6:00 h at constant feed rate and 90° C. Upon completion of the feeds, Feed 4 consisting of 3.43 g of tert-butyl peroxy-2-ethylhexanoate, dissolved in 28.34 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 51: Graft Polymerization of Vinyl Acetate (40 wt.-%) on Lupranol® 2048 (Mₙ3550 g/Mol; 60 wt.-%)

A polymerization vessel equipped with stirrer and reflux condenser was initially charged with 600 g of Lupranol® 2048 (Mₙ 3550 g/mol) under nitrogen atmosphere and melted at 90° C. Feed 1 containing 5.60 g of tert-butyl peroxy-2-ethylhexanoate, dissolved in 42.88 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (400 g of vinyl acetate) was started and dosed to the reaction vessel within 6:00 h at constant feed rate and 90° C. Upon completion of the feeds, Feed 3 consisting of 3.54 g of tert-butyl peroxy-2-ethylhexanoate, dissolved in 27.11 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 52: Graft Polymerization of Vinyl Acetate (40 wt.-%) on Lupranol® 6000/1 (Mₙ 2200 g/Mol; 60 wt.-%)

A polymerization vessel equipped with stirrer and reflux condenser was initially charged with 360 g of Lupranol® 6000/1 (Mₙ 2200 g/mol) under nitrogen atmosphere and melted at 90° C. Feed 1 containing 3.36 g of tert-butyl peroxy-2-ethylhexanoate, dissolved in 25.73 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (240 g of vinyl acetate) was started and dosed to the reaction vessel within 6:00 h at constant feed rate and 90° C. Upon completion of the feeds, Feed 3 consisting of 2.12 g of tert-butyl peroxy-2-ethylhexanoate, dissolved in 16.27 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 53: Graft Polymerization of Vinyl Acetate (20 wt.-%) and Isobutyl Vinyl Ether (5 wt. %) on PEG (Mₙ 1500 g/Mol; 75 wt.-%)

A polymerization vessel equipped with stirrer and reflux condenser was initially charged with 675 g of PEG (Mₙ 1500 g/mol) under nitrogen atmosphere and melted at 90° C. Feed 1 containing 18.37 g of tert-butyl peroxy-2-ethylhexanoate, dissolved in 56.45 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (180 g of vinyl acetate) and Feed 3 (45.92 g of isobutyl vinyl ether) were started and dosed to the reaction vessel within 6:00 h at constant feed rate and 90° C. Upon completion of the feeds, Feed 4 consisting of 4.41 g of tert-butyl peroxy-2-ethylhexanoate, dissolved in 13.55 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 54: Graft Polymerization of Vinyl Acetate (20 wt.-%) and Isobutyl Vinyl Ether (5 wt. %) on PEG (Mₙ 1500 g/Mol; 75 wt.-%)

A polymerization vessel equipped with stirrer and reflux condenser was initially charged with 675 g of PEG (Mₙ 1500 g/mol) under nitrogen atmosphere and melted at 90° C. Feed 1 containing 27.55 g of tert-butyl peroxy-2-ethylhexanoate, dissolved in 60.34 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (180 g of vinyl acetate) and Feed 3 (45.92 g of isobutyl vinyl ether) were started and dosed to the reaction vessel within 6:00 h at constant feed rate and 90° C. Upon completion of the feeds, Feed 4 consisting of 4.41 g of tert-butyl peroxy-2-ethylhexanoate, dissolved in 9.66 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 55: Graft Polymerization of Vinyl Acetate (15 wt.-%) and Isobutyl Vinyl Ether (10 wt. %) on PEG (Mₙ 1500 g/Mol; 75 wt.-%)

A polymerization vessel equipped with stirrer and reflux condenser was initially charged with 675 g of PEG (Mₙ 1500 g/mol) under nitrogen atmosphere and melted at 90° C. Feed 1 containing 10.10 g of tert-butyl peroxy-2-ethylhexanoate, dissolved in 40.53 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (135 g of vinyl acetate) and Feed 3 (91.84 g of isobutyl vinyl ether) were started and dosed to the reaction vessel within 6:00 h at constant feed rate and 90° C. Upon completion of the feeds, Feed 4 consisting of 7.35 g of tert-butyl peroxy-2-ethylhexanoate, dissolved in 29.47 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 56: Graft Polymerization of Vinyl Acetate (40 wt.-%) on PEG (Mₙ 1500 g/Mol; 60 wt.-%)

A polymerization vessel equipped with stirrer and reflux condenser was initially charged with 560.40 g of PEG (Mₙ 1500 g/mol) under nitrogen atmosphere and melted at 90° C. Feed 1 containing 5.23 g of tert-butyl peroxy-2-ethylhexanoate, dissolved in 40.05 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (373.60 g of vinyl acetate) was started and dosed to the reaction vessel within 6:00 h at constant feed rate and 90° C. Upon completion of the feeds, Feed 3 consisting of 3.31 g of tert-butyl peroxy-2-ethylhexanoate, dissolved in 25.32 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 57: Graft Polymerization of Vinyl Acetate (10 wt.-%) and Vinyl Pyrrolidone (30 wt.-%) on PEG (Mₙ 1500 g/Mol; 60 wt.-%)

A polymerization vessel equipped with stirrer and reflux condenser was initially charged with 420 g of PEG (Mₙ 1500 g/mol) under nitrogen atmosphere and melted at 90° C. Feed 1 containing 2.50 g of tert-butyl peroxy-2-ethylhexanoate, dissolved in 20.66 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (70.0 g of vinyl acetate) and Feed 3 (210.0 g of vinyl pyrrolidone) were started and dosed to the reaction vessel within 6:00 h at constant feed rate and 90° C. Upon completion of the feeds, Feed 4 consisting of 3.43 g of tert-butyl peroxy-2-ethylhexanoate, dissolved in 28.34 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar.

### Example 58: Graft Polymerization of Vinyl Acetate (40 wt.-%) on PO-EO-PO Block Copolymer (Mₙ 2650 g/Mol; 60 wt.-%) Und Subsequent Hydrolysis of 10% of Vinyl Acetate

A polymerization vessel equipped with stirrer and reflux condenser was initially charged with 125.19 g of EO-PO-EO (Mₙ 2650 g/mol) under nitrogen atmosphere and melted at 90° C. Feed 1 containing 0.84 g of tert-butyl peroxy-2-ethylhexanoate, dissolved in 6.89 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (83.46 g of vinyl acetate) was started and dosed to the reaction vessel within 6:00 h at constant feed rate and 90° C. Upon completion of the feeds, Feed 3 consisting of 0.53 g of tert-butyl peroxy-2-ethylhexanoate, dissolved in 4.37 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar. The mixture was stirred at 80° C. and Feed 4 consisting of 7.76 g of sodium hydroxide dissolved in 78.71 g of water was added slowly keeping the temperature below 85° C. Upon completion of the feed the mixture was stirred for one hour at 80° C. and cooled down to room temperature.

### Example 59: Graft Polymerization of Vinyl Acetate (40 wt.-%) on PO-EO-PO Block Copolymer (Mₙ 2650 g/Mol; 60 wt.-%) Und Subsequent Hydrolysis of 25% of Vinyl Acetate

A polymerization vessel equipped with stirrer and reflux condenser was initially charged with 125.19 g of EO-PO-EO (Mₙ 2650 g/mol) under nitrogen atmosphere and melted at 90° C. Feed 1 containing 0.84 g of tert-butyl peroxy-2-ethylhexanoate, dissolved in 6.89 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (83.46 g of vinyl acetate) was started and dosed to the reaction vessel within 6:00 h at constant feed rate and 90° C. Upon completion of the feeds, Feed 3 consisting of 0.53 g of tert-butyl peroxy-2-ethylhexanoate, dissolved in 4.37 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar. The mixture was stirred at 80° C. and Feed 4 consisting of 19.39 g of sodium hydroxide dissolved in 78.71 g of water was added slowly keeping the temperature below 85° C. Upon completion of the feed the mixture was stirred for one hour at 80° C. and cooled down to room temperature.

### Example 60: Graft Polymerization of Vinyl Acetate (40 wt.-%) on PO-EO-PO Block Copolymer (Mₙ 2650 g/Mol; 60 wt.-%) Und Subsequent Hydrolysis of 40% of Vinyl Acetate

A polymerization vessel equipped with stirrer and reflux condenser was initially charged with 125.19 g of EO-PO-EO (Mₙ 2650 g/mol) under nitrogen atmosphere and melted at 90° C. Feed 1 containing 0.84 g of tert-butyl peroxy-2-ethylhexanoate, dissolved in 6.89 g of tripropylene glycol, was dosed to the stirred vessel in 6:10 h, at 90° C. 5.56 wt.-% of Feed 1 were dosed in the first 10 min and the rest was dosed with constant feed rate for 6:00 h. 10 minutes after the start of Feed 1, Feed 2 (83.46 g of vinyl acetate) was started and dosed to the reaction vessel within 6:00 h at constant feed rate and 90° C. Upon completion of the feeds, Feed 3 consisting of 0.53 g of tert-butyl peroxy-2-ethylhexanoate, dissolved in 4.37 g of tripropylene glycol, were dosed within 56 min with constant flow rate at 90° C. The mixture was stirred for one hour at 90° C. upon complete addition of the feed. Residual amounts of monomer were removed by vacuum distillation for 1 h at 95° C. and 500 mbar. The mixture was stirred at 80° C. and Feed 4 consisting of 37.19 g of sodium hydroxide dissolved in 94.37 g of water was added slowly keeping the temperature below 85° C. Upon completion of the feed the mixture was stirred for one hour at 80° C. and cooled down to room temperature.

### Biodegradation

Biodegradation in waste water was tested three times using the manometric respirometry OECD 301 F method. 30 mg/mL test substance was inoculated into wastewater taken from Mannheim Wastewater Treatment Plant and incubated in a closed flask at 25° C. for 28 days. The consumption of oxygen during this time was measured as the change in pressure inside the flask using an OxiTop C (WTW). Evolved CO₂ was absorbed using an NaOH solution. The amount of oxygen consumed by the microbial population during biodegradability of the test substance, after correction using a blank, is expressed as a percentage of the ThOD (Theoretical Oxygen Demand).

The results are shown in the following table. The following abbreviations are used:
Ex.=inventive example
Ref. Ex.=reference example
% EO=total EO content of the backbone
A1, A2: structure according to formulae (A1) or (A2), respectively
VAc=vinyl acetate
VPr=vinyl propionate
VLau=vinyl laurate
VP=vinyl pyrrolidone
IBVE=isobutyl vinyl ether
VOH=hydrolyzed vinyl acetate

TABLE 1

| | | | | | Weight Ratio of | |
|---|---|---|---|---|---|---|
| | | | | | Polymer | |
| | Polymer | Polymer | Polymer | | Backbone to | |
| | Backbone | Backbone | Backbone | Sidechain | Sidechain | Biodegradation |
| | Mₙ [g/mol] | % EO | Structure | Monomers | Monomers | [%], 28 d |
| Ex. 1 | 2650 | 40% | A2 | VAc | 60/40 | 59 |
| Ex. 2 | 6500 | 50% | A1 | VAc | 60/40 | 16 |
| Ex. 3 | 1500 | 100 | PEG | VAc | 80/20 | 66 |
| Ex. 4 | 1950 | 50% | A2 | VAc | 70/30 | 52 |
| Ex. 5 | 2650 | 40% | A2 | VAc | 50/50 | 38 |
| Ex. 6 | 4000 | 100 | PEG | VAc/VLau | 60/20/20 | 30 |
| Ex. 7 | 1950 | 50% | A2 | VAc | 60/40 | 56 |
| Ex. 8 | 4000 | 100 | PEG | VAc | 60/40 | 39 |
| Ex. 9 | 5900 | 40% | A1 | VAc | 60/40 | 12 |
| Ex. 10 | 1500 | 100 | PEG | VAc | 70/30 | 47 |
| Ex. 11 | 1500 | 100 | PEG | VAc | 75/25 | 63 |
| Ex. 12 | 2650 | 40% | A2 | VAc | 75/25 | 60 |
| Ex. 13 | 2500 | 60 | EO/PO | VAc | 50/50 | 29 |
| | | | random | | | |
| Ex. 14 | 2500 | 60 | EO/PO | VAc | 30/70 | 18 |
| | | | random | | | |
| Ex. 15 | 1500 | 100 | PEG | VAc/VLau | 75/20/5 | 59 |
| Ex. 16 | 600 | 100 | PEG | VAc | 70/30 | 64 |
| Ex. 17 | 2650 | 40% | A2 | VAc | 65/35 | 53 |
| Ex. 18 | 2900 | 40% | A1 | VAc | 80/20 | 50 |
| Ex. 19 | 6000 | 100 | PEG | VAc | 40/60 | 28 |
| Ex. 20 | 6000 | 100 | PEG | VAc/VP | 50/30/20 | 15 |
| Ex. 21 | 2000 | 0% | PPG | VAc | 70/30 | 56 |
| Ex. 22 | 3100 | 20% | A2 | VAc | 60/40 | 47 |
| Ex. 23 | 1500 | 100 | PEG | VAc | 85/15 | 74 |
| Ex. 24 | 2650 | 40 | A2 | VAc/VLau | 60/30/10 | 32 |
| Ex. 25 | 2650 | 40 | A2 | VAc/VLau | 70/15/15 | 47 |
| Ex. 26 | 1043 | 80 | A1 | VAc | 55/45 | 63 |
| Ex. 27 | 2103 | 80 | A2 | VAc | 40/60 | 55 |
| Ex. 28 | 2650 | 40 | A2 | VAc/VLau | 80/5/15 | 63 |
| Ex. 29 | 2650 | 40 | A2 | VAc/VPr | 50/45/5 | 40 |
| Ex. 30 | 2650 | 40 | A2 | VAc/VPr | 70/15/15 | 54 |
| Ex. 31 | 2650 | 40 | A2 | VAc/VPr | 80/5/15 | 66 |
| Ex. 32 | 2500 | 35 | EO/PO | VAc | 60/40 | 44 |
| | | | random | | | |
| Ex. 33 | 2500 | 75 | EO/PO | VAc | 60/40 | 47 |
| | | | random | | | |
| Ex. 34 | 2500 | 55 | EO/PO | VAc | 60/40 | 43 |
| | | | random | | | |
| Ex. 35 | 2500 | 90 | EO/PO | VAc | 60/40 | 47 |
| | | | random | | | |
| Ex. 36 | 2650 | 40 | A2 | VAc | 60/40 | 53 |
| Ex. 37 | 2650 | 40 | A2 | VAc | 60/40 | 53 |
| Ex. 38 | 2650 | 40 | A2 | VAc | 60/40 | 49 |
| Ex. 39 | 2500 | 60 | EO/PO | VAc | 70/30 | 43 |
| | | | random | | | |
| Ex. 40 | 2650 | 40 | A2 | VAc/VLau | 70/25/5 | 53 |
| Ex. 41 | 2900 | 40 | A1 | VAc | 75/25 | 56 |
| Ex. 42 | 1950 | 50 | A2 | VAc | 75/25 | 62 |
| Ex. 43 | 1950 | 50 | A2 | VAc/VLau | 75/20/5 | 59 ** |
| Ex. 44 | 2900 | 40 | A1 | VAc | 60/40 | 38 |
| Ex. 45 | 2650 | 40 | A2 | VAc/VLau | 75/20/5 | 66 |
| Ex. 46 | 2650 | 40 | A2 | VAc/VLau | 75/20/5 | n.d. * |
| Ex. 47 | 2650 | 40 | A2 | VLau | 90/10 | 73 |
| Ex. 48 | 600 | 100 | PEG | VAc | 80/20 | n.d. * |
| Ex. 49 | 2650 | 40 | A2 | VAc/VLau | 75/20/5 | 61 |
| Ex. 50 | 4000 | 100 | PEG | VAc/VP | 60/10/30 | 34 |
| Ex. 51 | 3550 | 72 | Lupranol ® | VAc | 60/40 | 19 |
| | | | 2048 | | | |
| Ex. 52 | 2200 | 80 | Lupranol ® | VAc | 60/40 | 39 |
| | | | 6000/1 | | | |
| Ex. 53 | 1500 | 100 | PEG | VAc/IBVE | 75/20/5 | 53 |
| Ex. 54 | 1500 | 100 | PEG | VAc/IBVE | 75/20/5 | 50 |
| Ex. 55 | 1500 | 100 | PEG | VAc/IBVE | 75/20/5 | n.d. * |
| Ex. 56 | 1500 | 100 | PEG | VAc | 60/40 | 46 |
| Ex. 57 | 1500 | 100 | PEG | VAc/VP | 60/10/30 | n.d. * |
| Ex. 58 | 2650 | 40 | A2 | VAc/VOH | 60/30/10 | 45 |
| Ex. 59 | 2650 | 40 | A2 | VAc/VOH | 60/15/25 | 44 |
| Ex. 60 | 2650 | 40 | A2 | VAc/VOH | 60/0/40 | 44 |

* n.d. = not determined
** determined after 14 days

### Viscosity Measurements

Viscosity of the samples was measured using a Brookfield Viscosimeter. For the measurements, the samples were diluted with tripropylene glycol to the solid content indicated in the table 2. The samples were heated to 60° C. and measured using spindle 31 at 30 rpm.

TABLE 2
Viscosities

| | Solids content | Viscosity |
|---|---|---|
| Example | [%] | [mPa · s] |
| Ex. 1 | 85 | 632 |
| Ex. 1 | 80 | 550 |
| Ex. 1 | 75 | 360 |
| Ex. 1 | 70 | 322 |

### Composition Examples—Suspension Concentrates

All references to fully demineralized water refer to water which was fully demineralized and additionally purified by ion exchange, having a pH value of about 5.5.

### Preparation

Suspension concentrates were prepared by grinding 40 wt.-% of solids (w.s.) active ingredient, 2.5% or 5% w.s. dispersant, 0.3% w.s. Agnique DFM 111 S (silicon emulsion defoamer) with fully demineralized water in a disperser “DAS 200”, Lau GmbH with glass balls (diameter: 2 or 3 mm) such that the dispersed pesticide particles reached a particle size distribution characterized by a D90 of ≤10 μm and a D50≤3 μm and a D10≤1 μm. Particles analysis was done according to method (1). Storage stability was assessed as described in method (II). Blooming and suspensibility were determined according to method (III) and (IV). The specific components and experimental results are shown in the tables below.

### Method (I): Particle Size Analysis According to CIPAC MT 187

Approximately 1.0 mL of the sample (suspension) was slightly shaken into 9 mL of fully demineralized water. This diluted sample was added dropwise to a Malvern Master Sizer Dispersing Unit (Hydro MV) until a laser shadowing of 6% (+/−1.5%) was reached. Within the dispersing unit, the sample was diluted in 120 mL of fully demineralized water and pumped through the measuring cell of the Malvern Mastersizer 3000 (Malvern Pananalytical GmbH, Germany) that used a 632.8 nm laser (4 mW He—Ne) for analysis. The sample and the fully demineralized water used for the dilution were at room temperature. Particle size distribution, including D10, D50 and D90 values, was calculated using the Fraunhofer model as known in the art. See, e.g., ISO 13320-1:1999(E).

### Method (II): Accelerated Storage Test According to CIPAC MT 46.3

About 10 mL of the sample (suspension) were placed in a 40 mL Penicillin glass bottle fitted with screw cap and polyethylene inserts and kept in a temperature-controlled cabinet at the specified temperatures (+/−2° C.) for the defined period of time. In the swing tests indicated as “−10/+40° C.” below, the temperature was switched between −10° C. and 40° C. every 12 h. After the defined period of time, the bottle was removed from the oven and allowed to reach room temperature before further analysis.

### Method (III): Blooming

95 mL of CIPAC water D were filled into a 100 mL measuring cylinder. Then 4 drops of the suspension concentrate were added and the distribution was evaluated: 1: homogeneous, 3: cylinder completely filled, but not completely homogeneous (<20%), 5: SC does not distribute, remains either at the top or at the bottom, 2 & 4 is accordingly in between.

### Method (IV): Suspensibility According to CIPAC MT 161

The filled measuring cylinder from Method III was taken and more suspension concentrate was added until the cylinder comprised 5 g thereof. Subsequently, the cylinder content was homogenized by ten times 180° inversion, and allowed to stand for 30 min. Next, the top nine-tenths of the content were removed and the remaining tenth was then dried (ca. 50° C./500 mbar), assayed gravimetrically, and the suspensibility was calculated according to the following method:

$$1 - ( wt . solids / wt . water in sample composition ) = \% wt . by solids \qquad Calculation 1$$

$$[ ( Starting sample weight ) \times ( value of calculation 1 , as decimal ) ] = grams of dispersible solids \qquad Calculation 2$$

$$( 1 - ( \frac{weight of filled cylinder ( g ) - weight of empty cylinder ( g )}{( value of Calculation 2 ) - ( 0.1 \times value of Calaculation 2 )} ) ) \times 100 = Suspensibility ( \% ) \qquad Calculation 3$$

TABLE
Particle Size Stability (Suspension Concentrates
with 40% w.s. Azoxystrobin)

| | Particle Size | | Particle Size | |
|---|---|---|---|---|
| | Distribution [μm] | | Distribution [μm] | |
| Dispersant | 2.5% w.s. of Dispersant | | 5% w.s. of Dispersant | |
| Ex. 1 | | | | |
| start | D10 | 0.59 | D10 | 0.71 |
| | D50 | 2.06 | D50 | 1.55 |
| | D90 | 5.13 | D90 | 3.36 |
| rt, 14 d | D10 | 0.72 | D10 | 0.65 |
| | D50 | 1.48 | D50 | 1.4 |
| | D90 | 3.07 | D90 | 3.28 |
| −10/+40° C., 14 d | D10 | 0.76 | | |
| | D50 | 2.05 | | |
| | D90 | 5.5 | | |
| 54° C., 14 d | D10 | 0.79 | D10 | 0.77 |
| | D50 | 2.95 | D50 | 2.84 |
| | D90 | 8.49 | D90 | 7.95 |
| Ex. 2 | | | | |
| start | D10 | 0.62 | D10 | 0.61 |
| | D50 | 1.47 | D50 | 1.33 |
| | D90 | 6.32 | D90 | 3.42 |
| rt, 14 d | D10 | 0.60 | D10 | 0.59 |
| | D50 | 1.38 | D50 | 1.33 |
| | D90 | 3.68 | D90 | 3.4 |
| −10/+40° C., 14 d | D10 | 0.77 | D10 | 0.67 |
| | D50 | 2.06 | D50 | 1.63 |
| | D90 | 15.1 | D90 | 3.38 |
| 54° C., 14 d | D10 | 0.69 | D10 | 0.60 |
| | D50 | 1.34 | D50 | 1.32 |
| | D90 | 3 | D90 | 2.92 |
| Ex. 3 | | | | |
| start | | | D10 | 0.78 |
| | | | D50 | 1.81 |
| | | | D90 | 4.25 |
| rt, 14 d | | | D10 | 0.71 |
| | | | D50 | 1.65 |
| | | | D90 | 4.54 |
| 54° C., 14 d | | | D10 | 0.69 |
| | | | D50 | 1.58 |
| | | | D90 | 3.49 |
| Ex. 4 | | | | |
| start | | | D10 | 0.69 |
| | | | D50 | 1.76 |
| | | | D90 | 3.65 |
| rt, 14 d | | | D10 | 0.59 |
| | | | D50 | 1.32 |
| | | | D90 | 2.93 |
| −10/+40° C., 14 d | | | D10 | 0.61 |
| | | | D50 | 1.54 |
| | | | D90 | 3.49 |
| 54° C., 14 d | | | D10 | 0.72 |
| | | | D50 | 2.59 |
| | | | D90 | 7.37 |
| Ex. 5 | | | | |
| start | | | D10 | 0.79 |
| | | | D50 | 1.91 |
| | | | D90 | 4.89 |
| −10/+40° C., 14 d | | | D10 | 0.75 |
| | | | D50 | 2.36 |
| | | | D90 | 6.28 |
| Ex. 6 | | | | |
| start | | | D10 | 0.75 |
| | | | D50 | 1.70 |
| | | | D90 | 4.28 |
| rt, 14 d | | | D10 | 0.73 |
| | | | D50 | 1.74 |
| | | | D90 | 4.54 |
| −10/+40° C., 14 d | | | D10 | 0.70 |
| | | | D50 | 1.67 |
| | | | D90 | 4 |
| Ex. 7 | | | | |
| start | | | D10 | 0.72 |
| | | | D50 | 1.84 |
| | | | D90 | 3.79 |
| rt, 14 d | | | D10 | 0.60 |
| | | | D50 | 1.31 |
| | | | D90 | 2.83 |
| 54° C., 14 d | | | D10 | 0.76 |
| | | | D50 | 2.75 |
| | | | D90 | 7.83 |
| Ex. 8 | | | | |
| start | D10 | 0.66 | | |
| | D50 | 1.43 | | |
| | D90 | 4.55 | | |
| rt, 14 d | D10 | 0.64 | | |
| | D50 | 1.42 | | |
| | D90 | 3.84 | | |
| −10/+40° C., 14 d | D10 | 0.64 | | |
| | D50 | 1.4 | | |
| | D90 | 3.5 | | |
| Ex. 9 | | | | |
| start | D10 | 0.6 | | |
| | D50 | 1.45 | | |
| | D90 | 5.86 | | |
| rt, 14 d | D10 | 0.6 | | |
| | D50 | 1.43 | | |
| | D90 | 5.05 | | |
| 54° C., 14 d | D10 | 0.60 | | |
| | D50 | 1.32 | | |
| | D90 | 2.9 | | |
| Ex. 10 | | | | |
| start | D10 | 0.78 | D10 | 0.72 |
| | D50 | 1.78 | D50 | 1.65 |
| | D90 | 3.91 | D90 | 3.5 |
| rt, 14 d | D10 | 0.74 | D10 | 0.62 |
| | D50 | 1.85 | D50 | 1.36 |
| | D90 | 6.68 | D90 | 3.23 |
| 54° C., 14 d | D10 | 0.76 | D10 | 0.65 |
| | D50 | 2.09 | D50 | 1.42 |
| | D90 | 9.74 | D90 | 3.07 |
| Ex. 11 | | | | |
| start | | | D10 | 0.70 |
| | | | D50 | 1.54 |
| | | | D90 | 3.50 |
| rt, 14 d | | | D10 | 0.66 |
| | | | D50 | 1.48 |
| | | | D90 | 3.67 |
| −10/+40° C., 14 d | | | D10 | 0.65 |
| | | | D50 | 1.45 |
| | | | D90 | 3.3 |
| 54° C., 14 d | | | D10 | 0.65 |
| | | | D50 | 1.47 |
| | | | D90 | 3.2 |
| Ex. 12 | | | | |
| start | | | D10 | 0.7 |
| | | | D50 | 1.60 |
| | | | D90 | 3.15 |
| rt, 14 d | | | D10 | 0.65 |
| | | | D50 | 1.37 |
| | | | D90 | 2.8 |
| −10/+40° C., 14 d | | | D10 | 0.69 |
| | | | D50 | 2.43 |
| | | | D90 | 5.82 |
| 54° C., 14 d | | | D10 | 0.58 |
| | | | D50 | 2.16 |
| | | | D90 | 5.67 |
| Ex. 13 | | | | |
| start | D10 | 0.72 | | |
| | D50 | 1.72 | | |
| | D90 | 4.96 | | |
| rt, 14 d | D10 | 0.61 | | |
| | D50 | 1.45 | | |
| | D90 | 4.5 | | |
| 54° C., 14 d | D10 | 0.76 | | |
| | D50 | 2.86 | | |
| | D90 | 8.89 | | |
| Ex. 14 | | | | |
| start | D10 | 0.82 | | |
| | D50 | 2.14 | | |
| | D90 | 6.12 | | |
| rt, 14 d | D10 | 0.71 | | |
| | D50 | 1.72 | | |
| | D90 | 4.34 | | |
| Ex. 15 | | | | |
| start | D10 | 0.67 | | |
| | D50 | 1.51 | | |
| | D90 | 3.76 | | |
| rt, 14 d | D10 | 0.64 | | |
| | D50 | 1.45 | | |
| | D90 | 3.34 | | |
| 54° C., 14 d | D10 | 0.63 | | |
| | D50 | 1.43 | | |
| | D90 | 3.05 | | |

| | |
|---|---|
| | Particle Size Distribution [μm] |
| Dispersant | 5% w.s. of Dispersant |

| | | |
|---|---|---|
| Ex. 18 | | |
| start | D10 | 0.63 |
| | D50 | 1.34 |
| | D90 | 2.72 |
| rt, 14 d | D10 | 0.59 |
| | D50 | 1.31 |
| | D90 | 2.87 |
| Ex. 20 | | |
| start | D10 | 0.66 |
| | D50 | 1.46 |
| | D90 | 3.39 |
| Ex. 24 | | |
| start | D10 | 0.57 |
| | D50 | 1.30 |
| | D90 | 3.32 |
| rt, 14 d | D10 | 0.58 |
| | D50 | 1.33 |
| | D90 | 3.28 |
| 54° C., 14 d | D10 | 0.76 |
| | D50 | 3.03 |
| | D90 | 8.7 |
| Ex. 25 | | |
| start | D10 | 0.72 |
| | D50 | 1.58 |
| | D90 | 4.06 |
| rt, 14 d | D10 | 0.71 |
| | D50 | 1.52 |
| | D90 | 3.27 |
| −10/+40° C., | D10 | 0.77 |
| 14 d | D50 | 2.35 |
| | D90 | 6.14 |
| 54° C., 14 d | D10 | 0.76 |
| | D50 | 2.76 |
| | D90 | 8.21 |
| Ex. 26 | | |
| start | D10 | 0.8 |
| | D50 | 2.24 |
| | D90 | 6.08 |
| rt, 14 d | D10 | 0.76 |
| | D50 | 2.12 |
| | D90 | 5.1 |
| 54° C., 14 d | D10 | 0.74 |
| | D50 | 2.62 |
| | D90 | 6.96 |
| Ex. 27 | | |
| start | D10 | 0.67 |
| | D50 | 1.47 |
| | D90 | 4.65 |
| rt, 14 d | D10 | 0.62 |
| | D50 | 1.38 |
| | D90 | 4.44 |
| −10/+40° C., | D10 | 0.62 |
| 14 d | D50 | 1.61 |
| | D90 | 3.42 |
| 54° C., 14 d | D10 | 0.63 |
| | D50 | 1.36 |
| | D90 | 3.25 |
| Ex. 28 | | |
| start | D10 | 0.65 |
| | D50 | 1.38 |
| | D90 | 3.00 |
| 54° C., 14 d | D10 | 0.73 |
| | D50 | 2.86 |
| | D90 | 7.5 |
| Ex. 29 | | |
| start | D10 | 0.72 |
| | D50 | 1.65 |
| | D90 | 4.25 |
| rt, 14 d | D10 | 0.67 |
| | D50 | 1.57 |
| | D90 | 4.23 |
| −10/+40° C., | D10 | 0.65 |
| 14 d | D50 | 1.63 |
| | D90 | 5.02 |
| 54° C., 14 d | D10 | 0.76 |
| | D50 | 2.8 |
| | D90 | 7.91 |
| Ex. 30 | | |
| start | D10 | 0.60 |
| | D50 | 1.30 |
| | D90 | 2.72 |
| rt, 14 d | D10 | 0.57 |
| | D50 | 1.27 |
| | D90 | 2.74 |
| 54° C., 14 d | D10 | 0.77 |
| | D50 | 2.75 |
| | D90 | 9.14 |
| Ex. 31 | | |
| Start | D10 | 0.73 |
| | D50 | 1.80 |
| | D90 | 3.96 |
| rt, 14 d | D10 | 0.66 |
| | D50 | 1.58 |
| | D90 | 3.54 |
| 54° C., 14 d | D10 | 0.80 |
| | D50 | 2.94 |
| | D90 | 9.74 |
| Ex. 32 | | |
| start | D10 | 0.89 |
| | D50 | 2.02 |
| | D90 | 5.18 |
| rt, 14 d | D10 | 0.7 |
| | D50 | 1.82 |
| | D90 | 4.41 |
| 54° C., 14 d | D10 | 0.75 |
| | D50 | 2.74 |
| | D90 | 7.55 |
| Ex. 33 | | |
| start | D10 | 0.61 |
| | D50 | 1.35 |
| | D90 | 3.66 |
| rt, 14 d | D10 | 0.56 |
| | D50 | 1.31 |
| | D90 | 3.62 |
| 54° C., 14 d | D10 | 0.58 |
| | D50 | 1.28 |
| | D90 | 2.77 |
| Ex. 34 | | |
| start | D10 | 0.66 |
| | D50 | 1.46 |
| | D90 | 4.03 |
| rt, 14 d | D10 | 0.60 |
| | D50 | 1.36 |
| | D90 | 4.02 |
| 54° C., 14 d | D10 | 0.67 |
| | D50 | 2.04 |
| | D90 | 5.65 |
| Ex. 35 | | |
| start | D10 | 0.61 |
| | D50 | 1.36 |
| | D90 | 3.95 |
| rt, 14 d | D10 | 0.58 |
| | D50 | 1.33 |
| | D90 | 3.63 |
| 54° C., 14 d | D10 | 0.58 |
| | D50 | 1.29 |
| | D90 | 2.85 |
| Ex. 36 | | |
| start | D10 | 0.69 |
| | D50 | 1.63 |
| | D90 | 3.27 |
| rt, 14 d | D10 | 0.62 |
| | D50 | 1.38 |
| | D90 | 2.89 |
| Ex. 37 | | |
| start | D10 | 0.67 |
| | D50 | 1.81 |
| | D90 | 3.61 |
| rt, 14 d | D10 | 0.62 |
| | D50 | 1.4 |
| | D90 | 2.99 |
| Ex. 38 | | |
| start | D10 | 0.73 |
| | D50 | 1.82 |
| | D90 | 3.70 |
| rt, 14 d | D10 | 0.75 |
| | D50 | 2.3 |
| | D90 | 5.11 |
| Ex. 39 | | |
| Start | D10 | 0.65 |
| | D50 | 1.42 |
| | D90 | 3.03 |
| rt, 14 d | D10 | 0.61 |
| | D50 | 1.33 |
| | D90 | 3.01 |
| 54° C., 14 d | D10 | 0.72 |
| | D50 | 2.59 |
| | D90 | 6.79 |
| Ex. 40 | | |
| start | D10 | 0.61 |
| | D50 | 1.39 |
| | D90 | 3.00 |
| rt, 14 d | D10 | 0.60 |
| | D50 | 1.32 |
| | D90 | 2.93 |
| 54° C., 14 d | D10 | 0.77 |
| | D50 | 2.69 |
| | D90 | 6.72 |
| Ex. 41 | | |
| start | D10 | 0.61 |
| | D50 | 1.34 |
| | D90 | 2.90 |
| rt, 14 d | D10 | 0.59 |
| | D50 | 1.32 |
| | D90 | 2.94 |
| −10/+40° C., | D10 | 0.63 |
| 14 d | D50 | 1.62 |
| | D90 | 3.46 |
| Ex. 42 | | |
| start | D10 | 0.74 |
| | D50 | 1.84 |
| | D90 | 4.03 |
| rt, 14 d | D10 | 0.65 |
| | D50 | 1.6 |
| | D90 | 3.83 |
| 54° C., 14 d | D10 | 0.72 |
| | D50 | 2.54 |
| | D90 | 6.55 |
| Ex. 43 | | |
| start | D10 | 0.62 |
| | D50 | 1.41 |
| | D90 | 3.27 |
| rt, 14 d | D10 | 0.63 |
| | D50 | 1.42 |
| | D90 | 3.2 |
| 54° C., 14 d | D10 | 0.74 |
| | D50 | 2.67 |
| | D90 | 6.57 |
| Ex. 44 | | |
| start | D10 | 0.61 |
| | D50 | 1.32 |
| | D90 | 2.86 |
| rt, 14 d | D10 | 0.59 |
| | D50 | 1.4 |
| | D90 | 3.31 |
| −10/+40° C., | D10 | 0.61 |
| 14 d | D50 | 1.48 |
| | D90 | 3.16 |
| 54° C., 14 d | D10 | 0.75 |
| | D50 | 3.66 |
| | D90 | 10 |
| Ex. 45 | | |
| start | D10 | 0.62 |
| | D50 | 1.37 |
| | D90 | 2.93 |
| rt, 14 d | D10 | 0.61 |
| | D50 | 1.3 |
| | D90 | 2.83 |
| 54° C., 14 d | D10 | 0.73 |
| | D50 | 2.49 |
| | D90 | 5.97 |
| Ex. 46 | | |
| start | D10 | 0.63 |
| | D50 | 1.37 |
| | D90 | 2.79 |
| rt, 14 d | D10 | 0.65 |
| | D50 | 1.56 |
| | D90 | 3.24 |
| 54° C., 14 d | D10 | 0.75 |
| | D50 | 2.71 |
| | D90 | 6.93 |
| Ex. 49 | | |
| start | D10 | 0.65 |
| | D50 | 1.46 |
| | D90 | 3.13 |
| rt, 14 d | D10 | 0.66 |
| | D50 | 1.43 |
| | D90 | 3.11 |
| Ex. 51 | | |
| start | D10 | 0.62 |
| | D50 | 1.28 |
| | D90 | 2.74 |
| rt, 14 d | D10 | 0.63 |
| | D50 | 1.31 |
| | D90 | 2.79 |
| −10/+40° C., | D10 | 0.67 |
| 14 d | D50 | 1.77 |
| | D90 | 3.75 |
| 54° C., 14 d | D10 | 0.64 |
| | D50 | 1.44 |
| | D90 | 3.22 |
| Ex. 52 | | |
| start | D10 | 0.71 |
| | D50 | 1.56 |
| | D90 | 3.08 |
| rt, 14 d | D10 | 0.74 |
| | D50 | 1.61 |
| | D90 | 3.10 |
| −10/+40° C., | D10 | 0.72 |
| 14 d | D50 | 1.70 |
| | D90 | 3.80 |
| 54° C., 14 d | D10 | 0.66 |
| | D50 | 1.43 |
| | D90 | 3.00 |
| Ex. 53 | | |
| start | D10 | 0.65 |
| | D50 | 1.38 |
| | D90 | 3.07 |
| rt, 14 d | D10 | 0.64 |
| | D50 | 1.36 |
| | D90 | 3.07 |
| 54° C., 14 d | D10 | 0.64 |
| | D50 | 1.38 |
| | D90 | 2.94 |
| Ex. 54 | | |
| start | D10 | 0.68 |
| | D50 | 1.42 |
| | D90 | 3.12 |
| rt, 14 d | D10 | 0.66 |
| | D50 | 1.39 |
| | D90 | 3 |
| 54° C., 14 d | D10 | 0.66 |
| | D50 | 1.41 |
| | D90 | 2.96 |
| Ex. 55 | 5% w.s. | |
| | dispersant | |
| start | D10 | 0.69 |
| | D50 | 1.48 |
| | D90 | 3.47 |
| rt, 14 d | D10 | 0.66 |
| | D50 | 1.43 |
| | D90 | 3.26 |
| 54° C., 14 d | D10 | 0.65 |
| | D50 | 1.41 |
| | D90 | 2.99 |
| Ex. 56 | | |
| start | D10 | 0.70 |
| | D50 | 1.51 |
| | D90 | 3.29 |
| rt, 14 d | D10 | 0.69 |
| | D50 | 1.43 |
| | D90 | 3.12 |
| −10/+40° C., | D10 | 0.70 |
| 14 d | D50 | 1.63 |
| | D90 | 3.39 |
| 54° C., 14 d | D10 | 0.66 |
| | D50 | 1.40 |
| | D90 | 2.97 |
| Ex. 58 | | |
| start | D10 | 0.76 |
| | D50 | 1.94 |
| | D90 | 4.50 |
| rt, 14 d | D10 | 0.67 |
| | D50 | 1.45 |
| | D90 | 3.01 |
| −10/+40° C., | D10 | 0.73 |
| 14 d | D50 | 2.43 |
| | D90 | 5.78 |
| Ex. 59 | | |
| start | D10 | 0.75 |
| | D50 | 1.78 |
| | D90 | 3.74 |
| −10/+40° C., | D10 | 0.73 |
| 14 d | D50 | 2.49 |
| | D90 | 6.36 |
| Ex. 60 | | |
| start | D10 | 0.74 |
| | D50 | 1.60 |
| | D90 | 3.19 |
| rt, 14 d | D10 | 0.69 |
| | D50 | 1.45 |
| | D90 | 2.84 |
| −10/+40° C., | D10 | 0.69 |
| 14 d | D50 | 1.69 |
| | D90 | 4.38 |

rt: room temperature (ca. 23° C.)

TABLE
Particle Size Stability (Suspension
Concentrates with 40% w.s. Atrazine)

| | Particle Size | | Particle Size | |
|---|---|---|---|---|
| | Distribution [μm] | | Distribution [μm] | |
| Dispersant | 2.5% w.s. of Dispersant | | 5% w.s. of Dispersant | |
| Ex. 2 | | | | |
| start | | | D10 | 0.87 |
| | | | D50 | 1.89 |
| | | | D90 | 4.36 |
| rt, 14 d | | | D10 | 0.91 |
| | | | D50 | 1.98 |
| | | | D90 | 4.74 |
| −10/+40° C., 14 d | | | D10 | 0.90 |
| | | | D50 | 1.98 |
| | | | D90 | 4.57 |
| 54° C., 14 d | | | D10 | 0.93 |
| | | | D50 | 2.07 |
| | | | D90 | 4.92 |
| Ex. 9 | | | | |
| start | D10 | 1.02 | | |
| | D50 | 2.3 | | |
| | D90 | 5.32 | | |
| Ex. 18 | | | | |
| start | | | D10 | 0.94 |
| | | | D50 | 2.04 |
| | | | D90 | 4.61 |
| rt, 14 d | | | D10 | 0.93 |
| | | | D50 | 1.99 |
| | | | D90 | 4.58 |
| −10/+40° C., 14 d | | | D10 | 1 |
| | | | D50 | 2.21 |
| | | | D90 | 4.96 |
| 54° C., 14 d | | | D10 | 1.08 |
| | | | D50 | 2.36 |
| | | | D90 | 5.72 |

rt: room temperature (ca. 23° C.)

TABLE
Particle Size Stability (Suspension Concentrates
with 40% w.s. Chlorothalonil)

| | Particle Size | | Particle Size | |
|---|---|---|---|---|
| | Distribution [μm] | | Distribution [μm] | |
| Dispersant | 2.5% w.s. of Dispersant | | 5% w.s. of Dispersant | |
| Ex. 1 | | | | |
| start | D10 | 0.8 | D10 | 0.53 |
| | D50 | 1.7 | D50 | 1.39 |
| | D90 | 3.89 | D90 | 3.46 |
| rt, 14 d | D10 | 0.65 | | |
| | D50 | 1.63 | | |
| | D90 | 3.56 | | |
| −10/+40° C., 14 d | | | D10 | 0.52 |
| | | | D50 | 1.44 |
| | | | D90 | 3.45 |
| 54° C., 14 d | D10 | 0.56 | D10 | 0.65 |
| | D50 | 1.71 | D50 | 2.67 |
| | D90 | 4.95 | D90 | 8.17 |
| Ex. 3 | | | | |
| start | | | D10 | 0.65 |
| | | | D50 | 1.64 |
| | | | D90 | 4.47 |
| 54° C., 14 d | | | D10 | 0.55 |
| | | | D50 | 1.17 |
| | | | D90 | 2.31 |
| Ex. 4 | | | | |
| start | | | D10 | 0.53 |
| | | | D50 | 1.45 |
| | | | D90 | 3.92 |
| −10/+40° C., 14 d | | | D10 | 0.52 |
| | | | D50 | 1.4 |
| | | | D90 | 3.26 |
| 54° C., 14 d | | | D10 | 0.50 |
| | | | D50 | 1.69 |
| | | | D90 | 3.69 |
| Ex. 5 | | | | |
| start | | | D10 | 0.61 |
| | | | D50 | 1.51 |
| | | | D90 | 5.15 |
| rt, 14 d | | | D10 | 0.51 |
| | | | D50 | 1.21 |
| | | | D90 | 2.64 |
| Ex. 6 | | | | |
| start | | | D10 | 0.78 |
| | | | D50 | 2.15 |
| | | | D90 | 6.69 |
| rt, 14 d | | | D10 | 0.71 |
| | | | D50 | 2.05 |
| | | | D90 | 5.92 |
| 54° C., 14 d | | | D10 | 0.71 |
| | | | D50 | 2.21 |
| | | | D90 | 5.85 |
| Ex. 7 | | | | |
| start | | | D10 | 0.53 |
| | | | D50 | 1.40 |
| | | | D90 | 3.62 |
| −10/+40° C., 14 d | | | D10 | 0.50 |
| | | | D50 | 1.2 |
| | | | D90 | 2.55 |
| 54° C., 14 d | | | D10 | 0.6 |
| | | | D50 | 2.2 |
| | | | D90 | 5.85 |
| Ex. 10 | | | | |
| start | | | D10 | 0.61 |
| | | | D50 | 1.70 |
| | | | D90 | 4.75 |
| 54° C., 14 d | | | D10 | 0.54 |
| | | | D50 | 1.19 |
| | | | D90 | 2.39 |
| Ex. 13 | | | | |
| start | D10 | 0.62 | | |
| | D50 | 1.64 | | |
| | D90 | 4.92 | | |
| −10/+40° C., 14 d | D10 | 0.59 | | |
| | D50 | 1.28 | | |
| | D90 | 2.54 | | |
| 54° C., 14 d | D10 | 0.64 | | |
| | D50 | 2.41 | | |
| | D90 | 5.99 | | |
| Ex. 14 | | | | |
| start | D10 | 0.71 | | |
| | D50 | 1.79 | | |
| | D90 | 5.28 | | |
| 54° C., 14 d | D10 | 0.65 | | |
| | D50 | 2.54 | | |
| | D90 | 5.97 | | |
| Ex. 15 | | | | |
| start | D10 | 0.69 | | |
| | D50 | 1.96 | | |
| | D90 | 5.01 | | |
| 54° C., 14 d | D10 | 0.54 | | |
| | D50 | 1.18 | | |
| | D90 | 2.47 | | |
| Ex. 16 | | | | |
| start | | | D10 | 0.67 |
| | | | D50 | 1.74 |
| | | | D90 | 5.84 |
| 54° C., 14 d | | | D10 | 0.48 |
| | | | D50 | 1.07 |
| | | | D90 | 2.49 |
| Ex. 17 | | | | |
| start | D10 | 0.70 | | |
| | D50 | 1.68 | | |
| | D90 | 4.41 | | |
| 54° C., 14 d | D10 | 0.63 | | |
| | D50 | 2.36 | | |
| | D90 | 6.45 | | |

rt: room temperature (ca. 23° C.)

TABLE
Particle Size Stability (Suspension Concentrates
with 40% w.s. Fluxapyroxad)

| | |
|---|---|
| | Particle Size Distribution [μm] |
| Dispersant | 5% w.s. of Dispersant |

| | | |
|---|---|---|
| Ex. 1 | | |
| start | D10 | 0.77 |
| | D50 | 1.88 |
| | D90 | 4.28 |
| 54° C., 14 d | D10 | 0.9 |
| | D50 | 2.5 |
| | D90 | 6.09 |
| Ex. 2 | | |
| start | D10 | 0.73 |
| | D50 | 2.01 |
| | D90 | 4.93 |
| rt, 14 d | D10 | 0.79 |
| | D50 | 2.21 |
| | D90 | 5.64 |
| −10/+40° C., 14 d | D10 | 0.85 |
| | D50 | 2.42 |
| | D90 | 6.15 |
| Ex. 17 | | |
| start | D10 | 0.66 |
| | D50 | 1.65 |
| | D90 | 3.96 |
| −10/+40° C., 14 d | D10 | 0.84 |
| | D50 | 2.22 |
| | D90 | 6.94 |
| 54° C., 14 d | D10 | 0.87 |
| | D50 | 2.46 |
| | D90 | 6.77 |

rt: room temperature (ca. 23° C.)

TABLE
Particle Size Stability (Suspension Concentrates
with 40% w.s. Terbuthylazine)

| | |
|---|---|
| | Particle Size Distribution [μm] |
| Dispersant | 5% w.s. of Dispersant |

| | | |
|---|---|---|
| Ex. 15 | | |
| start | D10 | 0.78 |
| | D50 | 1.75 |
| | D90 | 4.02 |
| rt, 14 d | D10 | 0.87 |
| | D50 | 1.94 |
| | D90 | 4.46 |
| 54° C., 14 d | D10 | 0.89 |
| | D50 | 2.00 |
| | D90 | 4.56 |
| Ex. 36 | | |
| start | D10 | 0.89 |
| | D50 | 2.03 |
| | D90 | 4.41 |
| Ex. 37 | | |
| start | D10 | 0.9 |
| | D50 | 2.08 |
| | D90 | 4.5 |
| Ex. 41 | | |
| start | D10 | 0.73 |
| | D50 | 1.59 |
| | D90 | 3.41 |
| −10/+40° C., 14 d | D10 | 0.89 |
| | D50 | 2.21 |
| | D90 | 4.85 |
| 54° C., 14 d | D10 | 0.92 |
| | D50 | 2.15 |
| | D90 | 4.82 |
| Ex. 43 | | |
| start | D10 | 0.78 |
| | D50 | 1.70 |
| | D90 | 3.61 |
| rt, 14 d | D10 | 0.86 |
| | D50 | 1.84 |
| | D90 | 3.88 |
| −10/+40° C., 14 d | D10 | 0.88 |
| | D50 | 1.9 |
| | D90 | 3.98 |
| 54° C., 14 d | D10 | 0.98 |
| | D50 | 3 |
| | D90 | 7.82 |
| Ex. 44 | | |
| start | D10 | 0.69 |
| | D50 | 1.51 |
| | D90 | 3.38 |
| rt, 14 d | D10 | 0.78 |
| | D50 | 1.69 |
| | D90 | 3.78 |
| 54° C., 14 d | D10 | 0.91 |
| | D50 | 2.2 |
| | D90 | 5.14 |
| Ex. 45 | | |
| start | D10 | 0.76 |
| | D50 | 1.63 |
| | D90 | 3.46 |
| rt, 14 d | D10 | 0.81 |
| | D50 | 1.75 |
| | D90 | 3.69 |
| 54° C., 14 d | D10 | 0.94 |
| | D50 | 2.82 |
| | D90 | 6.87 |

rt: room temperature (ca. 23° C.)

TABLE
Particle Size Stability (Suspension Concentrates
with 40% w.s. Diflufenican)

| | |
|---|---|
| | Particle Size Distribution [μm] |
| Dispersant | 5% w.s. of Dispersant |

| | | |
|---|---|---|
| Ex. 27 | | |
| start | D10 | 0.71 |
| | D50 | 1.52 |
| | D90 | 4.19 |
| rt, 14 d | D10 | 0.66 |
| | D50 | 1.45 |
| | D90 | 4.00 |
| −10/+40° C., 14 d | D10 | 0.67 |
| | D50 | 1.58 |
| | D90 | 3.68 |
| 54° C., 14 d | D10 | 0.65 |
| | D50 | 1.39 |
| | D90 | 2.96 |
| Ex. 41 | | |
| start | D10 | 0.68 |
| | D50 | 1.69 |
| | D90 | 3.95 |
| −10/+40° C., 14 d | D10 | 0.75 |
| | D50 | 2.11 |
| | D90 | 4.96 |
| Ex. 43 | | |
| start | D10 | 0.73 |
| | D50 | 1.83 |
| | D90 | 4.33 |
| rt, 14 d | D10 | 0.72 |
| | D50 | 1.92 |
| | D90 | 4.38 |
| −10/+40° C., 14 d | D10 | 0.77 |
| | D50 | 2.24 |
| | D90 | 5.19 |
| 54° C., 14 d | D10 | 0.89 |
| | D50 | 2.94 |
| | D90 | 6.67 |
| Ex. 45 | | |
| start | D10 | 0.70 |
| | D50 | 1.74 |
| | D90 | 3.96 |
| rt, 14 d | D10 | 0.70 |
| | D50 | 1.89 |
| | D90 | 4.27 |
| −10/+40° C., 14 d | D10 | 0.79 |
| | D50 | 2.29 |
| | D90 | 5.64 |
| 54° C., 14 d | D10 | 0.88 |
| | D50 | 2.89 |
| | D90 | 6.81 |
| Ex. 46 | | |
| start | D10 | 0.70 |
| | D50 | 1.72 |
| | D90 | 3.94 |
| rt, 14 d | D10 | 0.70 |
| | D50 | 1.86 |
| | D90 | 4.18 |
| −10/+40° C., 14 d | D10 | 0.78 |
| | D50 | 2.29 |
| | D90 | 5.75 |
| 54° C., 14 d | D10 | 0.87 |
| | D50 | 2.94 |
| | D90 | 7.02 |

rt: room temperature (ca. 23° C.)

TABLE
Suspensibility and Blooming (Suspension
Concentrates, 40% w.s. Azoxystrobin)

| | |
|---|---|
| 2.5% w.s. | 5% w.s. |
| of Dispersant | of Dispersant |

Ex. 1

| | | |
|---|---|---|
| start | | |
| Blooming | g2 | 1 |
| Suspensibility after 30 min [%] | 95.5 | 95.3 |
| rt, 14 d | | |
| Blooming | 2.5 | 1 |
| Suspensibility after 30 min [%] | 94.9 | 94.8 |
| −10/+40° C., 14 d | | |
| Blooming | 3 | 2 |
| Suspensibility after 30 min [%] | 87.1 | 88.5 |
| 54° C., 14 d | | |
| Blooming | 2.3 | 2 |
| Suspensibility after 30 min [%] | 93.7 | 88.4 |

Ex. 2

| | | |
|---|---|---|
| start | | |
| Blooming | 1 | 1 |
| Suspensibility after 30 min [%] | 94.3 | 94.5 |
| rt, 14 d | | |
| Blooming | 1 | 1 |
| Suspensibility after 30 min [%] | 94.9 | 95.0 |
| −10/+40° C., 14 d | | |
| Blooming | 2 | 1 |
| Suspensibility after 30 min [%] | 82.5 | 94.8 |
| 54° C., 14 d | | |
| Blooming | 1 | 1 |
| Suspensibility after 30 min [%] | 94.3 | 94.6 |

Ex. 3

| | |
|---|---|
| start | |
| Blooming | 1 |
| Suspensibility after 30 min [%] | 91.6 |
| rt, 14 d | |
| Blooming | 1 |
| Suspensibility after 30 min [%] | 92.4 |
| 54° C., 14 d | |
| Blooming | 1 |
| Suspensibility after 30 min [%] | 94.5 |

Ex. 4

| | |
|---|---|
| start | |
| Blooming | 2 |
| Suspensibility after 30 min [%] | 94.7 |
| rt, 14 d | |
| Blooming | 2.5 |
| Suspensibility after 30 min [%] | 94.6 |
| −10/+40° C., 14 d | |
| Blooming | 3 |
| Suspensibility after 30 min [%] | 94.2 |
| 54° C., 14 d | |
| Blooming | 3 |
| Suspensibility after 30 min [%] | 87.0 |

Ex. 5

| | |
|---|---|
| start | |
| Blooming | 1 |
| Suspensibility after 30 min [%] | 94.7 |
| −10/+40° C., 14 d | |
| Blooming | 2 |
| Suspensibility after 30 min [%] | 82.8 |

Ex. 6

| | |
|---|---|
| start | |
| Blooming | 1 |
| Suspensibility after 30 min [%] | 95.3 |
| rt, 14 d | |
| Blooming | 2 |
| Suspensibility after 30 min [%] | 95.3 |
| −10/+40° C., 14 d | |
| Blooming | 1 |
| Suspensibility after 30 min [%] | 95.1 |

Ex. 7

| | |
|---|---|
| start | |
| Blooming | 1 |
| Suspensibility after 30 min [%] | 94.5 |
| rt, 14 d | |
| Blooming | 2 |
| Suspensibility after 30 min [%] | 95.0 |
| −10/+40° C., 14 d | |
| Blooming | 2 |
| Suspensibility after 30 min [%] | 85.9 |
| 54° C., 14 d | |
| Blooming | 2 |
| Suspensibility after 30 min [%] | 84.0 |

Ex. 8

| | |
|---|---|
| start | |
| Blooming | 1 |
| Suspensibility after 30 min [%] | 93.5 |
| rt, 14 d | |
| Blooming | 2 |
| Suspensibility after 30 min [%] | 94.6 |
| −10/+40° C., 14 d | |
| Blooming | 2 |
| Suspensibility after 30 min [%] | 94.9 |

Ex. 9

| | |
|---|---|
| start | |
| Blooming | 1 |
| Suspensibility after 30 min [%] | 94.6 |
| rt, 14 d | |
| Blooming | 1 |
| Suspensibility after 30 min [%] | 94.9 |
| 54° C., 14 d | |
| Blooming | 1 |
| Suspensibility after 30 min [%] | 94.9 |

Ex. 10

| | | |
|---|---|---|
| start | | |
| Blooming | 2 | 2 |
| Suspensibility after 30 min [%] | 89.2 | 94.3 |
| rt, 14 d | | |
| Blooming | 2 | 2 |
| Suspensibility after 30 min [%] | 90.3 | 94.3 |
| 54° C., 14 d | | |
| Blooming | 2 | 2 |
| Suspensibility after 30 min [%] | 90.7 | 93.7 |

Ex. 11

| | |
|---|---|
| start | |
| Blooming | 4 |
| Suspensibility after 30 min [%] | 93.2 |
| rt, 14 d | |
| Blooming | 2.5 |
| Suspensibility after 30 min [%] | 95.1 |
| −10/+40° C., 14 d | |
| Blooming | 2.5 |
| Suspensibility after 30 min [%] | 95.1 |
| 54° C., 14 d | |
| Blooming | 2.5 |
| Suspensibility after 30 min [%] | 95.1 |

Ex. 12

| | |
|---|---|
| start | |
| Blooming | 3 |
| Suspensibility after 30 min [%] | 92.0 |
| rt, 14 d | |
| Blooming | 2.5 |
| Suspensibility after 30 min [%] | 94.6 |
| −10/+40° C., 14 d | |
| Blooming | 3 |
| Suspensibility after 30 min [%] | 94.6 |
| 54° C., 14 d | |
| Blooming | 2.5 |
| Suspensibility after 30 min [%] | 95.8 |

Ex. 13

| | |
|---|---|
| start | |
| Blooming | 2 |
| Suspensibility after 30 min [%] | 95.3 |
| rt, 14 d | |
| Blooming | 2 |
| Suspensibility after 30 min [%] | 95.4 |
| 54° C., 14 d | |
| Blooming | 3 |
| Suspensibility after 30 min [%] | 91.5 |

Ex. 14

| | |
|---|---|
| start | |
| Blooming | 3 |
| Suspensibility after 30 min [%] | 85.3 |
| rt, 14 d | |
| Blooming | 2.5 |
| Suspensibility after 30 min [%] | 93.3 |
| 54° C., 14 d | |
| Blooming | 3.5 |
| Suspensibility after 30 min [%] | 85.8 |

Ex. 15

| | |
|---|---|
| start | |
| Blooming | 2 |
| Suspensibility after 30 min [%] | 95.9 |
| rt, 14 d | |
| Blooming | 2 |
| Suspensibility after 30 min [%] | 95.2 |
| 54° C., 14 d | |
| Blooming | 2 |
| Suspensibility after 30 min [%] | 95.2 |

Ex. 18

| | |
|---|---|
| start | |
| Blooming | 3 |
| Suspensibility after 30 min [%] | 94.9 |
| rt, 14 d | |
| Blooming | 2.5 |
| Suspensibility after 30 min [%] | 95.3 |
| 54° C., 14 d | |
| Blooming | 2.5 |
| Suspensibility after 30 min [%] | 92.0 |

Ex. 20

| | |
|---|---|
| start | 1 |
| Blooming | 1.5 |
| Suspensibility after 30 min [%] | 99.3 |

Ex. 24

| | |
|---|---|
| start | |
| Blooming | 2 |
| Suspensibility after 30 min [%] | 100.2 |
| rt, 14 d | |
| Blooming | 1.5 |
| Suspensibility after 30 min [%] | 98.6 |
| 54° C., 14 d | |
| Blooming | 2.5 |
| Suspensibility after 30 min [%] | 96.7 |

Ex. 25

| | |
|---|---|
| start | |
| Blooming | 2.5 |
| Suspensibility after 30 min [%] | 100.1 |
| rt, 14 d | |
| Blooming | 2 |
| Suspensibility after 30 min [%] | 97.3 |
| −10/+40° C., 14 d | |
| Blooming | 2.5 |
| Suspensibility after 30 min [%] | 98.4 |
| 54° C., 14 d | |
| Blooming | 2.5 |
| Suspensibility after 30 min [%] | 96.2 |

Ex. 26

| | |
|---|---|
| start | |
| Blooming | 2 |
| Suspensibility after 30 min [%] | 99.2 |
| rt, 14 d | |
| Blooming | 2 |
| Suspensibility after 30 min [%] | 99.2 |
| −10/+40° C., 14 d | |
| Blooming | 2 |
| Suspensibility after 30 min [%] | 99.3 |
| 54° C., 14 d | |
| Blooming | 2.5 |
| Suspensibility after 30 min [%] | 99.5 |

Ex. 27

| | |
|---|---|
| start | |
| Blooming | 1.5 |
| Suspensibility after 30 min [%] | 100.4 |
| rt, 14 d | |
| Blooming | 1.5 |
| Suspensibility after 30 min [%] | 102.7 |
| −10/+40° C., 14 d | |
| Blooming | 1.5 |
| Suspensibility after 30 min [%] | 101.5 |
| 54° C., 14 d | |
| Blooming | 1.5 |
| Suspensibility after 30 min [%] | 101.4 |

Ex. 28

| | |
|---|---|
| start | |
| Blooming | 2 |
| Suspensibility after 30 min [%] | 100.2 |
| rt, 14 d | |
| Blooming | |
| Suspensibility after 30 min [%] | -- |
| 54° C., 14 d | |
| Blooming | 2.5 |
| Suspensibility after 30 min [%] | 99.6 |

Ex. 29

| | |
|---|---|
| start | |
| Blooming | 2 |
| Suspensibility after 30 min [%] | 100.9 |
| rt, 14 d | |
| Blooming | 2 |
| Suspensibility after 30 min [%] | 100.0 |
| −10/+40° C., 14 d | |
| Blooming | 2.5 |
| Suspensibility after 30 min [%] | 90.6 |
| 54° C., 14 d | |
| Blooming | 2.5 |
| Suspensibility after 30 min [%] | 88.7 |

Ex. 30

| | |
|---|---|
| start | |
| Blooming | 2 |
| Suspensibility after 30 min [%] | 99.3 |
| rt, 14 d | |
| Blooming | 2 |
| Suspensibility after 30 min [%] | 100.2 |
| −10/+40° C., 14 d | |
| Blooming | 2.5 |
| Suspensibility after 30 min [%] | 89.8 |
| 54° C., 14 d | |
| Blooming | 2.5 |
| Suspensibility after 30 min [%] | 97.2 |

Ex. 31

| | |
|---|---|
| start | |
| Blooming | 2 |
| Suspensibility after 30 min [%] | 99.8 |
| rt, 14 d | |
| Blooming | 2.5 |
| Suspensibility after 30 min [%] | 99.4 |
| −10/+40° C., 14 d | |
| Blooming | 3 |
| Suspensibility after 30 min [%] | 85.4 |
| 54° C., 14 d | |
| Blooming | 2.5 |
| Suspensibility after 30 min [%] | 95.8 |

Ex. 32

| | |
|---|---|
| start | |
| Blooming | 2 |
| Suspensibility after 30 min [%] | 98.8 |
| rt, 14 d | |
| Blooming | 2 |
| Suspensibility after 30 min [%] | 99.4 |
| 54° C., 14 d | |
| Blooming | 3 |
| Suspensibility after 30 min [%] | 86.6 |

Ex. 33

| | |
|---|---|
| start | |
| Blooming | 2 |
| Suspensibility after 30 min [%] | 100.8 |
| rt, 14 d | |
| Blooming | 1.5 |
| Suspensibility after 30 min [%] | 100.1 |
| 54° C., 14 d | |
| Blooming | 2 |
| Suspensibility after 30 min [%] | 100.3 |

Ex. 34

| | |
|---|---|
| start | |
| Blooming | 2 |
| Suspensibility after 30 min [%] | 100.2 |
| rt, 14 d | |
| Blooming | 1.5 |
| Suspensibility after 30 min [%] | 99.4 |
| 54° C., 14 d | |
| Blooming | 2 |
| Suspensibility after 30 min [%] | 95.7 |

Ex. 35

| | |
|---|---|
| start | |
| Blooming | 2 |
| Suspensibility after 30 min [%] | 100.5 |
| rt, 14 d | |
| Blooming | 1.5 |
| Suspensibility after 30 min [%] | 98.0 |
| 54° C., 14 d | |
| Blooming | 2 |
| Suspensibility after 30 min [%] | 100.8 |

Ex. 36

| | |
|---|---|
| start | |
| Blooming | 2 |
| Suspensibility after 30 min [%] | 99.5 |
| rt, 14 d | |
| Blooming | 2.5 |
| Suspensibility after 30 min [%] | 99.7 |
| −10/+40° C., 14 d | |
| Blooming | 3 |
| Suspensibility after 30 min [%] | 81.7 |
| 54° C., 14 d | |
| Blooming | 3 |
| Suspensibility after 30 min [%] | 94.5 |

Ex. 37

| | |
|---|---|
| start | |
| Blooming | 2 |
| Suspensibility after 30 min [%] | 99.7 |
| rt, 14 d | |
| Blooming | 2 |
| Suspensibility after 30 min [%] | 99.4 |
| −10/+40° C., 14 d | |
| Blooming | 3 |
| Suspensibility after 30 min [%] | 86.2 |
| 54° C., 14 d | |
| Blooming | 2 |
| Suspensibility after 30 min [%] | 99.1 |

Ex. 38

| | |
|---|---|
| start | |
| Blooming | 1.5 |
| Suspensibility after 30 min [%] | 101.6 |
| rt, 14 d | |
| Blooming | 2 |
| Suspensibility after 30 min [%] | 101.1 |
| 54° C., 14 d | |
| Blooming | 2.5 |
| Suspensibility after 30 min [%] | 97.1 |

Ex. 39

| | |
|---|---|
| start | |
| Blooming | 2 |
| Suspensibility after 30 min [%] | 101.4 |
| rt, 14 d | |
| Blooming | 2 |
| Suspensibility after 30 min [%] | 99.7 |
| −10/+40° C., 14 d | |
| Blooming | 2.5 |
| Suspensibility after 30 min [%] | 81.3 |
| 54° C., 14 d | |
| Blooming | 2 |
| Suspensibility after 30 min [%] | 98 |

Ex. 40

| | |
|---|---|
| start | |
| Blooming | 1.5 |
| Suspensibility after 30 min [%] | 102.2 |
| rt, 14 d | |
| Blooming | 1.5 |
| Suspensibility after 30 min [%] | 100.9 |
| −10/+40° C., 14 d | |
| Blooming | 2.5 |
| Suspensibility after 30 min [%] | 77.6 |
| 54° C., 14 d | |
| Blooming | 2.5 |
| Suspensibility after 30 min [%] | 98.8 |

Ex. 41

| | |
|---|---|
| start | |
| Blooming | 2 |
| Suspensibility after 30 min [%] | 99.5 |
| rt, 14 d | |
| Blooming | 1.5 |
| Suspensibility after 30 min [%] | 99.2 |
| −10/+40° C., 14 d | |
| Blooming | 2.5 |
| Suspensibility after 30 min [%] | 99.1 |

Ex. 42

| | |
|---|---|
| start | |
| Blooming | 2 |
| Suspensibility after 30 min [%] | 97.7 |
| rt, 14 d | |
| Blooming | 2.5 |
| Suspensibility after 30 min [%] | 98 |
| 54° C., 14 d | |
| Blooming | 2.5 |
| Suspensibility after 30 min [%] | 99.3 |

Ex. 43

| | |
|---|---|
| start | |
| Blooming | 2 |
| Suspensibility after 30 min [%] | 100.2 |
| rt, 14 d | |
| Blooming | 1.5 |
| Suspensibility after 30 min [%] | 99.2 |
| 54° C., 14 d | |
| Blooming | 3 |
| Suspensibility after 30 min [%] | 97.2 |

Ex. 44

| | |
|---|---|
| start | |
| Blooming | 1.5 |
| Suspensibility after 30 min [%] | 101.1 |
| rt, 14 d | |
| Blooming | 1.5 |
| Suspensibility after 30 min [%] | 101.0 |
| −10/+40° C., 14 d | |
| Blooming | 2 |
| Suspensibility after 30 min [%] | 100.4 |
| 54° C., 14 d | |
| Blooming | 3 |
| Suspensibility after 30 min [%] | 97.8 |

Ex. 45

| | |
|---|---|
| start | |
| Blooming | 1 |
| Suspensibility after 30 min [%] | 101.5 |
| rt, 14 d | |
| Blooming | 2 |
| Suspensibility after 30 min [%] | 101.0 |
| 54° C., 14 d | |
| Blooming | 2.5 |
| Suspensibility after 30 min [%] | 99.8 |

Ex. 46

| | |
|---|---|
| start | |
| Blooming | 1.5 |
| Suspensibility after 30 min [%] | 102.1 |
| rt, 14 d | |
| Blooming | 2 |
| Suspensibility after 30 min [%] | 101.6 |
| 54° C., 14 d | |
| Blooming | 2.5 |
| Suspensibility after 30 min [%] | 98.6 |

Ex. 51

| | |
|---|---|
| start | |
| Blooming | 2 |
| Suspensibility after 30 min [%] | 100.0 |
| rt, 14 d | |
| Blooming | n.d. |
| Suspensibility after 30 min [%] | n.d. |
| −10/+40° C., 14 d | |
| Blooming | n.d. |
| Suspensibility after 30 min [%] | n.d. |
| 54° C., 14 d | |
| Blooming | n.d. |
| Suspensibility after 30 min [%] | n.d. |

Ex. 52

| | |
|---|---|
| start | |
| Blooming | 2.5 |
| Suspensibility after 30 min [%] | 99.4 |
| rt, 14 d | |
| Blooming | n.d. |
| Suspensibility after 30 min [%] | n.d. |
| −10/+40° C., 14 d | |
| Blooming | n.d. |
| Suspensibility after 30 min [%] | n.d. |
| 54° C., 14 d | |
| Blooming | n.d. |
| Suspensibility after 30 min [%] | n.d. |

Ex. 53

| | |
|---|---|
| start | |
| Blooming | 1.5 |
| Suspensibility after 30 min [%] | 101.5 |
| rt, 14 d | |
| Blooming | 1.5 |
| Suspensibility after 30 min [%] | 100.7 |
| 54° C., 14 d | |
| Blooming | 2 |
| Suspensibility after 30 min [%] | 100.6 |

Ex. 54

| | |
|---|---|
| start | |
| Blooming | 1.5 |
| Suspensibility after 30 min [%] | 101.4 |
| rt, 14 d | |
| Blooming | 1.5 |
| Suspensibility after 30 min [%] | 100.5 |
| 54° C., 14 d | |
| Blooming | 2 |
| Suspensibility after 30 min [%] | 100.8 |

Ex. 55

| | |
|---|---|
| start | |
| Blooming | 1.5 |
| Suspensibility after 30 min [%] | 101.4 |
| rt, 14 d | |
| Blooming | 1.5 |
| Suspensibility after 30 min [%] | 101.4 |
| 54° C., 14 d | |
| Blooming | 2 |
| Suspensibility after 30 min [%] | 101.3 |

Ex. 56

| | |
|---|---|
| start | |
| Blooming | 1.5 |
| Suspensibility after 30 min [%] | 98.5 |
| rt, 14 d | |
| Blooming | 2 |
| Suspensibility after 30 min [%] | 97.9 |
| −10/+40° C., 14 d | |
| Blooming | 3 |
| Suspensibility after 30 min [%] | 99.4 |
| 54° C., 14 d | |
| Blooming | 1.5 |
| Suspensibility after 30 min [%] | 98.1 |

Ex. 58

| | |
|---|---|
| start | |
| Blooming | 2 |
| Suspensibility after 30 min [%] | 100.1 |
| rt, 14 d | |
| Blooming | 1.5 |
| Suspensibility after 30 min [%] | 99.8 |
| −10/+40° C., 14 d | |
| Blooming | 2.5 |
| Suspensibility after 30 min [%] | 100.7 |
| 54° C., 14 d | |
| Blooming | 2.5 |
| Suspensibility after 30 min [%] | 97.2 |

Ex. 59

| | |
|---|---|
| start | |
| Blooming | 2 |
| Suspensibility after 30 min [%] | 100.3 |
| −10/+40° C., 14 d | |
| Blooming | 2 |
| Suspensibility after 30 min [%] | 101.3 |
| 54° C., 14 d | |
| Blooming | 2 |
| Suspensibility after 30 min [%] | 100.2 |

Ex. 60

| | |
|---|---|
| start | |
| Blooming | 2 |
| Suspensibility after 30 min [%] | 101.1 |
| rt, 14 d | |
| Blooming | 1.5 |
| Suspensibility after 30 min [%] | 100.2 |
| −10/+40° C., 14 d | |
| Blooming | 2 |
| Suspensibility after 30 min [%] | 90.8 |
| 54° C., 14 d | |
| Blooming | 2.5 |
| Suspensibility after 30 min [%] | 99.6 |

rt: room temperature (ca. 23° C.)

TABLE
Suspensibility and Blooming (Suspension
Concentrates, 40% w.s. Atrazine)

| | |
|---|---|
| 2.5% w.s. of | 5% w.s. of |
| Dispersant | Dispersant |

Ex. 2

| | |
|---|---|
| start | |
| Blooming | 1 |
| Suspensibility after 30 min [%] | 94.8 |
| rt, 14 d | |
| Blooming | 2 |
| Suspensibility after 30 min [%] | 94.8 |
| −10/+40° C., 14 d | |
| Blooming | 1 |
| Suspensibility after 30 min [%] | 95.0 |
| 54° C., 14 d | |
| Blooming | 1 |
| Suspensibility after 30 min [%] | 95.3 |

Ex. 9

| | |
|---|---|
| start | |
| Blooming | 1 |
| Suspensibility after 30 min [%] | 95.2 |
| −10/+40° C., 14 d | |
| Blooming | 2 |
| Suspensibility after 30 min [%] | 80.6 |
| 54° C., 14 d | |
| Blooming | 2 |
| Suspensibility after 30 min [%] | 94.9 |

Ex. 18

| | |
|---|---|
| start | |
| Blooming | 3 |
| Suspensibility after 30 min [%] | 91.7 |
| rt, 14 d | |
| Blooming | 2.5 |
| Suspensibility after 30 min [%] | 95.5 |
| −10/+40° C., 14 d | |
| Blooming | 2.5 |
| Suspensibility after 30 min [%] | 95 |
| 54° C., 14 d | |
| Blooming | 3 |
| Suspensibility after 30 min [%] | 94.9 |

rt: room temperature (ca. 23° C.)

TABLE
Suspensibility and Blooming (Suspension
Concentrates, 40% w.s. Chlorothalonil)

| | |
|---|---|
| 2.5% w.s. of | 5% w.s. of |
| Dispersant | Dispersant |

Ex. 1

| | | |
|---|---|---|
| start | | |
| Blooming | 2 | 2 |
| Suspensibility after 30 min [%] | 95.2 | 94.7 |
| rt, 14 d | | |
| Blooming | 2.5 | |
| Suspensibility after 30 min [%] | 93.3 | |
| −10/+40° C., 14 d | | |
| Blooming | 3 | 2 |
| Suspensibility after 30 min [%] | 88.5 | 94.8 |
| 54° C., 14 d | | |
| Blooming | 3 | 2 |
| Suspensibility after 30 min [%] | 95.0 | 93.9 |

Ex. 3

| | |
|---|---|
| Start | |
| Blooming | 1 |
| Suspensibility after 30 min [%] | 95.4 |
| 54° C., 14 d | |
| Blooming | 2 |
| Suspensibility after 30 min [%] | 96.3 |

Ex. 4

| | |
|---|---|
| start | |
| Blooming | 2 |
| Suspensibility after 30 min [%] | 95.0 |
| −10/+40° C., 14 d | |
| Blooming | 2 |
| Suspensibility after 30 min [%] | 95.2 |
| 54° C., 14 d | |
| Blooming | 2 |
| Suspensibility after 30 min [%] | 95.6 |

Ex. 5

| | |
|---|---|
| start | |
| Blooming | 1 |
| Suspensibility after 30 min [%] | 94.6 |
| rt, 14 d | |
| Blooming | 2 |
| Suspensibility after 30 min [%] | 95.0 |
| −10/+40° C., 14 d | |
| Blooming | 2 |
| Suspensibility after 30 min [%] | 91.5 |

Ex. 6

| | |
|---|---|
| start | |
| Blooming | 1 |
| Suspensibility after 30 min [%] | 93.7 |
| rt, 14 d | |
| Blooming | 2 |
| Suspensibility after 30 min [%] | 94.0 |
| 54° C., 14 d | |
| Blooming | 2 |
| Suspensibility after 30 min [%] | 95.6 |

Ex. 7

| | |
|---|---|
| start | |
| Blooming | 1 |
| Suspensibility after 30 min [%] | 94.5 |
| −10/+40° C., 14 d | |
| Blooming | 2 |
| Suspensibility after 30 min [%] | 95.4 |
| 54° C., 14 d | |
| Blooming | 2 |
| Suspensibility after 30 min [%] | 95.2 |

Ex. 10

| | |
|---|---|
| start | |
| Blooming | 2 |
| Suspensibility after 30 min [%] | 94.1 |
| 54° C., 14 d | |
| Blooming | 2 |
| Suspensibility after 30 min [%] | 95.9 |

Ex. 13

| | |
|---|---|
| start | |
| Blooming | 2 |
| Suspensibility after 30 min [%] | 95.4 |
| −10/+40° C., 14 d | |
| Blooming | 2.5 |
| Suspensibility after 30 min [%] | 96.4 |
| 54° C., 14 d | |
| Blooming | 2.5 |
| Suspensibility after 30 min [%] | 94.5 |

Ex. 14

| | |
|---|---|
| start | |
| Blooming | 2 |
| Suspensibility after 30 min [%] | 96.5 |
| −10/+40° C., 14 d | |
| Blooming | 3 |
| Suspensibility after 30 min [%] | 83.0 |
| 54° C., 14 d | |
| Blooming | 2 |
| Suspensibility after 30 min [%] | 96.4 |

Ex. 15

| | |
|---|---|
| start | |
| Blooming | 2 |
| Suspensibility after 30 min [%] | 96.8 |
| 54° C., 14 d | |
| Blooming | 2.5 |
| Suspensibility after 30 min [%] | 98.8 |

Ex. 16

| | |
|---|---|
| start | |
| Blooming | 3 |
| Suspensibility after 30 min [%] | 93.3 |
| −10/+40° C., 14 d | |
| Blooming | 3 |
| Suspensibility after 30 min [%] | 86.4 |
| 54° C., 14 d | |
| Blooming | 2.5 |
| Suspensibility after 30 min [%] | 97.7 |

Ex. 17

| | |
|---|---|
| start | |
| Blooming | 2 |
| Suspensibility after 30 min [%] | 94.5 |
| −10/+40° C., 14 d | |
| Blooming | 3 |
| Suspensibility after 30 min [%] | 81.6 |
| 54° C., 14 d | |
| Blooming | 3 |
| Suspensibility after 30 min [%] | 95.8 |

rt: room temperature (ca. 23° C.)

TABLE
Suspensibility and Blooming (Suspension
Concentrates, 40% w.s. Fluxapyroxad)

5% w.s. of Dispersant

Ex. 1

| | |
|---|---|
| start | |
| Blooming | 2 |
| Suspensibility after 30 min [%] | 94.7 |
| −10/+40° C., 14 d | |
| Blooming | 3.5 |
| Suspensibility after 30 min [%] | 84.3 |
| 54° C., 14 d | |
| Blooming | 3.5 |
| Suspensibility after 30 min [%] | 92.6 |

Ex. 2

| | |
|---|---|
| start | |
| Blooming | 2 |
| Suspensibility after 30 min [%] | 94.9 |
| rt, 14 d | |
| Blooming | 2.5 |
| Suspensibility after 30 min [%] | 95.6 |
| −10/+40° C., 14 d | |
| Blooming | 2.5 |
| Suspensibility after 30 min [%] | 94.3 |

rt: room temperature (ca. 23° C.)

TABLE
Suspensibility and Blooming (Suspension
Concentrates, 40% w.s. Terbuthylazine)

5% w.s. of Dispersant

Ex. 15

| | |
|---|---|
| start | |
| Blooming | 1.5 |
| Suspensibility after 30 min [%] | 99.5 |
| rt, 14 d | |
| Blooming | 1 |
| Suspensibility after 30 min [%] | 100.1 |
| 54° C., 14 d | |
| Blooming | 2 |
| Suspensibility after 30 min [%] | 98.5 |

Ex. 36

| | |
|---|---|
| start | |
| Blooming | 1.5 |
| Suspensibility after 30 min [%] | 103.2 |
| −10/+40° C., 14 d | |
| Blooming | 2.5 |
| Suspensibility after 30 min [%] | 75.4 |
| 54° C., 14 d | |
| Blooming | 2.5 |
| Suspensibility after 30 min [%] | 94.8 |

Ex. 37

| | |
|---|---|
| start | |
| Blooming | 2 |
| Suspensibility after 30 min [%] | 101.8 |
| 54° C., 14 d | |
| Blooming | 2.5 |
| Suspensibility after 30 min [%] | 95.4 |

Ex. 41

| | |
|---|---|
| start | |
| Blooming | 1 |
| Suspensibility after 30 min [%] | 100.6 |
| −10/+40° C., 14 d | |
| Blooming | 3 |
| Suspensibility after 30 min [%] | 97.6 |
| 54° C., 14 d | |
| Blooming | 2.5 |
| Suspensibility after 30 min [%] | 99.2 |

Ex. 43

| | |
|---|---|
| start | |
| Blooming | 1.5 |
| Suspensibility after 30 min [%] | 100.8 |
| rt, 14 d | |
| Blooming | 1 |
| Suspensibility after 30 min [%] | 100.5 |
| −10/+40° C., 14 d | |
| Blooming | 2.5 |
| Suspensibility after 30 min [%] | 100.3 |
| 54° C., 14 d | |
| Blooming | 2.5 |
| Suspensibility after 30 min [%] | 99.7 |

Ex. 44

| | |
|---|---|
| start | |
| Blooming | 2 |
| Suspensibility after 30 min [%] | 101.4 |
| rt, 14 d | |
| Blooming | 1 |
| Suspensibility after 30 min [%] | 102.2 |
| 54° C., 14 d | |
| Blooming | 2 |
| Suspensibility after 30 min [%] | 98.9 |

Ex. 45

| | |
|---|---|
| start | |
| Blooming | 1.5 |
| Suspensibility after 30 min [%] | 102.3 |
| rt, 14 d | |
| Blooming | 1 |
| Suspensibility after 30 min [%] | 101.2 |
| −10/+40° C., 14 d | |
| Blooming | 2.5 |
| Suspensibility after 30 min [%] | 74.4 |
| 54° C., 14 d | |
| Blooming | 2 |
| Suspensibility after 30 min [%] | 98.5 |

rt: room temperature (ca. 23° C.)

TABLE
Suspensibility and Blooming (Suspension
Concentrates, 40% w.s. Diflufenican)

5% w.s. of Dispersant

Ex. 27

| | |
|---|---|
| start | |
| Blooming | 1.5 |
| Suspensibility after 30 min [%] | 97.8 |
| rt, 14 d | |
| Blooming | 1.5 |
| Suspensibility after 30 min [%] | 98.1 |
| −10/+40° C., 14 d | |
| Blooming | 2 |
| Suspensibility after 30 min [%] | 98.1 |
| 54° C., 14 d | |
| Blooming | 2 |
| Suspensibility after 30 min [%] | 97.9 |

Ex. 41

| | |
|---|---|
| start | |
| Blooming | 1 |
| Suspensibility after 30 min [%] | 100.6 |
| −10/+40° C., 14 d | |
| Blooming | 2 |
| Suspensibility after 30 min [%] | 100.4 |

Ex. 43

| | |
|---|---|
| start | |
| Blooming | 1 |
| Suspensibility after 30 min [%] | 99.6 |
| rt, 14 d | |
| Blooming | 1 |
| Suspensibility after 30 min [%] | 98.4 |
| −10/+40° C., 14 d | |
| Blooming | 2 |
| Suspensibility after 30 min [%] | 97.2 |
| 54° C., 14 d | |
| Blooming | 1.5 |
| Suspensibility after 30 min [%] | 97.1 |

Ex. 45

| | |
|---|---|
| start | |
| Blooming | 1 |
| Suspensibility after 30 min [%] | 98.2 |
| rt, 14 d | |
| Blooming | 1 |
| Suspensibility after 30 min [%] | 97.5 |
| −10/+40° C., 14 d | |
| Blooming | 2.5 |
| Suspensibility after 30 min [%] | 76.6 |
| 54° C., 14 d | |
| Blooming | 1.5 |
| Suspensibility after 30 min [%] | 97.3 |

Ex. 46

| | |
|---|---|
| start | |
| Blooming | 1 |
| Suspensibility after 30 min [%] | 98.4 |
| rt, 14 d | |
| Blooming | 1.5 |
| Suspensibility after 30 min [%] | 98.2 |
| −10/+40° C., 14 d | |
| Blooming | 2 |
| Suspensibility after 30 min [%] | 81.5 |
| 54° C., 14 d | |
| Blooming | 1.5 |
| Suspensibility after 30 min [%] | 97.7 |

rt: room temperature (ca. 23° C.)

### Composition Examples—Suspension Concentrates with Co-Dispersant

### Preparation

Suspension concentrates were prepared by grinding 40% w.s. active ingredient, 2.5 or 5.0% w.s. dispersant, 2.5% w.s. co-dispersant Pluronic PE 6400 (PO-EO block polymer), 0.3% Agnique OEM 111 S (silicion emulsion defoamer) with fully demineralized water in a disperser “DAS 200”, Lau GmbH with glass balls (diameter: 2 or 3 mm) such that the dispersed pesticide particles reach a particle size distribution characterized by a 090 of ≤10 μm and a 050 of ≤3 μm. Particles analysis was carried out according to method (I). Storage stability was assessed as described in method (II). Blooming and suspensibility was determined according to method (III) and (IV). Methods (I) to (IV) are described in detail above. The specific components and experimental results are shown in the tables below.

TABLE
Particle Size Stability (Suspension Concentrates with
40% w.s. Azoxystrobin and 2.5% w.s. Pluronic PE 6400)

| | |
|---|---|
| 2.5% w.s. of | 5% w.s. of |
| Dispersant | Dispersant |

| | | | | |
|---|---|---|---|---|
| Ex. 8 | | | | |
| start | D50 | 1.43 | | |
| | D90 | 3.15 | | |
| rt, 14 d | D50 | 1.41 | | |
| | D90 | 3.08 | | |
| 54° C., 14 d | D50 | 1.44 | | |
| | D90 | 3.10 | | |
| Ex. 11 | | | | |
| start | D50 | 1.72 | | |
| | D90 | 3.51 | | |
| rt, 14 d | D50 | 1.75 | | |
| | D90 | 3.60 | | |
| 54° C., 14 d | D50 | 1.61 | | |
| | D90 | 3.50 | | |
| Ex. 12 | | | | |
| start | | | D50 | 2.53 |
| | | | D90 | 5.25 |
| rt, 14 d | | | D50 | 2.17 |
| | | | D90 | 4.56 |
| −10/+40° C., 14 d | | | D50 | 2.15 |
| | | | D90 | 4.21 |
| 54° C., 14 d | | | D50 | 2.82 |
| | | | D90 | 6.69 |

rt: room temperature (ca. 23° C.)

TABLE
Suspensibility/Blooming (Suspension Concentrates with
40% w.s. Azoxystrobin and 2.5% w.s. Pluronic PE 6400)

| | 2.5% w.s. of | 5% w.s. of |
|---|---|---|
| | Dispersant | Dispersant |
| Ex. 8 | | |
| start | | |
| Blooming | 1.5 | |
| Suspensibility after 30 min [%] | 98.8 | |
| Ex. 11 | | |
| start | | |
| Blooming | 1.5 | |
| Suspensibility after 30 min [%] | 94.4 | |
| Ex. 12 | | |
| start | | |
| Blooming | | 2.0 |
| Suspensibility after 30 min [%] | | 98.4 |
| rt, 14 d | | |
| Blooming | | 1.5 |
| Suspensibility after 30 min [%] | | 98.8 |
| −10/+40° C., 14 d | | |
| Blooming | | 1.5 |
| Suspensibility after 30 min [%] | | 94.9 |
| 54° C., 14 d | | |
| Blooming | | 3.0 |
| Suspensibility after 30 min [%] | | 98.4 |

rt: room temperature (ca. 23° C.)

### Composition Examples—Dispersible Concentrate (DC)

In a stirred beaker, the following substances were added sequentially at room temperature (about 23° C.): 500 g polar, water miscible solvent as indicated below, 40 g mefentrifluconazole, 32 g metyltetraprole, 100 g alcohol alkoxylate wetting agent (adjuvant A), 197 g of polymer Ex. 1 and 50 g castor oil ethoxylate emulsifier (surfactant A). The mixture was stirred until all active ingredient was dissolved and a homogenous, crystal free solution was obtained. This was transferred to a measure cylinder and filled up to 1 L with the polar, water miscible solvent. The final solution was poured over a 150 μm sieve into storage bottles to obtain the dispersible concentrate (DC). The specific components and experimental results are shown in the tables below.

### Dilution Test

0.625 g of the DC obtained above was pipetted into 99 g of CIPAC D water. After the completed addition, the tapered cylinder was stoppered and inverted 30 times for homogenization. The optical appearance was assessed immediately, as well as after standing for 24 h.

### Application Test

To determine the ease of handling and application of the compositions, the obtained compositions were diluted with CIPAC D water to obtain emulsions containing 0.625 wt.-% of the composition in water having a temperature of 10° C. Two liters of the diluted emulsion so obtained were continuously pumped through a cascade of one 300 μm sieve and one 150 μm sieve at an initial flow rate that was set at 100 liters per hour.

The circulated spray liquid was in total 5 times replaced with fresh composition after 1, 2, 2.5 and 4 hours on the first day and upon start of the second day and after 1 hour on the second day. The applicability properties of the compositions were rated from “++” to “−−” based on the flow of the diluted emulsion through the sieves in the final filtration cycle and visual evaluation of the residue in the sieves. A rating of “−−” means that the sieves contained a high amount of residue and a slow flow of the diluted emulsion through the sieve, a rating of “++” means essentially unchanged flow of the diluted emulsion through the sieve and that almost no residue was collected in the sieves. For a handling rating of “+”, the flow at the end of the test had to be 90% or more of the initial flow rate (i.e. at least 90 L/h).
Polymer A: Example 1
Adjuvant A: Wettol LF 312 (alcohol alkoxylate)
Surfactant A: Wettol EM 31 (polyethoxylated caster oil, 31 EO units)
Solvent A: Solvesso 200 ND
Solvent B: Cyclohexanon
Solvent C: N-Butylpyrrolidon

TABLE
Components and Properties of Examples 1 and 2 (the
content of each component is provided in grams)

| | 1 | 2 | 3 |
|---|---|---|---|
| Metyltetraprole | 32 | 32 | 32 |
| Mefentrifluconazole | 40 | 40 | 40 |
| Adjuvant A | 100 | 100 | 100 |
| Surfactant A | 50 | 50 | 50 |
| Solvent A | 30 | 30 | 30 |
| Polymer of Ex. 1 | 197 | 197 | — |
| Solvent B | ad 1 Liter | — | ad 1 Liter |
| Solvent C | — | ad 1 Liter | — |
| Applicability | ++ | + | −− |
| Tapered cylinder test | Clear without | Clear without | Crystals |
| initial after 30 | any crystals | any crystals | visible |
| inversions | | | |
| Tapered cylinder test | Small amount of | Small amount of | Crystalline |
| after 24 h | oily separation, | oily separation, | sediment |
| | no crystals | no crystals | |

It is evident that the use of the graft polymer allows for the suppression of crystal formation in agrochemical compositions, and hence allows for high applicability.

### Composition Examples—Suspo-Emulsion (SE)

### Preparation

Suspensions concentrates were prepared by grinding 50% w.s. azoxystrobin, 2,5% w.s. dispersant (Ex. 3), and 0,3% w.s. Agnique DFM 111 S (silicon emulsion defoamer) in a disperser “DAS 200”, Lau GmbH with glass balls (diameter: 2 or 3 mm) such that the dispersed pesticide particles reach a particle size distribution characterized by a D90 of ≤10 μm and a D50≤3 μm. Particles analysis was done according to method (I). Storage stability was assessed as described in method (II). Methods (I) and (II) are described in detail above.

Emulsion concentrates were prepared by mixing 37% w.s. Agnique AE3-2EH (2-ethylhexyl lactate) and 25% w.s. Agnique AMD 12 (fatty acid dimethyl amide) in a 100 mL bottle. Next, 8% w.s. of a PO-EO block copolymer having a PO block of 1750 g/mol and containing 40% by weight EO, 4% w.s. of a PO-EO block polymer having a PO block of 2750 g/mol and containing 20% by weight EO and 6% w.s. Lutensol A08 (ethoxylated C₁₃-C₁₅ oxo alcohol) were added while stirring. When everything was dissolved, 20% w.s. tebuconazol was added and then heated to 50° C. until everything was dissolved.

Next, the thus prepared SC and EC were combined (weight ratio 1:1) and homogenized by a torque measurement stirrer (ViscoPakt Rheo X7 of Hightech) at 800 rpm for 15 min leading to a suspo-emulsion with 25% w.s. azoxystrobin and 10% w.s. tebuconazol. Emulsion stability was assessed as described in method (V).

The specific components and experimental results are shown in the tables below.

### Method (V): Emulsion Quality According to CIPAC 36.3

a) Initial Emulsion Quality:
   5 g of the suspension Concentrate was added to 95 mL of CIPAC D water in a 100 mL measuring cylinder. Next, the measuring cylinder was closed with a glass or plastic plug and homogenized by ten times 180° inversion. Subsequently, the initial emulsion quality was evaluated: 1: very good (homogeneous), 3: moderate, 5: very poor (not emulsifiable), 2 & 4 accordingly in between.
b) Emulsion Stability After 24 h:
   The filled measuring cylinder was then stored for 24 h at room temperature. During this time, any separation on the surface or at the bottom of the emulsion was recorded (documentation after 1 h, 2 h, 4 h and 24 h).
c) Re-Emulsifying After 24 h:
   After storage for 24 h, the filled measuring cylinder was homogenized by ten times 180° inversion. After 30 min, the creaming and sedimentation was evaluated.

TABLE
Particle Size Stability (Suspo-Emulsion with 25%
w.s. azoxystrobin and 10% w.s. tebuconazol)

2.5% w.s. of Dispersant

| | | |
|---|---|---|
| start | D50 | 2.07 |
| | D90 | 4.44 |
| rt, 14 d | D50 | 2.27 |
| | D90 | 4.91 |

TABLE
Emulsion Quality

| | 2.5% w.s. of Dispersant |
|---|---|
| Initial Emulsion Quality | 4.5 |

| | | |
|---|---|---|
| Emulsion Stability After 1 h [mL] | Cr: 0 | Sd: 0 |
| Emulsion Stability After 2 h [mL] | Cr: 0 | Sd: 0 |
| Emulsion Stability After 4 h [mL] | Cr: 0 | Sd: 0 |
| Emulsion Stability After 24 h [mL] | Cr: 0 | Sd: 0.3 |
| Re-Emulsifying [mL] | Cr: 0 | Sd: 0.3 |

Cr = creaming;
Sd = sedimentation

1. An agrochemical composition comprising
(i) an agrochemical active ingredient; and
(ii) a graft polymer comprising
(A) a polymer backbone as a graft base,
wherein said polymer backbone is obtained by polymerizing at least one alkylene oxide selected from the group consisting of C₂- to C₁₀-alkylene oxides, and optionally at least one polyol selected from the group consisting of C₂- to C₁₄-polyols or at least one polyamine selected from the group consisting of C₂- to C₁₄-polyamines; and
(B) polymeric sidechains grafted onto the polymer backbone (A), wherein said polymeric sidechains (B) are obtained by polymerizing monomers comprising at least one vinyl ester monomer (B1); in the presence of the polymer backbone (A).

2. The agrochemical composition according to claim 1, wherein the graft polymer has a number average molecular weight Mₙ of 1,000 to 100,000 g/mol.

3. The agrochemical composition according to claim 1, wherein the graft polymer has a polydispersity M_{w}/Mₙ of less than 7, with M_{w} being the weight average molecular weight and Mₙ being the number average molecular weight.

4. The graft polymer according to claim 1, wherein a biodegradation of the graft polymer is at least 30 wt.-% by solids, within 28 days according to OECD 301 F.

5. The agrochemical composition according to claim 1, wherein the graft polymer comprises 25 to 90 wt.-% of the polymer backbone (A) and 10 to 75 wt.-% of the polymeric sidechains (B), relative to the total weight of the graft polymer.

6. The agrochemical composition according to claim 1, wherein the polymer backbone (A) has a number average molecular weight Mₙ of 500 to 3,800 g/mol.

7. The agrochemical composition according to claim 1, wherein the polymer backbone (A) is obtained by polymerizing ethylene oxide.

8. The agrochemical composition according to claim 1, wherein the polymer backbone (A) is obtained by polymerizing ethylene oxide and at least one alkylene oxide selected from 1,2-propylene oxide and 1,2-butylene oxide.

9. The agrochemical composition according to claim 1, wherein the polymer backbone (A) is capped at one or both end groups.

10. The agrochemical composition according to claim 1, wherein the least one vinyl ester monomer (B1) is selected from the group consisting of vinyl acetate, vinyl propionate, and vinyl laurate.

11. The agrochemical composition according to claim 1, wherein the polymeric sidechains (B) are obtained by radical polymerization of
65 to 100 wt.-%, relative to the total amount of monomers constituting the polymeric sidechains (B), of at least one vinyl ester monomer (B1), and optionally
0 to 35 wt.-%, relative to the total amount of monomers constituting the polymeric sidechains (B), of at least one secondary monomer (B2),
in the presence of polymer backbone (A).

12. The agrochemical composition according to claim 1, wherein the polymer backbone (A) has a number average molecular weight Mₙ of 500 to 3,800 g/mol, and wherein the polymeric sidechains (B) are obtained by radical polymerization of
65 to 100 wt.-%, relative to the total amount of monomers constituting the polymeric sidechains (B), of at least one vinyl ester monomer (B1), and optionally
0 to 35 wt.-%, relative to the total amount of monomers constituting the polymeric sidechains (B), of at least one secondary monomer (B2),
in the presence of polymer backbone (A).

13. The agrochemical composition according to claim 12,
wherein the graft polymer comprises 25 to 90 wt.-% of the polymer backbone (A) and 10 to 75 wt.-% of the polymeric sidechains (B), relative to the total weight of the graft polymer.

14. The agrochemical composition according to claim 1, wherein the agrochemical active ingredient is selected from herbicides, fungicides, and insecticides.

15. The agrochemical composition according to claim 14,
wherein the agrochemical active ingredient is selected from the group consisting of azoxystrobin, fluxapyroxad, fludioxonil, prothioconazole, chlorothalonil, diflufenican, metyltetraprole, mefentrifluconazole, tebuconazole, atrazine, indaziflam, saflufenacil, pyroxasulfone, glufosinate, cinmethylin, terbuthylazine, and metribuzin.

16. The agrochemical composition according to claim 1, wherein the weight ratio of the active agrochemical ingredient to the graft polymer in the agrochemical composition is in a range of 1:1 to 30:1.

17. The agrochemical composition according to claim 1, wherein the agrochemical composition is an emulsifiable concentrate, a wettable powder, a wettable dust, a granule, a suspension concentrate, a suspo-emulsion, or a dispersible concentrate.
